(19) United States
(12) Patent Application Publication
(10) Pub. No.: US 2025/0051686 A1
(43) Pub. Date: Feb. 13, 2025

(54) SURFACTANTS FOR CLEANING PRODUCTS

(71) Applicant: AdvanSix Resins & Chemicals LLC, Parsippany, NJ (US)

(72) Inventors: Edward Asirvatham, Chatham, NJ (US); Kavssery Parameswaran Ananthapadmanabhan, Loveland, OH (US); Harshita Kumari, Cincinnati, OH (US); Ramana Reddy Mittapalli, Cincinnati, OH (US); Suchitra Dilipkumar Panigrahi, Cincinnati, OH (US)

(21) Appl. No.: 18/795,170

(22) Filed: Aug. 5, 2024

Related U.S. Application Data
(60) Provisional application No. 63/531,198, filed on Aug. 7, 2023.

(51) Int. Cl. C11D 1/62; C07F 7/08; C11D 1/835; C11D 3/37; C11D 3/386; C11D 3/395; C11D 3/43; C11D 3/48; C11D 10/04

(52) U.S. Cl. CPC C11D 1/62; C07F 7/0872; C11D 1/835; C11D 3/37; C11D 3/386; C11D 3/3951; C11D 3/43; C11D 3/48; C11D 10/045; C11D 2111/12; C11D 2111/14

(57) ABSTRACT

Surfactants for use in the formulation of detergents, foaming agents, emulsifiers, and degreasers. Some aspects of the disclosure include formulations suitable for cleaning and/or condition fabrics including upholstery. Some formulations are suitable for in home or commercial dry cleaning. Some of the formulations may be suitable for cleaning hard surfaces including plastic surfaces and surfaces with food contact. Certain of the other formulations may be suitable for cleaning surfaces used in food processing, food stuff themselves, and in surfaces of healthcare settings.

### CROSS REFERENCE TO RELATED APPLICATIONS

This application claims priority to U.S. Provisional Patent Application Ser. No. 63/531,198, filed Aug. 7, 2023, the entire disclosure of which is incorporated by reference in its entirety.

### FIELD

The present disclosure pertains to surfactants for use in cleaning products including cleaning products used to clean and conditioning fabrics, hard surfaces, and plastic surfaces. Such surfactants may include siloxane derivatives of amino acids wherein the siloxane derivatives have surface-active properties.

### BACKGROUND

Surfactants (molecules with surface-active properties) are widely used in commercial applications in formulations ranging from detergents to hair care products to cosmetics. Compounds with surface-active properties are used as soaps, detergents, lubricants, wetting agents, foaming agents, and spreading agents, among others. In personal care cleansing products (e.g., shampoos, body washes, facial cleansers, liquid hand soaps, etc.) the surfactant is often the most important component because it provides many of the cleansing attributes of the composition.

Surfactants may be uncharged, zwitterionic, cationic, or anionic. Although in principle any surfactant class (e.g., cationic, anionic, nonionic, amphoteric) is suitable in cleansing or cleaning applications, in practice many personal care cleansers and household cleaning products are formulated with a combination of two or more surfactants from two or more surfactant classes.

Often, surfactants are amphiphilic molecules with a relatively water-insoluble hydrophobic “tail” group and a relatively water-soluble hydrophilic “head” group. These compounds may adsorb at an interface, such as an interface between two liquids, a liquid and a gas, or a liquid and a solid. In systems comprising relatively polar and relatively non-polar components the hydrophobic tail typically and selectively interacts with the relatively non-polar component(s) while the hydrophilic head selectively interacts with the relatively polar component(s). In the case of an interface between water and oil, the hydrophilic head group extends into the water, while the hydrophobic tail extends into the oil. When added to a water-gas only interface, the hydrophilic head group extends into the water, while the hydrophobic tail extends into the air. The presence of the surfactant disrupts at least some of the intermolecular interaction between the water molecules, replacing at least some of the interactions between water molecules with generally weaker interactions between at least some of the water molecules and the surfactant. This results in lowered surface tension and can also serve to stabilize the interface.

At sufficiently high concentrations, surfactants may form aggregates which serve to limit the exposure of the hydrophobic tail to the polar solvent. One such aggregate is a micelle. In a typical micelle the molecules are arranged in a sphere with the hydrophobic tails of the surfactant(s) typically located inside the sphere and the hydrophilic heads of the surfactant(s) located on the outside of the micelle where the heads interact with the more polar solvent. The effect that a given compound has on surface tension and the concentration at which it forms micelles may serve as defining characteristics for a surfactant.

### SUMMARY

The present disclosure provides compositions for cleaning and or degreasing hard and plastic surfaces such as floors, walls, ceilings, roofs, counter tops, furniture, plates, cups, glasses, cutlery, eating utensils, machinery, part of machines, and devices used in the preparation and/or the packing of food; fabric care formulations, including laundry detergents, spot removers, wash pretreatments, fabric softeners, fabric dyes, and bleaching agents; and compositions used to clean upholstery and carpets. Some inventive compositions may be in the form of detergents, emulsifiers, dispersants, foaming agents and combinations thereof. The inventive products may be formulated to include one or more surfactants, from one or more surfactant classes.

The present disclosure provides siloxane derivatives of amino acids that have surface-active properties. The amino acids may be naturally occurring or synthetic amino acids, or they may be obtained via ring-opening reactions of molecules such as lactams, for example caprolactam. The amino acids may be functionalized with different types of siloxane groups to form compounds with surface-active properties. Characteristically, these compounds may have low critical micelle concentrations (CMC) and/or the ability to reduce the surface tension of a liquid.

The present disclosure provides a formulation for cleaning, comprising one or more surfactant molecules bearing the structure(s) of Formula I or II,

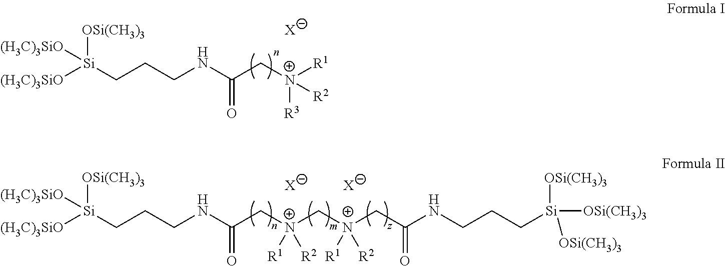

wherein R¹ and R² may be the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ may be selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to an additional surfactant molecule having a structure represented by Formula I, wherein the additional surfactant molecule of Formula I is the same or different from the surfactant molecule of Formula l;
n and z may be selected independently from any integer from 1 to 12;
m may be any integer from 1 to 12; and
X may be selected from the group consisting of chloride, bromide, and iodide,
   and optionally, one or more soaps, which themselves may be characterized as surfactants, soaps may also include fatty acids, salts, some soaps may comprise both water soluble and fat-soluble moieties.

For clarity, as disclosed herein, and with respect to any of the formulations provided herein, the molecule of Formula II may represent a construct of the following structure:

Formula I-Linker-Formula I,

wherein one molecule of Formula I may be the same as, or different from, the other molecule of Formula I. In this exemplary construct, the Linker is R³ in Formula I, a C₁-C₁₂ linker.

Further surfactant molecules provided by the present disclosure are those compounds of Formula I or II, wherein R¹ and R² are methyl.

Other surfactant molecules provided by the present disclosure are compounds of Formula I or II, wherein n and/or z are 5.

Specifically, R³ may be selected from the group consisting of C₂-C₁₀ alkenyl, C₂-C₁₀ alkynyl, C₂-C₁₂ ester, C₁-C₁₀ hydroxyl, benzyl, C₂-C₁₂ alkoxy alkyl ether, alkyl phosphate, alkyl phosphonate, C₃-C₈ carboxylic acid, C₁-C₅ alkyl benzoic acid, and a three-carbon linker attached to a second molecule of Formula I, wherein the second molecule of Formula I is the same as the first molecule of Formula I.

More specifically, R³ may be selected from the group consisting of the formulas below:

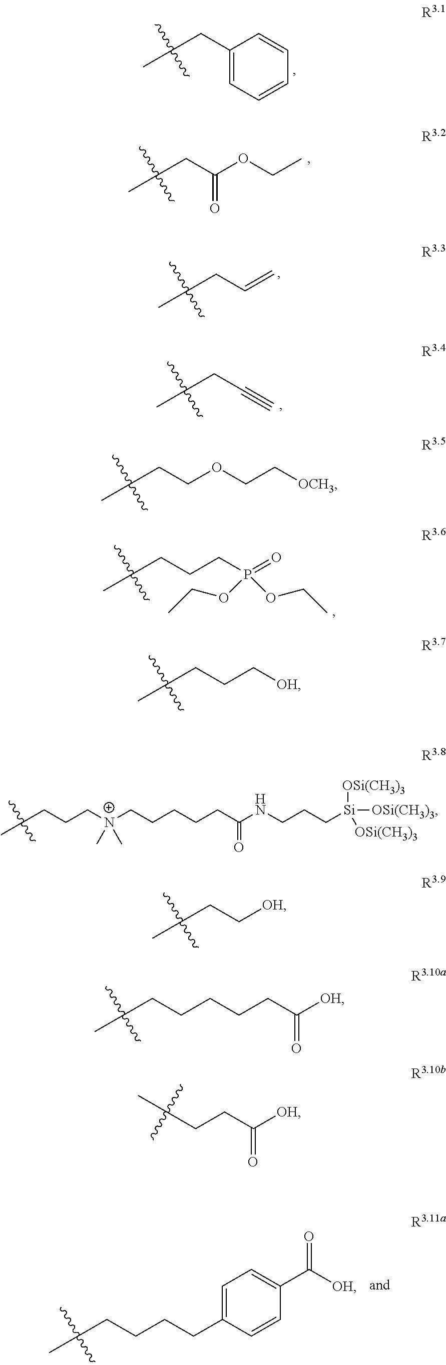

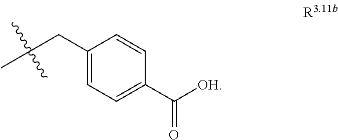 [SMILES: *Cc1ccc(C(=O)O)cc1]

There is further disclosed, the use as a surfactant of a compound of Formula I or II as described herein in a cleaning formulation as described herein.

The present disclosure further provides a formulation for cleaning, comprising one or more surfactant molecules bearing the structure(s) of Formula I or II,

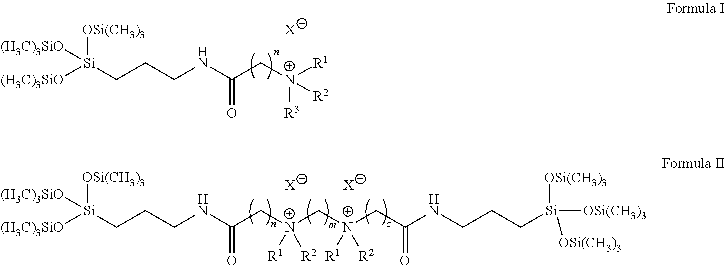

wherein R¹ and R² may be the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ may be selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to an additional surfactant molecule having a structure represented by Formula I, wherein the additional surfactant molecule of Formula I is the same or different from the surfactant molecule of Formula I;
n and z may be selected independently from any integer from 1 to 12;
m may be any integer from 1 to 12; and
X may be selected from the group consisting of chloride, bromide, and iodide,
   and at least one builder, builders may include molecules that facilitate the efficacy of the cleaning action in aqueous environments, some useful builders include, but are not limited to, certain polymers, phosphates and aluminosiliates, calcium citrates, alkaline metal salts, sodium salts, some grades of Zeolite.

Specifically, R³ may be selected from the group consisting of C₂-C₁₀ alkenyl, C₂-C₁₀ alkynyl, C₂-C₁₂ ester, C₁-C₁₀ hydroxyl, benzyl, C₂-C₁₂ alkoxy alkyl ether, alkyl phosphate, alkyl phosphonate, C₃-C₈ carboxylic acid, C₁-C₅ alkyl benzoic acid, and a three-carbon linker attached to a second molecule of Formula I, wherein the second molecule of Formula I is the same as the first molecule of Formula I.

More specifically, R³ may be selected from the group consisting of the formulas below:

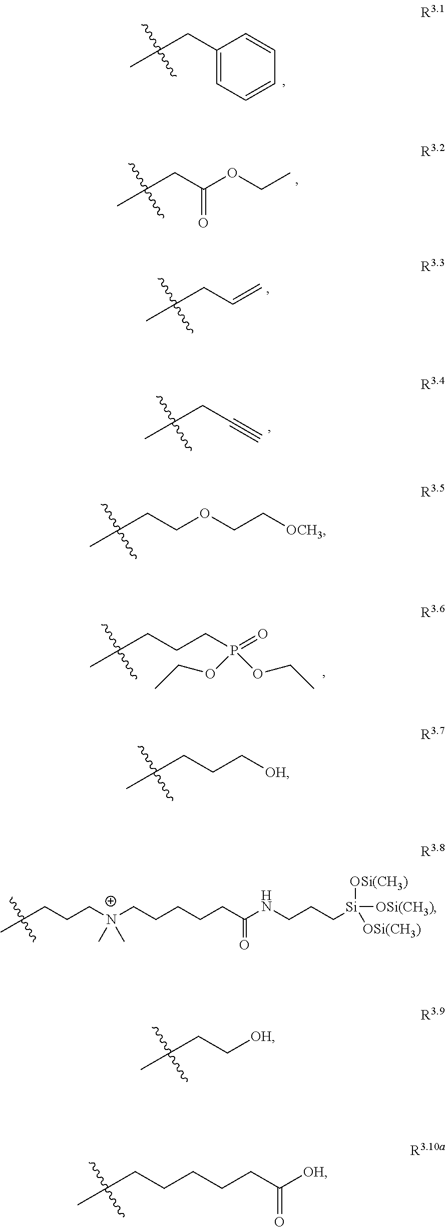

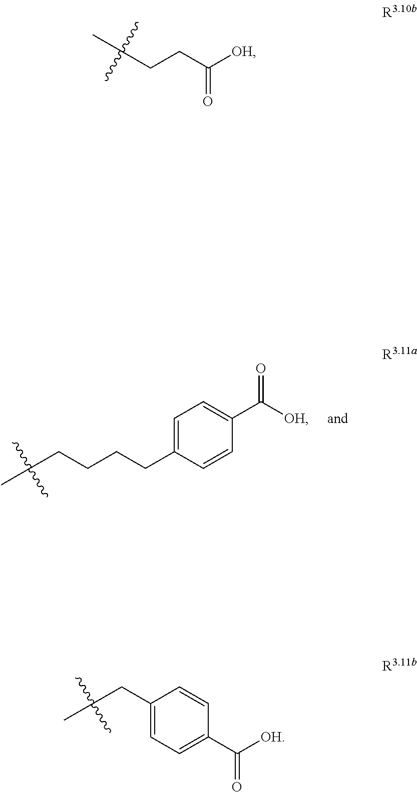 [SMILES: *CCC(=O)O ; *CCCCc1ccc(C(=O)O)cc1 ; *Cc1ccc(C(=O)O)cc1]

There is further disclosed, the use as a surfactant of a compound of Formula I or II as described herein in a cleaning formulation further comprising a builder as described herein.

The present disclosure further provides a formulation for cleaning comprising one or more surfactant molecules bearing the structure(s) of Formula I or II,

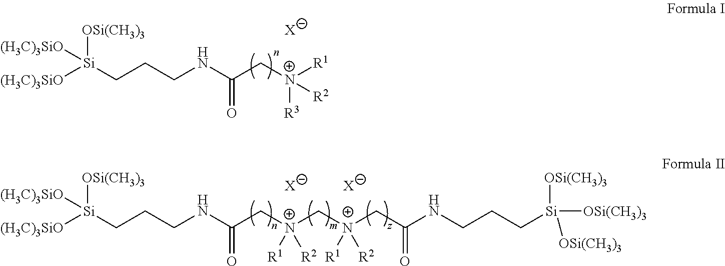

wherein R¹ and R² may be the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ may be selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to an additional surfactant molecule having a structure represented by Formula I, wherein the additional surfactant molecule of Formula I is the same or different from the surfactant molecule of Formula I;
n and z may be selected independently from any integer from 1 to 12;
m may be any integer from 1 to 12; and
X may be selected from the group consisting of chloride, bromide, and iodide,
   and a bleach, such as peroxy based beaches including, but not limited to inorganic persalts, organic peroxyacids, metal borates, percarbonates, perphosphates, persilicates, and persulfates.

Specifically, R³ may be selected from the group consisting of C₂-C₁₀ alkenyl, C₂-C₁₀ alkynyl, C₂-C₁₂ ester, C₁-C₁₀ hydroxyl, benzyl, C₂-C₁₂ alkoxy alkyl ether, alkyl phosphate, alkyl phosphonate, C₃-C₈ carboxylic acid, C₁-C₅ alkyl benzoic acid, and a three-carbon linker attached to a second molecule of Formula I, wherein the second molecule of Formula I is the same as the first molecule of Formula I.

More specifically, R³ may be selected from the group consisting of the formulas below:

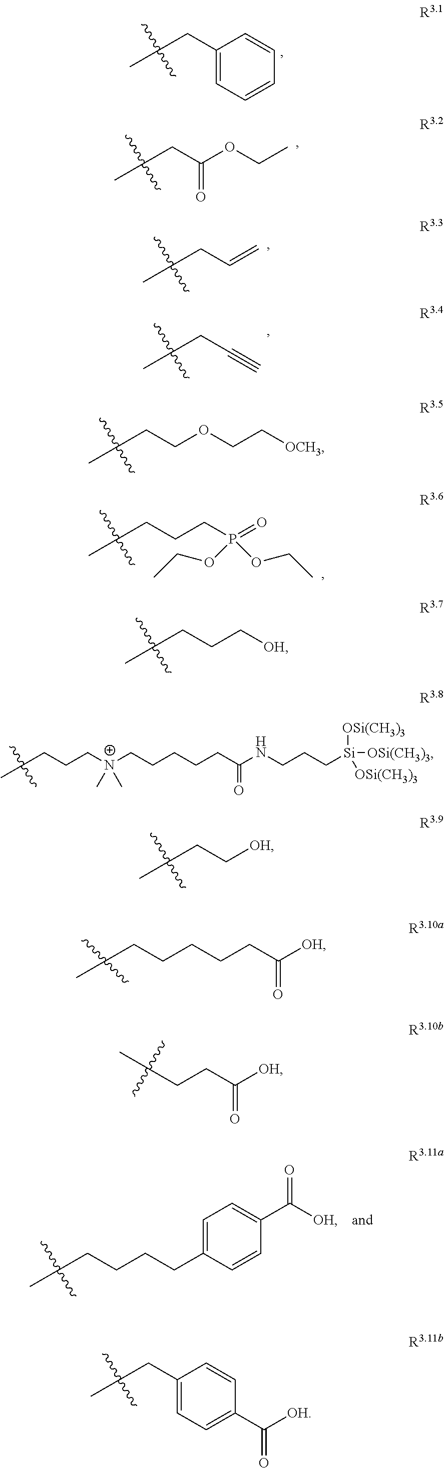

There is further disclosed, the use as a surfactant of a compound of Formula I or II as described herein in a cleaning formulation further comprising a bleach as described herein.

The present disclosure further provides a formulation for cleaning comprising one or more surfactant molecules bearing the structure(s) of Formula I or II,

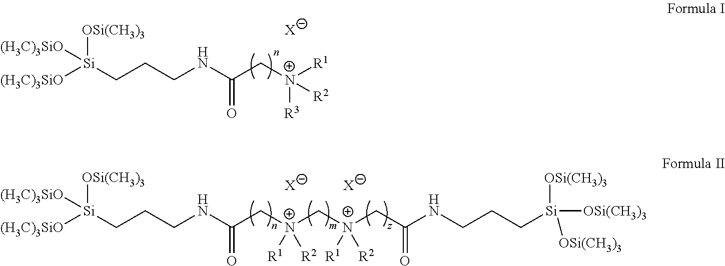

wherein R¹ and R² may be the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ may be selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to an additional surfactant molecule having a structure represented by Formula I, wherein the additional surfactant molecule of Formula I is the same or different from the surfactant molecule of Formula I;
n and z may be selected independently from any integer from 1 to 12;
m may be any integer from 1 to 12; and
X may be selected from the group consisting of chloride, bromide, and iodide,
   and one or more solvents, and optionally co-solvent, or non-flammable oil immersible compositions for use in either or both home or commercial dry cleaning processes.

Specifically, R³ may be selected from the group consisting of C₂-C₁₀ alkenyl, C₂-C₁₀ alkynyl, C₂-C₁₂ ester, C₁-C₁₀ hydroxyl, benzyl, C₂-C₁₂ alkoxy alkyl ether, alkyl phosphate, alkyl phosphonate, C₃-C₈ carboxylic acid, C₁-C₅ alkyl benzoic acid, and a three-carbon linker attached to a second molecule of Formula I, wherein the second molecule of Formula I is the same as the first molecule of Formula I.

More specifically, R³ may be selected from the group consisting of the formulas below:

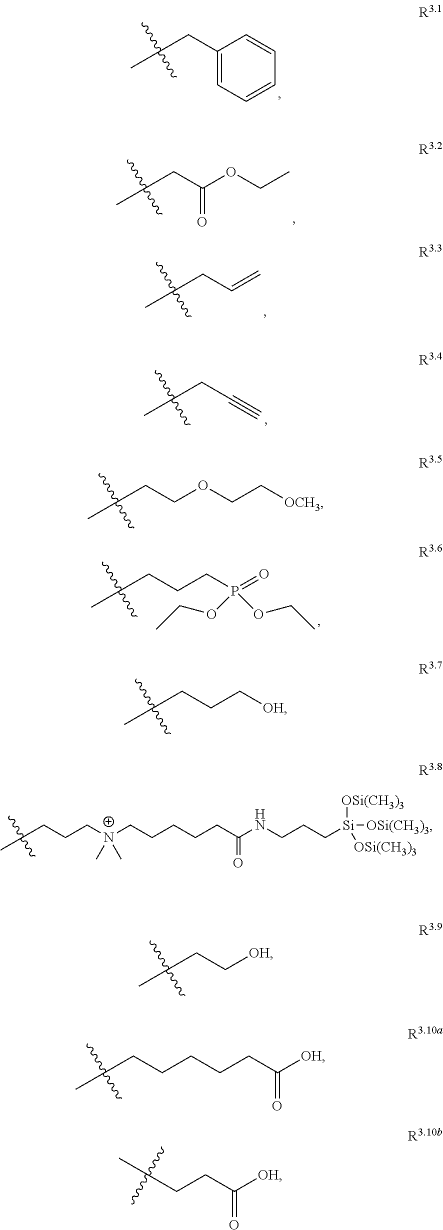

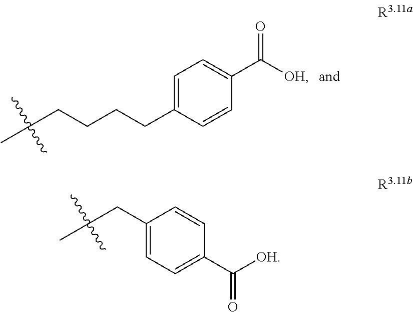 [SMILES: *CCCCc1ccc(C(=O)O)cc1 ; "and" ; *Cc1ccc(C(=O)O)cc1]

There is further disclosed, the use as a surfactant of a compound of Formula I or II as described herein in a cleaning formulation further comprising a solvent as described herein.

The present disclosure additional provides certain cleaning compositions that can be used to clean various types of surfaces, not limited to hard services and others, comprising one or more of the surfactants described herein, whereby the one or more surfactants impart an antimicrobial activity on such surfaces. In other words, surfactants of the present disclosure may confer antimicrobial activities, even in the absence of other antimicrobial additives and agents, to the formulations.

The above mentioned and other features of the disclosure, and the manner of attaining them, will become more apparent and will be better understood by reference to the following description of embodiments taken in conjunction with the accompanying drawings.

### BRIEF DESCRIPTION OF THE DRAWINGS

FIG. 1 shows a plot of surface tension versus concentration for Surfactant 1 as described in Example 2b.

FIG. 2 shows a plot of surface tension versus concentration for Surfactant 2 as described in Example 3b.

FIG. 3 shows a plot of surface tension versus concentration for Surfactant 3 as described in Example 4b.

FIG. 4 shows a plot of surface tension versus concentration for Surfactant 4 as described in Example 5b.

FIG. 5 shows a plot of surface tension versus concentration for Surfactant 5 as described in Example 6b.

FIG. 6 shows a plot of surface tension versus concentration for Surfactant 6 as described in Example 7b.

FIG. 7 shows a plot of surface tension versus concentration for Surfactant 7 as described in Example 8b.

FIG. 8 shows a plot of surface tension versus concentration for Surfactant 8 as described in Example 9b.

FIG. 9 shows a plot of surface tension versus concentration for Surfactant

9 as described in Example 11b.

FIG. 10 shows a plot of surface tension versus concentration for Surfactant 10 as described in Example 10b.

FIG. 11 shows a plot of surface tension versus concentration for Surfactant as described in Comparative Example A2.

### DETAILED DESCRIPTION

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

As used herein, the word “alkyl” means any saturated carbon chain, which may be a straight or branched chain, and may be substituted at any point along the carbon chain. The carbon chain may have 1, 2, 3, 4, 5, 6, 7, 8, 9, 10, 11, or 12 carbons.

As used herein, the phrase “surface-active” means that the associated compound is able to lower the surface tension of the medium in which it is at least partially dissolved, and/or the interfacial tension with other phases, and, accordingly, may be at least partially adsorbed at the liquid/vapor and/or other interfaces. The term “surfactant” may be applied to such a compound.

With respect to the terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error or minor adjustments made to optimize performance, for example. In the event it is determined that individuals having ordinary skill in the relevant arts would not readily ascertain values for such reasonably small differences, the terms “about” and “approximately” can be understood to mean plus or minus 15% of the stated value, for example, plus or minus 15%, plus or minus 12%, plus or minus 10%, plus or minus 9%, plus or minus 8%, plus or minus 8%, plus or minus 7%, plus or minus 6%, plus or minus 5%, plus or minus 4%, plus or minus 3%, plus or minus 2%, or even plus or minus 1% and so on.

Unless explicitly defined otherwise or implicitly used otherwise, as used herein the term, “suds” indicates a non-equilibrium dispersion of gas bubbles in a relatively smaller volume of a liquid. The terms like “suds,” “foam,” and “lather” can be used interchangeably within the meaning of the present disclosure.

Unless explicitly defined otherwise or implicitly used otherwise, as used herein the term, “sudsing profile” refers to the properties of a detergent composition relating to suds character during the wash and rinse cycles. The sudsing profile of a detergent composition includes, but is not limited to, the speed of suds generation upon dissolution in the laundering liquor, the volume and retention of suds in the wash cycle, and the volume and disappearance of suds in the rinse cycle. The sudsing profile may include the Wash Suds Index and Rinse Suds Index, as specifically defined by the testing methods disclosed hereinafter in the examples. It may further include additional suds-related parameters, such as suds stability measured during the washing cycle and the like.

Unless explicitly defined otherwise or implicitly used otherwise, as used herein the term, “fluid” includes liquid, gel, paste, and gas product forms.

Unless explicitly defined otherwise or implicitly used otherwise, as used herein the term, “liquid” refers to a fluid having a liquid having a viscosity of from about 1 to about 2000 mPa*s at 25° C., and a shear rate of about 20 sec⁻¹.

Unless explicitly defined otherwise or implicitly used otherwise, as used herein the term, “dry cleaning composition” as used herein is intended to mean the composition used in the dry cleaning process including the dry cleaning solvent, any surfactant, cleaning agents but excluding the laundry articles that are to be cleaned.

Unless explicitly defined otherwise or implicitly used otherwise, as used herein the term, “organic dry cleaning solvent” as used herein is intended to mean any non-aqueous solvent that would suitably have a liquid phase at 20° C. and standard pressure. The term organic has its usual meaning, i.e., a compound with at least one carbon hydrogen bond.

As used herein, the phrase “food product” includes any food substance that itself or during the processing, making, and preparation thereof, might require treatment with an antimicrobial agent, cleaning agent to remove debris and other substances including microbes and other agents that may adhere to the surface of the food product or the vessels or containers used to hold, manufacture and/or process the food product, or composition and that is edible with or without further processing or preparation. Food products include meat (e.g., red meat and pork), seafood, poultry, produce (e.g., fruits and vegetables), eggs, living eggs, egg products, ready to eat food, wheat, seeds, roots, tubers, leaves, stems, corns, flowers, sprouts, seasonings, or a combination thereof. The term “produce” refers to food products such as fruits and vegetables and plants or plant-derived materials that are typically sold uncooked and, often, unpackaged, and that can sometimes be eaten raw. Furthermore, food products may include liquid products that are consumed as beverages, broths, soups, and/or components used during cooking, processing and other preparation steps.

As used herein, the phrase “plant” or “plant product” includes any plant substance or plant-derived substance. Plant products include, but are not limited to, seeds, nuts, nut meats, cut flowers, plants or crops grown or stored in a greenhouse, house plants, and the like. Plant products may further include certain grains or seeds that may be processed and subsequently converted into other types of food products that can be consumed. Plant products can also include many animal feeds.

As used herein, the phrase “meat product” refers to all forms of animal flesh, including the carcass, muscle, fat, organs, skin, bones and body fluids and like components that form the animal. Animal flesh includes, but is not limited to, the flesh of mammals, birds, fishes, reptiles, amphibians, snails, clams, crustaceans, other edible species such as lobster, crab, etc., or other forms of seafood. The forms of animal flesh include, for example, the whole or part of animal flesh, alone or in combination with other ingredients. Typical forms include, for example, processed meats such as cured meats, sectioned and formed products, minced products, finely chopped products, ground meat and products including ground meat, whole products, and the like.

As used herein the term “poultry” refers to all forms of any bird kept, harvested, or domesticated for meat or eggs, and including chicken, turkey, ostrich, game hen, squab, guinea fowl, pheasant, quail, duck, goose, emu, or the like and the eggs of these birds. Poultry includes whole, sectioned, processed, cooked or raw poultry, and encompasses all forms of poultry flesh, by-products, and side products. The flesh of poultry includes muscle, fat, organs, skin, bones and body fluids and like components that form the animal. Forms of animal flesh include, for example, the whole or part of animal flesh, alone or in combination with other ingredients. Typical forms include, for example, processed poultry meat, such as cured poultry meat, sectioned and formed products, minced products, finely chopped products and whole products.

As used herein, the phrase “poultry debris” refers to any debris, residue, material, dirt, offal, poultry part, poultry waste, poultry viscera, poultry organ, fragments or combinations of such materials, and the like removed from a poultry carcass or portion during processing and that enters a waste stream.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, auto-dish sanitizers, sanitizing gels, cooling towers, food processing antimicrobial garment sprays, and non-to-low-aqueous food preparation lubricants, oils, and rinse additives. Food processing surfaces can also be found in fermentation vats and containers where certain processed and/or raw grains and other food products may be transformed and/or converted via the process of fermentation to convert to other food products.

The present disclosure provides compositions for cleaning and/or degreasing hard and plastic surfaces such as floors, walls, ceilings, roofs, counter tops, furniture, plates, cups, glasses, cutlery, eating utensils, machinery, parts of machines, and devices used in the preparation and/or packing of food; fabric care formulations, including laundry detergents, spot removers, wash pretreatments, fabric softeners, fabric dyes, and bleaching agents; and compositions used to clean upholstery and carpets.

The present disclosure further provides cleaning compositions suitable for use in a range of applications with food contact of any kind, such as for cleaning surfaces in contact with dairy, fruit, vegetable, meat, beverage and/or other types of products during preparation, storage, and/or production processes. Food products, food product residues, raw ingredients, and other food preparation and/or processing components, may need to be removed from processing machinery, vessels, and/or equipment, and transportation devices and vehicles. In these applications, there is a growing preference among consumers for organic-approved/certified and optionally biodegradable products to be used in maintain cleanliness. For those surfaces with food contact, it is it is desirable to limit the presence of components which may exhibit unwanted effects if inadvertently contacted with food, or worse, remain with food even in small amounts, and possibly ingested. Similar considerations may apply to surfaces routinely handled by children, as they are more prone to put their hands in their mouths after touching or otherwise handling such a surface (e.g., toys, high-chairs, tables, cribs, etc.). In some embodiments, the cleaning formulations of the instant disclosure can be used as a sanitizing composition for articles cleaned using a clean in place (CIP) technique. Such compositions can include an oxidizing agent, a stabilizing agent, an acidulant and a surfactant or mixture thereof.

### 1. Water Based Cleaning Formulations for Fabric and Household Care Applications

Laundry detergents, degreasers, spot removers, and laundry pretreatment compositions may comprise combinations of detersive surfactants, binders, enzymes, and conditioning agents. Laundry detergent formulations include, solids, liquids, powders, bars, sticks, pods, aerosols, and/or gels.

The laundry detergent compositions of the present disclosure can be used in applications such as automatic washing machine laundering, semi-automatic machine laundering (i.e., machine washing that requires at least one or two manual steps), hand—washing, etc. In some embodiments the detergent composition is a designated for hand-washing laundry detergent product.

The laundry detergent compositions can be in any form, namely, in the form of a liquid; an emulsion; a paste; a gel; a spray or foam; a solid such as a powder, granules, agglomerate, tablet, pouches, and bar; types delivered in dual- or multi-compartment containers or pouches; pre moistened or dry wipes (i.e., a liquid detergent composition in combination with a nonwoven material or a powder detergent composition in combination with a nonwoven material) that can be activated with water by a consumer; and other homogeneous or multiphase consumer cleaning product forms.

Some of the fabric care formulations of the present disclosure comprise one or more surfactants, also referred to as the surfactant system. The surfactant system is included to provide cleaning performance to the composition. The surfactant system comprises at least one surfactant, which may be an amphoteric surfactant, a zwitterionic surfactant, a cationic surfactant, a nonionic surfactant, and optionally at least one other surfactant, which may be an amphoteric surfactant, a zwitterionic surfactant, a cationic surfactant, a nonionic surfactant, or a combination thereof. Such surfactants should be physically and chemically compatible with the essential components described herein, or should not otherwise unduly impair product stability, aesthetics, or performance.

The compositions of the disclosure may be of any suitable physical form, for example, particulates (powders, granules, tablets), liquids, pastes, gels or bars. The detergent composition may be in granular form. The composition can be formulated for use as hand wash or machine wash detergents.

Representative, but not limiting, laundry detergent formulations may include the combination of a soap, an ionic surfactant, a nonionic surfactant, optionally a builder system, and optionally other detergent ingredients. Wherein a set amount of the soap is present in the form of granules which are dry-mixed with the other components, and the soap granule has a defined concentration of soap.

Some useful detergent compositions according to the disclosure show improved dissolution properties across a range of water hardness.

1. Detergent and/or Soaps

Detergents include anionic, cationic, non-ionic, and zwitterionic detergents. Soaps include compound of the general formula: (RCO₂⁻) n Mn⁺ wherein R is an alkyl group, and M is a metal, and n+ is either +1 or +2, commonly the alkyl group may be portion of an fatty acid, M, may be sodium, lithium, magnesium, calcium, and the like.

The soap according to the disclosure may comprise from about 5 to 85 wt. %, for example, 7 to 60 wt. %, or 10 to 35 wt. % of the formulation. The soap may in part comprise a surfactant system comprising from about 20 to 50 wt. % of a soap. The surfactant system may comprise from 30 to 40 wt. % of a soap. An example of an embodiment of the disclosure from 80 wt. % to 100 wt. %, such as from 85 to 95 wt. % of the soap is present in the form of granules.

The laundry detergent compositions of the current disclosure may comprise a soap granule which has a concentration of soap of at least 75 wt. % based on the weight of the composition.

In some embodiments of the disclosure the soap granule has a concentration of soap of from 80 to 95 wt. %, such as from 85 to 90 wt. %. The soap granules may include more than 90 wt. % soap, less than 10 wt. % moisture and less than 1 wt. % sodium hydroxide.

Useful soap compounds include but are not limited to; the alkali metal soaps such as the sodium, potassium, ammonium and a substituted ammonium (for example, monoethanolamine) salts or any combinations of this, of higher fatty acids containing from about 8 to 24 carbon atoms.

In some embodiments of the disclosure the fatty acid soap has a carbon chain length of from C₁₀ to C₂₂, for example, C₁₂ to C₂₀. Suitable fatty acids can be obtained from natural sources such as plant or animal esters, e.g., palm oil, coconut oil, babassu oil, soybean oil, castor oil, rape seed oil, sunflower oil, cottonseed oil, tallow, fish oils, grease lard and mixtures thereof. Also, fatty acids can be produced by synthetic means such as the oxidation of petroleum, or hydrogenation of carbon monoxide by the Fischer Tropsch process. Resin acids are suitable such as rosin and those resin acids in tall oil. Naphthenic acids are also suitable. Sodium and potassium soaps can be made by direct saponification of the fats and oils or by the neutralization of the free fatty acids which are prepared in a separate manufacturing process. Particularly useful are the sodium and potassium salts and the mixtures of fatty acids derived from coconut oil and tallow, i.e., sodium tallow soap, sodium coconut soap, potassium tallow soap, and potassium coconut soap.

In some embodiments of the disclosure the fatty acid soap is a lauric soap. For example, Prifac 5908 is a fatty acid from Uniqema which was neutralized with caustic soda. This soap is an example of a fully hardened or saturated lauric soap, which in general is based on coconut or palm kernel oil.

Although not necessary, the soap suitably does not stand out from the rest of the ingredients of the formulation. It therefore needs to be whitish, and more or less round namely with an aspect ratio of less than 2. This ensures that the laundry powder in its final format is free-flowing and containing a soap granule means that it is congruent with the rest of the composition.

In certain embodiment the soap has a particle size of from 400 to 1400 μm, such as from 500 to 1200 μm.

In certain embodiment the soap granule has a bulk density of from 400 to 650 g/liter, and the bulk density of the fully formulated powders are from 400 to 900 g/liter. Fabric washing powders containing major quantities of soap are favored by some consumers because of good detergency, and the tendency to leave clothes feeling softer than those washed with powders based on synthetic detergent active compounds. Soap also has environmental advantages in that it is fully biodegradable, and is a natural material derived from renewable raw materials. Saturated sodium soaps have high Krafft temperatures and consequently dissolve poorly at low temperatures, which are applied by some consumers. It is known that certain mixtures of saturated and unsaturated soaps have much lower Krafft temperatures. However, unsaturated soaps are less stable upon storage, and tend to be malodorous. The Soap mixture used in the granules therefore needs to be a careful balance between dissolution properties and stability proper ties. The stability of the soap is enhanced when it is concentrated in granules; compared to soap that is incorporated at low concentration into composite granules. The soap may be used in combination with a suitable antioxidant for example ethylenediamine tetra acetic acid and/or ethane-1-hydroxy-1,1-diphosphonic acid. Also, preservatives may be present to prevent degradation of the soap which can result in malodor or discoloration, for example, sodium hydroxyethlidene disphosphonic acid.

### 2. Surfactants

Suitable surfactants for use in the cleaning formulations of the present disclosure include one or more surfactant molecule and/or co-surfactant molecule of Formula I or II,

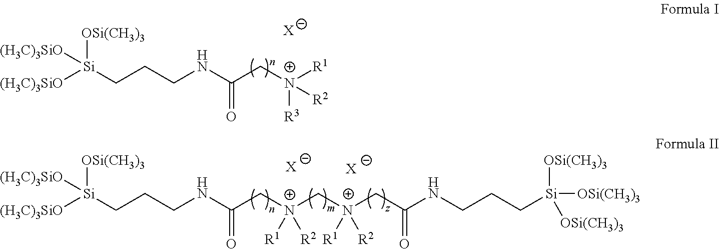

wherein R¹ and R² may be the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ may be selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to an additional surfactant molecule having a structure represented by Formula I, wherein the additional surfactant molecule of Formula I is the same or different from the surfactant molecule of Formula I;
n and z may be selected independently from any integer from 1 to 12;
m may be any integer from 1 to 12; and
X may be selected from the group consisting of chloride, bromide, and iodide.

Specifically, R³ may be selected from the group consisting of C₂-C₁₀ alkenyl, C₂-C₁₀ alkynyl, C₂-C₁₂ ester, C₁-C₁₀ hydroxyl, benzyl, C₂-C₁₂ alkoxy alkyl ether, alkyl phosphate, alkyl phosphonate, C₃-C₈ carboxylic acid, C₁-C₅ alkyl benzoic acid, and a three-carbon linker attached to a second molecule of Formula I, wherein the second molecule of Formula I is the same as the first molecule of Formula I.

More specifically, R³ may be selected from the group consisting of the formulas below:

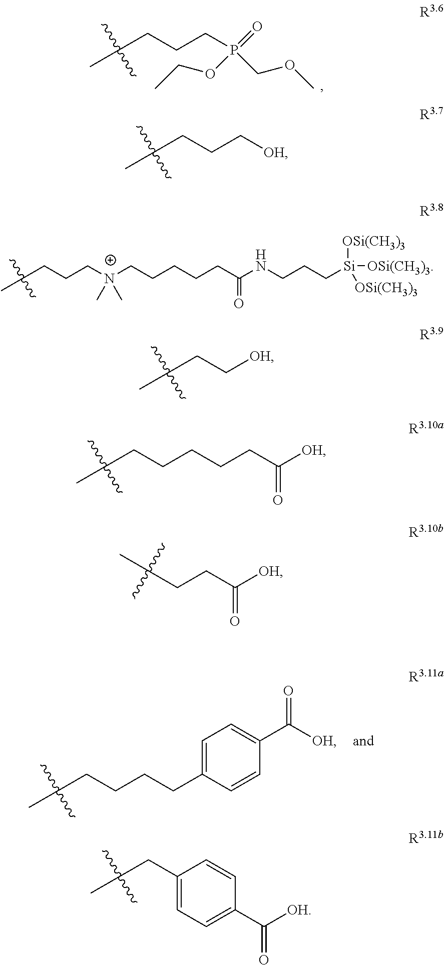

In particular, suitable surfactants or co-surfactants may include one or more of any of Surfactants 1-12 described herein.

Anionic surfactants are well known to those skilled in the art. Examples include alkylbenzene sulfonates, particularly linear alkylbenzene sulfonates, primary and secondary alkylsulfates, particularly primary alkyl sulfates; alkyl ether sulfates; olefin sulfonates; alkyl xylene sulfonates; dialkyl sulfosuccinates; and fatty acid ester sulfonates. Sodium salts are generally and often employed. In an example of the disclosure, the granular laundry detergent composition comprises an anionic surfactant which is a sulfonate anionic surfactant. The sulfonate anionic surfactant may comprise linear alkylbenzene sulfonate (LAS). The anionic surfactant may be present in an amount of from 15 to 50 wt %. For example, the weight ratio of the anionic surfactant to soap is from 0.5:1 to 5:1, such as from 1:1 to 2:1. Some Nonionic Surfactants well suited for use in detergent formulations.

In some embodiments, the nonionic surfactant is present in an amount of from 20 to 60 wt %. Nonionic surfactants that may be used include the primary and secondary alcohol ethoxylates, especially the C8-C20 aliphatic alcohols ethoxylated with an average of from 1 to 20 moles of ethylene oxide per mole of alcohol, and more especially the C10-C15 primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

Examples of suitable nonionics surfactants include Neodol 255E from Shell, which is a C12 to C15 poly (1 to 6) ethoxylate with an average degree of ethoxylation of 5. Also suitable is Lutensol A7, which is a C13 to C15 ethoxylate from BASF, with an average degree of ethoxylation of 7. HLB values can be calculated according to the method given in Griffin, J. Soc. Cosmetic Chemists, 5 (1954) 249 256.

### 3. Builder

Builders may be added to detergent formulations to increase the cleaning properties of the detergent. Such compounds may function by at least one of the following actions; removing or sequestering divalent cations commonly present in water as Ca²⁺ and/or Mg²⁺; creating or contributing the creation of a alkaline environment; enhancing the performance of surfactants; and stabilizing the dispersion of soil in the wash liquor.

Commonly used builders include, but are not limited to, sodium tripolyphosphates, nitriloacetic acid salts, and zeolites.

The compositions of the disclosure may contain a detergency builder. The builder may be present in an amount of from 0 to 15 wt % based on the weight of the total composition. Alternatively, the compositions may be essentially free of detergency builder.

The builder may be selected from strong builders such as phosphate builders, aluminosilicate builders and mixtures thereof. One or more weak builders, such as calcite/carbonate, citrate or polymer builders may be additionally or alternatively present.

The phosphate builder (if present) may for example be selected from alkali metal, for example, sodium, pyrophosphate, orthophosphate and tripolyphosphate, and mixtures thereof.

The aluminosilicate (if present) may be, for example, selected from one or more crystalline and amorphous aluminosilicates, for example, zeolites as disclosed in GB 1 473 201 (Henkel), amorphous aluminosilicates as disclosed in GB 1 473 202 (Henkel) and mixed crystalline/amorphous aluminosilicates as disclosed in GB 1 470 250 (Procter & Gamble); and layered silicates as disclosed in EP 164514B (Hoechst).

The alkali metal aluminosilicate may be either crystalline or amorphous or mixtures thereof, having the general formula: 0.8-1.5 Na₂O. Al₂O₃ 0.8-6 SiO₂.

These materials may generally contain some bound water and are required to have a calcium ion exchange capacity of at least 50 mg CaO/g. The sodium aluminosilicates may contain 1.5-3.5 SiO₂, units (in the formula above). Both the amorphous and the crystalline materials can be prepared readily by reaction between sodium silicate and Sodium aluminate, as amply described in the literature. Suitable crystalline sodium aluminosilicate ion-exchange detergency builders are described, for example, in GB 1429 143 (Procter & Gamble). Sodium aluminosilicates of this type are the well-known commercially available Zeolites A and X, and mixtures thereof.

The zeolite may be the commercially available Zeolite 4A now widely used in laundry detergent powders. However, an example of the present disclosure would include when the zeolite builder incorporated in the compositions of the disclosure is maximum aluminum zeolite P (zeolite MAP) as described and claimed in EP 384 070A (Unilever). Zeolite MAP is defined as an alkali metal aluminosilicate of the Zeolite P type having a silicon to aluminum ratio not exceeding 1.33, for example, within the range of from 0.90 to 1.33, or within the range of from 0.90 to 1.20.

Suitable inorganic salts include alkaline agents such as alkali metal, such as sodium, carbonates, sulfates, silicates, metasilicates as independent salts or as double salts. The inorganic salt may be selected from the group consisting of sodium carbonate, sodium sulfate, burkeite and mixtures thereof.

### 4. Surface Active Ingredients

As well as the surfactants and builders discussed above, the compositions may optionally contain other active ingredients to enhance performance and properties.

Additional detergent-active compounds (surfactants) may be chosen from soap and non-soap anionic, cationic, nonionic, amphoteric and zwitterionic detergent-active compounds, and mixtures thereof. Many suitable detergent-active compounds are available and are fully described in the literature, for example, in “Surface-Active Agents and Detergents”, Volumes I and II, by Schwartz, Perry and Berch.

Cationic surfactants that may be used include quaternary ammonium salts of the general formula RRRRNX wherein the R groups are long or short hydrocarbyl chains, typically alkyl, hydroxyalkyl or ethoxylated alkyl groups, and X is a solubilizing anion (for example, compounds in which R is a C₈-C₂₂ alkyl group, for example, a C₈-C₁₀ or C₁₂-C₁₄ alkyl group, R is a methyl group, and R and R, which may be the same or different, are methyl or hydroxyethyl groups); and cationic esters (for example, choline esters).

Amphoteric surfactants and/or zwitterionic surfactants may also be present. Some amphoteric surfactants that may be used to practice the disclosure include amine oxides.

Some zwitterionic surfactants that may be used to practice the disclosure include betaines such as the amidobetaines.

Detergent compositions according to the disclosure may suitably contain a bleach system. The bleach system can be based on peroxy bleach compounds, for example, inorganic persalts or organic peroxyacids, capable of yielding hydrogen peroxide in aqueous solution. Suitable peroxy bleach compounds include organic peroxides such as urea peroxide, and inorganic persalts such as the alkali metal per borates, percarbonates, perphosphates, persilicates and per sulfates. Suitable inorganic persalts can be sodium perborate monohydrate and tetrahydrate, and sodium percarbonate. For example, suitable is a sodium percarbonate having a protective coating against destabilization by moisture. Sodium per carbonate having a protective coating comprising sodium metaborate and sodium silicate is disclosed in GB2 123 044B (Kao).

The peroxy bleach compound is suitably present in an amount of from 5 to 35 wt %, for example from 10 to 25 wt. %.

The peroxy bleach compound may be used in conjunction with a bleach activator (bleach precursor) to improve bleaching action at low wash temperatures. The bleach precursor is suitably present in an amount of from 1 to 8 wt. %, such as from 2 to 5 wt. %.

Suitable bleach precursors are peroxycarboxylic acid pre cursors, more especially peracetic acid precursors and per oxybenzoic acid precursors; and peroxycarbonic acid precursors. An example of a useful bleach precursor suitable for use in the present disclosure is N,N,N′,N′-tetracetylethylenedi amine (TAED). Also of interest are peroxybenzoic acid pre cursors, in particular, N,N,N-trimethylammonium toluoy loxybenzene Sulphonate.

A bleach stabilizer (heavy metal sequestrant) may also be present. Suitable bleach stabilizers include ethylenediamine tetraacetate (EDTA) and the polyphosphonates, such as Dequest (Trade Mark), EDTMP.

### 6. Enzymes

The detergent compositions may also contain one or more enzymes. Suitable enzymes include, for example; proteases, amylases, cellulases, oxidases, mannanases, peroxidases and lipases usable for incorporation in detergent compositions. In particulate detergent compositions, detergency enzymes are commonly employed in granular form in amounts of from about 0.1 to about 3.0 wt %. However, any suitable physical form of an enzyme may be used in any effective amount.

### 7. Polymers

Some detergent may include cationic polymer. Cationic polymers such as those described below, when used in a laundering detergent composition at an amount ranging from about 0.01 wt. % to about 15 wt. %, is effective in improving the sudsing profile of such laundry detergent composition, in comparison with a composition of similar formulae but without such cationic polymer.

Cationic polymers of utility in detergents such as laundry detergents include the following. The cationic polymer used in the present disclosure is a terpolymer that contains three different types of structural unit. It is substantially free of, and for example, essentially free of, any other structural components. The structural unit, or monomers, can be incorporated in the cationic polymer in a random format or can be in a blocky format.

The first structural unit in the cationic polymer of the present disclosure is a nonionic structural unit derived from (meth)acrylamide (AAm). The cationic polymer contains from about 35 mol % to about 85 mol %, such as from about 55 mol % to about 85 mol %, or from about 65 mol % to about 80 mol %, of the AAm-derived structural unit.

The second structural unit in the cationic polymer is a cationic structural unit derived from any suitable water soluble cationic ethylenically unsaturated monomer, such as, for example, N,N-dialkylaminoalkyl methacrylate, N,N-dialkylaminoalkyl acrylate, N,N-dialkylaminoalkyl acrylamide, N,N-dialkylaminoalkylmethacrylamide, methacylamidoalkyl trialkylammonium salts, acrylamidoalkylltrialkylamminium salts, vinylamine, vinyl imidazole, quaternized vinyl imidazole and diallyl dialkyl ammonium salts.

For example, the second cationic structural unit may be derived from a monomer selected from the group consisting of diallyl dimethyl ammonium salts (DADMAS), N,N-dimethyl aminoethyl acrylate, N,N-dimethyl amino ethyl methacrylate (DMAM), [2-(methacryloylamino) ethyl]tri-methylammonium salts, N,N-dimethylaminopropyl acrylamide (DMAPA), N,N-dimethylaminopropyl methacrylamide (DMAPMA), acrylamidopropyl trimethyl ammonium salts (APTAS), methacrylamidopropyl trimethylammonium salts (MAPTAS), and quaternized vinylimidazole (PVi), and combinations thereof.

In some embodiments the second, cationic structural unit is derived from a diallyl dimethyl ammonium salt (DADMAS), such as, for example, diallyl dimethyl ammonium chloride (DADMAC), diallyl dimethyl ammonium fluoride, diallyl dimethyl ammonium bromide, diallyl dimethyl ammonium iodine, diallyl dimethyl ammonium bisulfate, diallyl dimethyl ammonium alkyl sulfate, diallyl dimethyl ammonium dihydrogen phosphate, diallyl dimethyl ammonium hydrogen alkyl phosphate, alkyl phosphonate, diallyl dimethyl ammonium dialkyl phosphate, alkyl phosphonate, and combinations thereof. Alternatively, the second, cationic structural unit can be derived from a [2-(methacryloylamino) ethyl]tri-methylammonium salt, such as, for example, [2-(methacryloylamino) ethyl]tr-methylammonium chloride, [2-(methacryloylamino) ethyl] tri-methylammonium fluoride, [2-(methacryloylamino) ethyl tri-methylammonium bromide, [2-(methacryloylamino)ethyl] tri-methylammonium iodine, [2-methacryloylamino) ethyl] tri-methylammonium bisulfate, [2-(methacryloylamino) ethyl] tri-methylammonium alkyl sulfat, [2-(methacryloylamino) ethyl] tri-methylammonium dihydrogen phosphate, [2-(methacryloylamino) ethyl]tri-methylammonium hydrogen alkyl phosphate, alkyl phosphonate, [2-(methacryloylamino) ethyl]tri-methylammonium dialkyl phosphate, alkyl phosphonate, and combinations thereof. Further, the second cationic structural unit can be derived from APTAS, which include, for example, acrylamidopropyl trimethyl ammonium chloride (APTAC), acrylamidopropyl trimethyl ammonium fluoride, acrylamidopropyl trimethyl ammonium bromide, acrylamidopropyl trimethyl ammonium iodine, acrylamidopropyl trimethyl ammonium bisulfate, acrylamidopropyl trimethyl ammonium alkyl sulfate, acrylamidopropyl trimethyl ammonium dihydrogen phosphate, acrylamidopropyl trimethyl ammonium hydrogen alkyl phosphate, alkyl phosphonate, acrylamidopropyl trimethyl ammonium dialkyl phosphate, alkyl phosphonate, and combinations thereof. Still further, the second cationic structural unit can be derived from a MAPTAS, which includes, for example, methacrylamidopropyl trimethylammonium chloride (MAPTAC), methacrylamidopropyl trimethylammonium fluoride, methacrylamidopropyl trimethylammonium bromide, methacrylamidopropyl trimethylammonium iodine, methacrylamidopropyl trimethyl ammonium bisulfate, methacrylamidopropyl trimethylammonium alkylsulfate, methacrylamidopropyl trimethylammonium dihydrogen phosphate, methacrylamidopropyl trimethylammonium hydrogen alkyl phosphate, alkyl phosphonate, methacrylamidopropyl trimethylammonium dialkylphosphate, and combinations thereof.

The second cationic structural unit is present in the cationic polymer in an amount ranging from about 10 mol % to about 65 mol %, for example, from about 15 mol % to about 60 mol %, or from about 15 mol % to about 30 mol %.

Presence of the first, nonionic structural unit at a relatively large amount (e.g., 65 mol % to 80 mol %) and the second, cationic structural unit at a moderate amount (e.g., 15 mol % to 30 mol %) ensures good sudsing benefit as well as good finish product appearance. If the first, nonionic structural unit is present at less than 65 mol % and if the second, cationic structural unit is present at more than 30 mol %, the sudsing benefit or the finished product appearance starts to suffer, e.g., the rinse suds volume may increase significantly, or the finished product is no longer transparent but appears turbid. Similarly, if the first, nonionic structural unit is present at more than 85 mol % and if the second, cationic structural unit is present at less than 10 mol %, the rinse suds volume increases to a level that is no longer acceptable for the purpose of the present disclosure.

The third structural unit in the cationic polymer is an anionic structural unit derived from (meth) acrylic acid (AA) or anhydride thereof. The cationic polymer may contain from about 0.1 mol % to about 35 mol %, such as from 0.2 mol % to about 20 mol %, or, from about 0.5 mol % to about 10 mol %, or even from about 1 mol % to about 5 mol %, of the third anionic structural unit.

Presence of the third anionic structural unit at a relatively small amount (e.g., 1 mol % to 5 mol %) helps to increase hydrophilicity of the resulting polymer and may in turn lead to better cleaning, especially better clay removal. Too much of the third anionic structure unit (e.g., greater than 30 mol %) may compromise the sudsing benefit of the resulting polymer.

### II. Dry Cleaning

According to some aspects of the disclosure, a formulation for dry cleaning process is provided for in-home dry cleaning comprising a dry cleaning step of contacting a laundry article stained with particulate soil with a dry cleaning composition wherein the liquor to cloth ratio (w/w) (LCR) is at most 20, and wherein said composition comprises
a) a non-flammable, non-chlorine containing organic dry cleaning solvent; b) a cleaning effective amount an acid surfactant.

In some embodiments the dry cleaning step is a low aqueous dry cleaning step and the composition is a low aqueous dry cleaning composition comprising 0.01 to 10 wt. % of water.

According to yet another aspect of the disclosure, one dry cleaning process further comprises a non-aqueous dry cleaning step wherein the laundry article contacted with a non-aqueous dry cleaning composition, the non-aqueous dry cleaning composition comprising 0.001 to 10 wt. % of a surfactant; 0 to 0.01 wt. % of water; 0 to 50 wt. % of a cosolvent and a non-flammable, non-chlorine containing organic dry cleaning solvent. According to another aspect of the disclosure a sequential dry cleaning process is provided comprising:
a) a non-aqueous dry cleaning step, wherein the articles are contacted with a non-aqueous dry cleaning composition said non-aqueous dry cleaning composition comprising 0.001 to 10 wt. % of a surfactant; 0 to 0.01 wt. % of water; 0 to 50 wt. % of a cosolvent and a non-flammable, non-chlorine containing organic dry cleaning solvent; b) at least one low-aqueous dry cleaning step, wherein the articles are contacted with a low aqueous dry cleaning composition said low aqueous dry cleaning composition comprising 0.001 to 10 wt. % of a cleaning effective amount an acids surfactant; 0.01 to 50 wt. % of water; 0 to 50 wt. % of a cosolvent; and a non-flammable, non-chlorine containing organic dry cleaning solvent; and, optionally, at least one rinsing step, wherein the articles are contacted with a rinse composition said rinse composition comprising 0 to 0.0001 wt. % of a surfactant; 0 to 10 wt. % of water; 0 to 50 wt. % of a cosolvent and a non-flammable, non-chlorine containing organic dry cleaning solvent.

Depending on the desired cleaning, the low aqueous and non-aqueous compositions may be used in any order. However, in some cases it will be useful to contact the articles with a non-aqueous composition prior to a low aqueous dry cleaning composition. In fact, the low aqueous dry cleaning step may be followed or preceded with various other steps such as a regeneration, garment care treatment and/or rinsing step, and, in fact, any other step known to the person skilled in the art.

Some aspects of the present disclosure may be especially suitable for cleaning a laundry article stained with domestic stain material selected from the group including kitchen grease, particulate soil and mixtures thereof. Therefore, according to one embodiment the dry cleaning process may comprise the step of contacting a laundry article with a dry cleaning composition whereby the laundry article is stained with domestic stain material selected from kitchen grease, particulate soil and mixtures thereof. Typical particulate Soil stains comprises any particulate matter which is capable of staining garments, such as dirt, mud, sand, charcoal, make up, deodorant, toothpaste but also corroded iron particles and mixtures thereof. Kitchen grease usually comprises edible fats and oils of animal or vegetable origin such as lard, sunflower oil, soy oil, olive oil, palm oil, peanut oil, rapeseed oil and mixtures thereof.

Generally, articles such as clothing are cleaned by contacting an effective amount of the dry cleaning composition according to one aspect of the disclosure with the articles for an effective period of time to clean the articles or otherwise remove stains. for example, the laundry article is immersed in the dry cleaning composition. The amount of dry cleaning composition used and the amount of time the com position contacts the article can vary based on equipment and the number of articles being cleaned. Normally, the dry cleaning process will comprise at least one step of contacting the article with dry cleaning composition according to the first aspect of the disclosure and at least one step of rinsing the article with a fresh load of dry cleaning solvent. The rinse composition will usually be comprised mainly of solvent, but cleaning agents may be added as desired.

In some aspects of the disclosure, in situ formulations of the dry cleaning compositions may be included in pretreatment compositions. Pretreating laundry articles with a pretreatment composition followed by contacting the pretreated laundry articles with the remaining ingredients of the dry cleaning composition, thereby formulating the dry cleaning composition in situ. A pretreatment step may take place manually outside the drum of the cleaning machine or mechanically inside the drum as part of a pretreatment step. The pretreatment step per se need not be immersive, i.e., it may be limited to treating the stained areas only, provided that when the laundry articles are contacted with all the ingredients making up the final dry cleaning composition, the laundry articles are immersed in said dry cleaning composition. For example, when the dry cleaning composition comprises dry cleaning solvent, water and surfactant stained areas of the laundry articles may be pretreated with a premix of water and surfactant manually or by an automated process. After an effective pretreatment time has elapsed, the laundry articles may be contacted in the drum with the remaining ingredients. The remaining dry cleaning ingredients may include the dry cleaning solvent (and optionally additional water and/or cleaning agent) to create in situ at least one dry cleaning composition according to this aspect of the disclosure. Typical, pretreatment times will be at least 5 sec but could be less than 1 day, for example, less than 1 hr., or less than 30 min. The pretreatment composition may be formulated to treat specific stains. For example, cleaning effective amounts of protease and other enzymes may be included to treat proteinaceous stains. In another embodiment, the complete dry cleaning composition is premixed in a separate premix compartment. For example, when the dry cleaning composition comprises dry cleaning solvent, surfactant and water, these may be premixed in a separate compartment before the dry cleaning composition is contacted with the laundry article. In some embodiments such a premix is in the form of an emulsion or micro emulsion. Forming a premix of for example, a water-in-oil emulsion can be brought about by any number of suitable procedures. For example, the aqueous phase containing a cleaning effective amount of surfactant can be contacted with the solvent phase by metered injection just prior to placing these components in a mixing device. Metering can be maintained such that the desired solvent/water ratio remains relatively constant. Mixing devices suitable for this practice include, for example, pump assemblies or in-line static mixers, centrifugal pumps or other types of pumps, colloid mills or other types of mills, rotary mixers, ultrasonic mixers, and other means of dispersing one liquid in another. In some embodiment a non-miscible liquid can be used to provide agitation sufficient to form an emulsion or pseudo-emulsion.

These static mixers include devices through which an emulsion is passed at high speed and in which said emulsion experiences sudden changes in direction and/or in the diameter of the channels which make up the interior of the mixers. This results in a pressure loss, which is a factor in obtaining a correct emulsion in terms of droplet size and stability.

In one variant of the method of the disclosure, the mixing steps are for example sequential. The procedure consists of mixing the solvent and emulsifier in a first stage, the premix being mixed and emulsified with the water in a second stage. In another variant of the method of the disclosure, provision is made for carrying out the above steps in a continuous mode.

The premix may take place at room temperature, which is also the temperature of the fluids and raw materials used.

A batch process such as an overhead mixer or a continuous process such as a two fluid co-extrusion nozzle, an in-line injector, an in-line mixer or an in-line screen can be used to make the emulsion. The size of the emulsion composition in the final composition can be adjusted by changing the mixing speed, mixing time, the mixing device and the viscosity of the aqueous solution. In general, by reducing the mixing speed, decreasing the mixing time, lowering the viscosity of the aqueous solution or using a mixing device that produces less shear force during mixing, one can produce an emulsion of a larger droplet size. Useful are ultrasonic mixers. Although the description above refers to the addition of surfactant, it is understood that it may also apply to the addition of cleaning agents.

### 1. Solvents

Generally, the dry cleaning solvent is usually a non-flammable, non-chlorine containing organic dry cleaning solvent. Although the term dry cleaning solvent is used in the singular, it should be noted that a mixture of solvents may also be used. Thus, the singular should be taken to encompass the plural, and vice versa. Because of the typical environmental problems associated with chlorine containing solvents, the solvent often does not contain CI atoms. In addition, the solvent should not be flammable such as most petroleum or mineral spirits having typical flash points as low as 20° C. or even lower. The term non-flammable is intended to describe dry cleaning solvents with a flash point of at least 37.8° C., such as at least 45° C., or at least 50° C. The limit of a flashpoint of at least 37.8° C. for non-flammable liquids is defined in NFPA 30, the flammable and combustible Liquids Code as issued by National Fire Protection Association, 1996 edition, Massachusetts USA. Test methods for determining the flashpoint of solvents may be the standard tests as described in NFPA30. One class of solvents is a fluorinated organic dry cleaning solvent including hydrofluorocarbon (HFC) and hydrofluoroether (HFE). However, it is often desirable to use nonflammable non-halogenated solvents such as siloxanes (see below). It should be noted that mixtures of different dry cleaning solvents may also be used.

Some solvents are non-ozone depleting and a useful common definition for the ozone depleting potential is defined by the Environmental Protection Agency in the USA: the ozone depleting potential is the ratio of the impact on ozone of a chemical compared to the impact of a similar mass of CFC-11. Thus, the ODP of CFC-11 is defined to be 1.0.

Hydrofluorocarbons may be used as solvents. One suitable hydrofluorocarbon solvent is represented by the formula C, H, F (2x+2−y) wherein x is from 3 to 8, y is from 1 to 6, the mole ratio of F/H in the hydrofluorocarbon solvent is greater than 1.6. In certain instances, X is from 4 to 6, or X is 5 and y is 2. Suitable are hydrofluorocarbon solvents selected from isomers of decafluoropentane and mixtures thereof. Also useful is 1,1,1,2,2,3,4,5,5,5-decafluoro pentane. The E.I. Du Pont De Nemours and Company markets this compound under the name Vertrel XF™.

Hydrofluoroethers (HFEs) suitable for use in the present disclosure are generally low polarity chemical compounds minimally containing carbon, fluorine, hydrogen, and catenary (that is, in-chain) oxygen atoms. HFEs can optionally contain additional catenary heteroatoms, such as nitrogen and sulphur. HFEs have molecular structures which can be linear, branched, or cyclic, or a combination thereof (such as alkyl cycloaliphatic), and are suitably free of ethylenic unsaturation, having a total of about 4 to about 20 carbon atoms. Such HFEs are known and are readily available, either as essentially pure compounds or as mixtures. The hydrofluoroethers can have a boiling point in the range from about 40° C. to about 275° C., for example, from about 50° C. to about 200° C., or from about 50° C. to about 121° C. It is very desirable that the hydrofluoroether has no flashpoint. In general, when an HFE has a flash point, decreasing the F/H ratio or decreasing the number of carbon-carbon bonds each decreases the flash point of the HFE (see WO/00 26206).

Useful hydrofluoroethers include two varieties: segregated hydrofluoroethers and omega-hydrofluoroalkylethers. Structurally, the segregated hydrofluoroethers comprise at least one mono-, di-, or trialkoxy-substituted perfluoroalkane, perfluorocycloalkane, perfluorocycloalkyl-containing perfluoroalkane, or perfluorocycloalkylene-containing perfluoroalkane compound.

Some siloxane solvents may also be used advantageously in the present disclosure. The siloxane may be linear, branched, cyclic, or a combination thereof. One example of a branched siloxane is tris (trimethylsiloxyl) silane. Examples also include linear and cyclic oligo dimethylsiloxanes. Example of a class of siloxane solvents is an alkylsiloxane represented by the formula:

R3-Si(—O—SiR2)w-R

where each R is independently chosen from an alkyl group having from 1 to 10 carbon atoms and w is an integer from 1 to 30. For example, R may be a methyl and w is 1-4, or w is 3 or 4.

Of the cyclic siloxane octamethyl cyclotetrasiloxane and decamethyl cyclopentasiloxane are particularly effective. Useful siloxanes may be selected from the group consisting of decamethyltetrasiloxane, dodecamethylpentasiloxane and mixtures thereof.

Organic solvents suitable for dry cleaning include at least one solvent selected from the group consisting of: the isomers of nonafluoromethoxybutane, nonafluoroethoxybutane and decafluoropentane, octamethyl cyclotetrasiloxane, decamethyl cyclopentasiloxane, decamethyl tetrasiloxane, dodecamethyl pentasiloxane and mixtures thereof. Suitable organic dry cleaning solvents include those selected from the group consisting of; octamethyl cyclotetrasiloxane, decamethyl cyclopentasiloxane, decamethyl tetrasiloxane, dodecamethyl pentasiloxane and mixtures thereof.

The dry cleaning compositions of the disclosure may include greater than about 50 percent by weight of organic dry cleaning solvent, such as greater than about 75 weight percent, or greater than about 80 weight percent, or even greater than about 85 weight percent, or even greater than about 95 weight percent, but often less than 100 weight percent of organic dry cleaning solvent by weight of the total dry cleaning composition. Such amounts may aid in improving drying times and maintaining a high flashpoint or no flashpoint at all. For the rinse step or the conditioning step the dry cleaning compositions may even comprise of at least 99 weight percent of organic dry cleaning solvent by weight of the total dry cleaning composition and sometimes even 100 weight percent of organic dry cleaning solvent.

In some cases, water may be used in the dry cleaning process and the amount of water is important. In those cases, the amount of water present in any step of the dry cleaning process is at such a level that laundry articles can be safely cleaned. This includes laundry articles that can only be dry cleaned. The amount of water present in the low aqueous dry cleaning composition may be from 0.01 to 50 wt. % water, or from 0.01 to 10 wt. %. The amount of water present in the non-aqueous dry cleaning composition may be from 0 to 0.1 wt. % water by weight of the dry cleaning composition or 0 to 0.01 wt. % or even 0 to 0.001 wt. % and or barely at 0 wt. %.

When the dry cleaning composition comprises water, the water to cloth ratio (w/w) (WCR) may be less than 0.45, often less than 0.35, or less than 0.25, or less than 0.2, or even less than 0.15, but usually more than 0.0001, or more than 0.001, or even more than 0.01.

When the dry cleaning process comprises more than one step, this WCR may applies to all steps in the dry cleaning process, especially when the dry cleaning composition comprises water and solvent. However, the WCR may or may not differ for each step. This WCR may also applie to each step in the dry cleaning process wherein the LCR is more than 1.

### 2. Co-solvents

The compositions of the disclosure may contain one or more cosolvents. The purpose of a cosolvent in the dry cleaning compositions of the disclosure is often to increase the solvency of the dry cleaning composition for a variety of soils. The cosolvent also enables the formation of a homogeneous solution containing a cosolvent, a dry cleaning solvent, and the soil; or a cosolvent, a dry cleaning solvent and an optional cleaning agent. As used herein, a “homogeneous composition’ is a single phased composition or a composition that appears to have only a single phase, for example, a macro-emulsion, a micro-emulsion or an azeotrope. However, if a cosolvent is used the dry cleaning composition is a non-azeotrope as azeotropes may be less robust.

Useful cosolvents of the disclosure are soluble in the dry cleaning solvent or water, are compatible with typical cleaning agents, and can enhance the solubilization of hydrophilic composite stains and oils typically found in stains on clothing, such as vegetable, mineral, or animal oils. Any cosolvent or mixtures of cosolvents meeting the above criteria may be used.

Useful cosolvents include for example, alcohols, ethers, glycol ethers, alkanes, alkenes, linear and cyclic amides, perfluorinated tertiary amines, perfluoroethers, cycloalkanes, esters, ketones, aromatics, the fully or partly halogenated derivatives thereof and mixtures thereof. The cosolvent may be selected from the group consisting of alcohols, alkanes, alkenes, cycloalkanes, ethers, esters, cyclic amides, aromatics, ketones, the fully or partly halogenated derivatives thereof and mixtures thereof. Representative examples of cosolvents which can be used in the dry cleaning compositions of the disclosure include methanol, ethanol, isopropanol, t-butyl alcohol, trifluoroethanol, pentafluoropropanol, hexafluoro-2-propanol, methyl t-butyl ether, methyltamyl ether, propylene glycol n-propyl ether, propylene glycol n-butyl ether, dipropylene glycol n-butyl ether, propylene glycol methyl ether, ethylene glycol monobutyl ether, trans-1,2-dichloroethylene, decalin, methyl decanoate, t-butyl acetate, ethyl acetate, glycol methyl ether acetate, ethyl lactate, diethyl phthalate, 2-butanone, N-alkyl pyrrolidone (such as N-methyl pyrrolidone, N-ethyl pyrroli done), methyl isobutyl ketone, naphthalene, toluene, trifluorotoluene, perfluorohexane, perfluoroheptane, perfluorooctane, perfluorotributylamine, perfluoro-2-butyl oxacyclopentane.

The cosolvent may be present in the compositions of the disclosure in an effective amount by weight to form a homogeneous composition with the other dry cleaning solvent(s) such as HFE. The effective amount of cosolvent will vary depending upon which cosolvent or cosolvent blends are used and the other dry cleaning solvent(s) used in the composition. However, the maximum amount of any particular cosolvent present in a dry cleaning composition should be kept low enough to keep the dry cleaning composition non-flammable as defined above.

In general, cosolvent may be present in the compositions of the disclosure in an amount of from about 1 to 50 wt %, for example from about 5 to about 40 wt %, or from about 10 to about 25 wt % of the total dry cleaning composition. In some cases, the cosolvent may be present amounts of from about 0.01 wt % of the total dry cleaning composition.

### 3. Surfactants

The present disclosure provides surfactants for use in cleaning products in the form of siloxane derivatives of amino acids. Thus, there is disclosed herein, the use as a surfactant of a compound of Formula I or II in a cleaning cleaning.

The present disclosure provides surfactants for use in cleaning products in the form of surfactant molecules of Formula I or II,

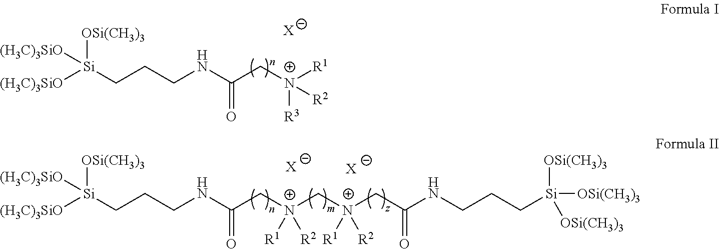

wherein R¹ and R² may be the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ may be selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to an additional surfactant molecule having a structure represented by Formula I, wherein the additional surfactant molecule of Formula I is the same or different from the surfactant molecule of Formula I;
n and z may be selected independently from any integer from 1 to 12;
m may be any integer from 1 to 12; and
X may be selected from the group consisting of chloride, bromide, and iodide.

Specifically, R³ may be selected from the group consisting of C₂-C₁₀ alkenyl, C₂-C₁₀ alkynyl, C₂-C₁₂ ester, C₁-C₁₀ hydroxyl, benzyl, C₂-C₁₂ alkoxy alkyl ether, alkyl phosphate, alkyl phosphonate, C₃-C₈ carboxylic acid, C₁-C₅ alkyl benzoic acid, and a three-carbon linker attached to a second molecule of Formula I, wherein the second molecule of Formula I is the same as the first molecule of Formula I.

More specifically, R³ may be selected from the group consisting of the formulas below:

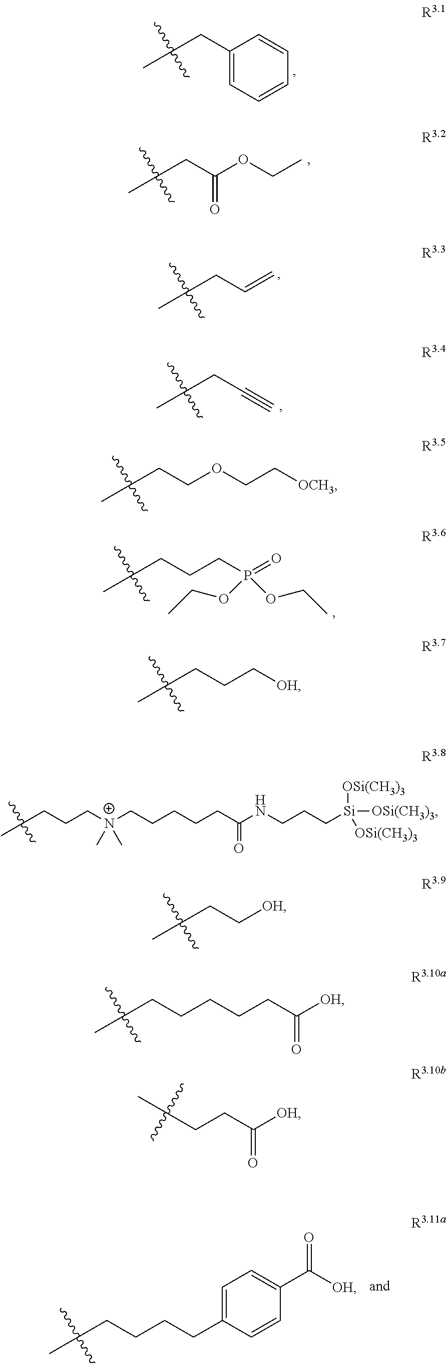

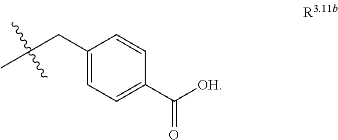 [SMILES: *Cc1ccc(C(=O)O)cc1]

In particular, suitable surfactants or co-surfactants may include one or more of any of Surfactants 1-12 described herein.

The dry-cleaning compositions of the disclosure can utilize many types of cyclic, linear or branched surfactants known in the art, both fluorinated and non-fluorinated. Solvents compatible surfactants include nonionic, anionic, cationic and zwitterionic surfactants having at least 4 carbon atoms, but can be less than 200 carbon atoms or more, and can also be less than 90 carbon atoms as described below. Solvent compatible surfactants usually have a solvent-philic part that increases the solubility of the surfactant in the dry cleaning solvent/composition. Effective surfactants may comprise of one or more polar hydrophilic groups and one or more dry cleaning solvent-philic parts having at least about 4 carbon atoms so that the Surfactant is soluble in said dry cleaning solvent/composition. It is often desirable that the surfactant is soluble in the dry cleaning composition, i.e., to at least the amount of surfactant used in the dry cleaning composition at about 20° C. The composition may comprise one or a mixture of Surfactants depending on the desired cleaning and garment care. One type of useful surfactant is an anionic surfactant. Another type of useful surfactant is a cationic surfactant.

The polar hydrophilic group, Z, can be nonionic, ionic (that is, anionic, cationic, or amphoteric), or a combination thereof. Typical nonionic moieties include polyoxyethylene and polyoxypropylene moieties. Typical anionic moieties include car boxylate, sulfonate, sulfate, or phosphate moieties. Typical cationic moieties include quaternary ammonium, protonated ammonium, imidazolines, amines, diamines, sulfonium, and phosphonium moieties. Typical amphoteric moieties include betaine, sulfobetaine, aminocarboxyl, amine oxide, and various other combinations of anionic and cationic moieties. Especially suitable surfactants comprise at least one polar hydrophilic group Z which is an anionic moiety whereby the counterion may be as described below.

The polar hydrophilic group Z can be selected from the group comprising —SOM, —SOM, —POM, —POM, —COM and mixtures thereof wherein each M can be independently selected from the group including H, NR, Na, K and Li, wherein each R is independently selected from H and C alkyl radical but is more likely H. Often M is H but in some cases salts may also be used.

The surfactant may be fluorinated, for example, a fluorinated acid. Suitable fluoro-surfactants are in most cases those according to the formula (1):

(Xf)n(Y)m(Z)p

and contain one, two or more fluorinated radicals (Xf) and one or more polar hydrophilic groups (Z), which radicals and polar hydrophilic groups are usually (but not necessarily) connected together by one or more Suitable linking groups (Y). For example, n and p are integers independently selected from 1 to 4 and m is selected from 0 to 4. When the surfactant comprises more than one Xf, Y or Z group, then each of Xf, Y and Z may be the same or different. The polar hydrophilic group may be connected by a covalent bond to Y, or in absence of Y, to Xf.

The fluorinated radical, Xf, can generally be a linear or cyclic, saturated or unsaturated, aromatic or non-aromatic, radical having at least 3 carbon atoms. The carbon chain may be linear or branched and may include hetero atoms Such as oxygen or sulfur, but usually not nitrogen. Xf is an aliphatic and saturated. A fully fluorinated Xf radical is often used, but hydrogen or chlorine may be present as substituents provided that not more than one atom of either is present for every two carbon atoms, and, for example, the radical contains at least a terminal perfluoromethyl group. Radicals containing no more than about 20 carbon atoms are often used because larger radicals usually represent a less efficient utilization of fluorine. Especially suitable Xf groups can be based on perfluorinated carbon: CF wherein n is from 1-40, for example, 2 to 26, or 2 to 18, or can be based on oligomers of hexafluoropropyleneoxide: ICF (CF)—CF. O, wherein n is from 1 to 30. Suitable examples of the latter are marketed by E.I DuPont de Nemours and Co. under the name Krytoxl™ 157, especially, Krytoxl™ 157 FSL. Fluoroaliphatic radicals containing about 2 to 14 carbon atoms are more often used.

The linking group Y is selected from groups such as alkyl, alkylene, alkylene oxide, arylene, carbonyl, ester, amide, ether oxygen, secondary or tertiary amine, Sulfonamidoalkylene, carboxamidoalkylene, alkylenesulfonamidoalkylene, alkyleneoxyalkylene, or alkylenethioalkylene or mixtures thereof. In one example Y is (CH₂), or (CH₂) O wherein t is 1 to 10, such as 1 to 6, or 2 to 4. Alternatively, Y may be absent, in which case Xf and Z are directly connected by a covalent bond.

Another suitable class of surfactants are non-fluorinated surfactants according the formula (2):

(Xh)n(Y)m(Z)p,

wherein Xh is a non-fluorinated radical and (Y), (Z), n, m and p are as described for formula I.
Xh may be a linear, branched or cyclic, saturated or unsaturated, aromatic or non-aromatic, radical can have at least 4 carbon atoms. Xh can include hydrocarbon radicals. When Xh is a hydrocarbon, the carbon chain may be linear, branched or cyclic and may include hetero atoms, such as oxygen, nitrogen or sulfur, although in some cases nitrogen may not be desirable. In some embodiments Xh is aliphatic and saturated. Radicals containing no more than about 24 carbon atoms can be used.

One example of a suitable surfactant is an acid surfactant. Some surfactants include anionic surfactants. Anionic surfactants are generally known in the art and include, for example, alkyl aryl sulfonates (such as, for example, alkylbenzene sulfonates), alkyl aryl sulfonic acids (such as, for example, Sodium and ammonium salts of toluene-, xylene- and isopro pylbenzenesulfonic acids), sulfonated amines and Sulfonated amides (such as, for example, amido sulfonates), carboxylated alcohols and carboxylated alkylphenol ethoxylates, diphenyl sulfonates, fatty esters, isethionates, lignin-based surfactants, olefin sulfonates (such as, for example, RCHCHSO₃Na, where R is C10-C16), phosphorous-based surfactants, protein based Surfactants, sarcosine-based surfactants (such as, for example, N-acylsarcosinates such as Sodium N-lauroylsarcosinate), sulfates and sulfonates of oils and/or fatty acids, sulfates and sulfonates of ethoxylated alkylphenols, sulfates of alcohols, sulfates of ethoxylated alcohols, sulfates of fatty esters, sulfates of aromatic or fluoro containing compounds, sulfo succinnamates, sulfo succinates (such as, for example, diamyl-, dioctyl- and diisobutylsulfo Succinates), taurates, and Sulfonic acids. Examples of suitable non fluorinated anionic surfactants include Crodafos™ 810A (ex Croda).

In addition to an acid surfactant other classes of surfactants may be used. Suitable surfactants include, but are not limited to, nonionic and cationic surfactants. Compounds suitable for use as the nonionic surfactant of the present disclosure are those that carry no discrete charge when dissolved in aqueous media. Nonionic surfactants are generally known in the art and include, for example, alkanol amides (such as, for example, coco, lauric, oleic and stearic monoethanolamides, diethanolamides and monoisopropanolamides), amine oxides (such as, for example, polyoxyethylene ethanolamides and polyoxyethylene propanolamides), polyalkylene oxide block copolymers (such as, for example, poly (oxyethylene co-oxypropylene)), ethoxylated alcohols, (such as, for example, isostearyl polyoxyethylene alcohol, lauryl, cetyl, stearyl, oleyl, tridecyl, trimethylnonyl, isodecyl, tridecyl), ethoxylated alkylphenols (such as, for example, nonylphonyl ethoxylated amines and ethoxylated amides, ethoxlated fatty acids, ethoxylated fatty esters and ethoxylated fatty oils (such as, for example, mono- and diesters of acids such as lauric, isostearic, pelargonic, oleic, coco, stearic, and ricinoleic, and oils such as castor oil and tall oil), fatty esters, fluorocarbon containing materials, glycerol esters (such as, for example, glycerol monostearate, glycerol monolaurate, glycerol dilaurate, glycerol monoricinoleate, and glycerol oleate), glycol esters (such as, for example, propylene glycol monostearate, ethylene glycol monostearate, ethylene glycol distearate, diethylene glycol monolaurate, diethylene glycol monolaurate, diethylene glycol monooleate, and diethylene glycol stearate), lanolin-based surfactants, monoglycerides, phosphate esters, polysaccharide ethers, propoxylated fatty acids, propoxylated alcohols, and propoxylated alkylphenols, protein-based organic surfactants, sorbitan-based surfactants (such as, for example, sorbitan oleate, sorbitan monolaurate, and sorbitan palmitate), sucrose esters and glucose esters, and thio- and mercapto-based surfactants.

Some other suitable nonionic surfactants may include polyethylene oxide condensates of nonyl phenol and myristyl alcohol, such as in U.S. Pat. No. 4,685,930 Kasprzak; and fatty alcohol ethoxylates, R—(OCH₂CH₂) OH wherein a-1 to 100, typically 1 to 30, R=Hydrocarbon residue 8 to 20 C atoms, typically linear alkyl. Examples polyoxyethylene lauryl ether, with 4 or 10 oxyethylene groups; polyoxyethylenecetyl ether with 2, 6 or 10 oxyethylene groups; polyoxyethylene stearyl ether, with 2, 5, 15, 20, 25 or 100 oxyethylene groups; polyoxyethylene oleyl ether, with 2 or 10 oxyethylene groups. Commercially available examples include but are not limited to: BRIJ and NEODOL. See also U.S. Pat. No. 6,013,683 Hill et al. Other suitable nonionic surfactants include Tween™.

Suitable cationic surfactants include, but are not limited to dialkyldimethyl ammonium salts having the formula: R″R″N″(CH)·X wherein R′ and R″ are each independently selected from the group consisting of hydrocarbon containing moiety containing 1-30 C atoms or derived from tallow, coconut oil or soy, X—Cl, I or Br. Examples include: didodecyldimethyl ammonium bromide (DDAB), dihexadecyldimethyl ammonium chloride, dihexadecyldimethyl ammonium bromide, dioctadecyldimethyl ammonium chloride, dieicosyldimethyl ammonium chloride, didoco Syldimethyl ammonium chloride, dicoconutdimethyl ammonium chloride, ditallowdimethyl ammonium bromide (DTAB). Commercially available examples include, but are not limited to: ADOGEN, ARQUAD, TOMAH, VARIOUAT. See also U.S. Pat. No. 6,013,683 Hill et al.

These and other surfactants suitable for use in combination with the organic dry cleaning solvent as adjuncts are well known in the art, being described in more detail in Kirk Othmer's Encyclopaedia of Chemical Technology, 3rd Ed., Vol. 22, pp. 360-379, “Surfactants and Detersive Systems’, incorporated by reference herein. Further suitable nonionic detergent surfactants are generally disclosed in U.S. Pat. No. 3,929,678, Laughlin et al., issued Dec. 30, 1975, at column 13, line 14 through column 16, line 6, incorporated herein by reference. Other suitable detergent surfactants are generally disclosed in WO-A-0246517.

The surfactant or mixture of surfactants is present in a cleaning effective amount. A cleaning effective amount is the amount needed for the desired cleaning. This will, for example, depend on the number of articles, level of soiling and Volume of dry cleaning composition used. Effective cleaning was observed when the surfactant was present from at least 0.001 wt. % to 10 wt. % by weight of the dry cleaning composition. For example, the surfactant is present from 0.01 to 3 wt. % or from 0.05 to 0.9 wt. % by weight of the dry cleaning composition. Alternatively, the surfactant is present from 0.1 to 0.8 wt. % or for example from 0.3 to 0.7 wt. % by weight of the dry cleaning composition.

The dry cleaning compositions may contain one or more optional cleaning agents. Cleaning agents include any agent suitable for enhancing the cleaning, appearance, condition and/or garment care. Generally, the cleaning agent may be present in the compositions of the disclosure in an amount of about 0 to 20 wt. %, such as 0.001 wt. % to 10 wt. %, or 0.01 wt. % to 2 wt. % by weight of the total dry cleaning composition.

Some suitable cleaning agents include, but are not limited to the following compounds, builders, enzymes, bleach activators, bleach catalysts, bleach boosters, bleaches, alkalinity sources, antibacterial agents, colorants, perfumes, pro-perfumes, finishing aids, lime soap dispersants, composition malodor control agents, odor neutralizers, polymeric dye transfer inhibiting agents, crystal growth inhibitors, photo-bleaches, heavy metal ion sequestrants, anti-tarnishing agents, anti-microbial agents, anti-oxidants, anti-redeposition agents, soil release polymers, electrolytes, pH modifiers, thickeners, abrasives, divalent or trivalent ions, metal ion salts, enzyme stabilizers, corrosion inhibitors, diamines or polyamines and/or their alkoxylates, suds stabilizing polymers, process aids, fabric softening agents, optical brighteners, hydrotropes, suds or foam suppressors, suds or foam boosters, fabric softeners, anti-static agents, dye fixatives, dye abrasion inhibitors, anti-crocking agents, wrinkle reduction agents, wrinkle resistance agents, soil repellency agents, Sunscreen agents, anti-fade agents, and mixtures thereof.

### III. Cleaning Compositions and Systems For Hard Surfaces

Other hard surface cleaning applications for the compounds of the disclosure include clean-in-place systems (CIP), clean-out-of-place systems (COP), washer-decontaminators, sterilizers, textile laundry machines, ultra and nano-filtration systems and indoor air filters. COP systems can include readily accessible systems including wash tanks, soaking vessels, mop buckets, holding tanks, scrub sinks, vehicle parts washers, non-continuous batch washers and systems, and the like. CIP systems include the internal components of tanks, lines, pumps and other process equipment used for processing typically liquid product streams such as beverages, milk, and juices. Generally, the actual cleaning of the in-place system or other surface (e.g., removal of unwanted offal therein) may be accomplished with a material such as a formulated detergent which is introduced with heated water. After this cleaning step, the washing/cleaning composition comprising the molecules described under this disclosure may be applied or introduced into the system at a use solution concentration, as made in unheated, ambient temperature water.

A sufficiently high flow rate may be used with the CIP composition on the order of, e.g., about 40 to about 600 liters per minute, at a slightly elevated temperature ranging from ambient up to about 70° C., allowing a contact time of the CIP system with the hard surface it intends to clean, of at least about 10 seconds, for example, about 30 to about 120 seconds. Nevertheless, a cleaning composition comprising the surfactant compounds described herein can be used in a solution in cold (e.g., 40° F./4° C.) water as well as in heated (e.g., 140° F./60° C.) water. Although it is not necessary required to use a cleaning composition comprising the compounds described herein, under some circumstances heating may be desirable to further enhance the surface activity. Accordingly, cleaning compositions comprising the surfactant molecules disclosed herein shall be useful and usable at any conceivable temperatures.

A method of sanitizing substantially fixed in-place process facilities may include the following steps. A cleaning composition comprising one or more surfactant compounds of the disclosure is introduced into the process facilities at a temperature in the range of about 4° C. to 60° C. After introduction of the use solution, the solution is held in a container or circulated throughout the system for a time sufficient to sanitize the process facilities (e.g., to kill undesirable microorganisms). After the surfaces have been sanitized by means of the present composition, the use solution is drained. Upon completion of the sanitizing step, the system optionally may be rinsed with other materials such as potable water. The used cleaning composition can then be circulated through the process facilities for further rounds of reuse or, if desirable, for purification and reformulation before being put to further use in a new cleaning-in-process round. Along these lines, the method can also include the alternative of delivering the cleaning composition comprising one or more surfactant compounds of the present disclosure via air delivery to the clean-in-place or other surfaces such as those inside pipes and tanks. In many instances, this method of air delivery can reduce the volume of solution required. This method described can readily be adapted to become a cleaning-out-of-place system.

### 1. Methods for Cleaning a Food Product Vessel.

In some aspects, the present disclosure provides for methods for cleaning a vessel or container that can be used for food contact, with a composition comprising one or more of the surfactant compounds disclosed hereunder, employing any method or apparatus suitable for applying such a composition. In some instances, the food product is placed into direct contact with a cleaning composition comprising one or more surfactant compounds of the invention, for example, the cleaning composition may be in the form of a spray, or a bath whereby the food product may be immersed therein, as a foam or gel which may be coated or otherwise applied to coat the food product, for example, using methods known to those persons in the food preparation and processing industry. The contact by the cleaning composition comprising one or more surfactant compounds of the present disclosure may take place in any location in which the food product might be found, such as field, processing site or plant, vehicle, warehouse, store, restaurant, or home.

A cleaning composition comprising one or more surfactant compounds of the present invention used in direct contact with food product may require a certain minimal contact time with the food product in order to achieve the cleansing or antimicrobial effect. The contact time can vary with concentration of the surfactant compounds used in the cleaning composition, the form of the cleaning composition, method of applying the cleaning composition, the temperature at which the cleaning composition is applied, and also often on the amount of soil or the number of microorganisms present on the food product, the type of antimicrobial agents included in the cleaning composition, or the like. The exposure time period can be at least about 5 to about 15 seconds. In some embodiments, the exposure time can be about 15 to about 30 seconds. In other embodiments, the exposure time is at least about 30 seconds.

In some embodiments, the method for washing a food product employs a pressure spray solution composition that comprises one or more surfactant compounds of the present disclosure. During application of the spray solution composition on the food product, the surface of the food product can be moved by mechanical action, e.g., agitated, rubbed, brushed, etc. Agitation can include actions such as physically scrubbing the food product, via the action of the spray solution under pressure, through sonication, or by other methods. Agitation increases the efficacy of the spray solution in killing micro-organisms, potentially due to better or higher exposure of the spray solution into the crevasses or small colonies containing the undesirable microorganisms. The spray solution, before application, can also be heated to a temperature of about 15 to 20° C., for example, about 20 to 60° C. to increase cleaning efficacy. The spray solution, once applied to the food product, can be left on the food product for a sufficient amount of time to suitably reduce the population of undesirable microorganisms before the food product is rinsed, drained, and the spray solution composition is thus evaporated off, rinsed and dried, or otherwise removed from the food product.

Application of the cleaning composition by spray can be accomplished using a manual spray wand application, an automatic spray used on a food product moving along a production line using multiple spray heads to ensure complete contact, or other spray apparatus. One automatic spray application involves the use of a spray booth. The spray booth substantially confines the sprayed cleaning composition to within the booth. The production line moves the food product through the entryway into the spray booth in which the food product is sprayed on all its exterior surfaces by sprays within the booth. After a complete coverage of the food product by the spray cleaning composition and drainage of the excess cleaning composition from the food product within the booth, the food product then exit the booth via, e.g., an automatic conveyance. The spray booth can include steam jets that can be used to apply the cleaning composition comprising one or more surfactant compounds of the disclosure. These steam jets can be used in combination with cooling water to ensure that the treatment reaching the food product surface is less than 65° C., e.g., less than 60° C. The temperature of the spray on the food product is important to ensure that the food product is not substantially altered (cooked) by the temperature of the sprayed composition. The spray pattern that can be applied may be any useful spray pattern.

Immersing a food product in a liquid cleaning composition comprising one or more surfactant compounds of the present disclosure can be accomplished by any of a variety of methods known to those of skill in the art. For example, the food product can be placed into a tank or bath containing the cleaning composition. Alternatively, the food product can be transported or processed in a flume containing the cleaning composition. The cleaning composition can be agitated to increase the efficacy of cleaning and the speed at which the composition comprising one or more of the surfactant compounds of the present disclosure can reduce the number of undesirable microorganisms initially present on the food product. Agitation can be obtained by conventional methods, including ultrasonics, aeration by bubbling air through the solution, by mechanical methods, such as strainers, paddles, brushes, pump driven liquid jets, or by combinations of these methods. The cleaning composition may be heated to increase the efficacy of killing undesirable microorganisms. After the food product has been immersed for a time sufficient for the desired antimicrobial effect, the food product can be removed from the bath or flume and the cleaning composition can be rinsed, drained, evaporated off or otherwise removed from the food product.

In other embodiments, a food product can be treated with a foaming version of a cleaning composition comprising one or more surfactant compounds of the present disclosure. The foam can for example be prepared by mixing one or more of the surfactants of the present disclosure capable of foaming and/or sustaining a foam, with a water-based solution comprising other components at the time of use. For example, the surfactant compound used to generate and sustain a form in a cleaning composition may be of nonionic, anionic or cationic in nature, including, without limitation, alcohol ethoxylates, alcohol ethoxylate carboxylate, amine oxides, alkyl sulfates, alkyl ether sulfate, sulfonates, including, for example, alkyl aryl sulfonates, quaternary ammonium compounds, alkyl sarcosines, betaines and alkyl amides. In the event the surfactant(s) and the cleaning composition is mixed at the point of use, the cleaning composition can contain about 50 ppm to about 2.0 wt-% of one or more surfactants of the present disclosure. At time of use, compressed air can be injected into the mixture, which is then applied to the food product surface through a foam application device such as a tank foamer or an aspirated wall mounted foamer.

In some embodiments, a food product can be treated with a thickened or gelled version of a cleaning composition comprising one or more of surfactant compounds of the present disclosure. In the thickened or gelled state, the cleaning composition may remain in contact with the surface of the food product for extended periods of time, thus resulting in higher antimicrobial efficacy. The thickened or gelled composition is typically more inclined to adhere to vertical surfaces, therefore resulting in better and more complete contact with the food product. The cleaning composition can be thickened or gelled using known existing technologies including, without limitation, the use of xanthan gum, polymeric thickeners, cellulose thickeners, or the like. In such applications, surfactants capable for forming rod micelles, such as, for example, amine oxides and anionic ones, having counter ions may be suitable. The thickeners or gel forming agents can be used either in the concentrated cleaning composition, or they can be mixed into the cleaning composition from a separate formulation at the time of use. Typical levels of thickeners or gel agents used in such formulations can range from about 100 ppm to about 10 wt-%.

### 2. Methods for Beverage, Food, and Pharmaceutical Processing

The surfactant compounds and compositions of the present disclosure can be used in the manufacture of beverage, food, and pharmaceutical materials including fruit juice, dairy products, malt beverages, soybean-based products, yogurts, baby foods, bottled water products, teas, cough medicines, drugs, and soft drinks. The cleaning composition may further include antimicrobial compounds to sanitize, disinfect, act as a sporicide for, or sterilize bottles, pumps, lines, tanks and mixing equipment used in the manufacture of such beverages. Further, the cleaning compositions of the present disclosure can in aseptic, cold filling operations in which the interior of the food, beverage, or pharmaceutical container is sanitized or sterilized prior to filling. In such operations, a container and its surfaces can be contacted with the sanitizing composition, typically using a spray, dipping, or filling device to intimately contact the inside of the container with the cleaning composition, for a sufficient period of time to reduce the population of the undesirable microorganisms within the container. The container can then be emptied, washed, rinsed (e.g., with potable water or sterilized water), emptied again, dried or otherwise, in order to remove the cleaning composition used to disinfect or clean it. After the cleaning composition is removed from the container, it can then be filled with the desired food product such as a beverage, a food, or a pharmaceutical. The container can then be sealed, capped or closed and then packed for shipment for ultimate sale. The sealed container can be autoclaved or retorted for added microorganism kill.

Alternatively, the container to be cleaned may be a fermentation vessel where, between each batch of food product produce using the vessel, one or more cleaning steps must be employed to remove any residual culturable organisms as well as food and plant residues used as raw materials. In such applications, it is particularly important to ensure that the spent culture and medium, as well as any contaminating microorganisms that may be introduced by the raw fruits, vegetables, seeds, grains and other culturable substances be removed as completely as possible from the vessel, in order to ensure of subsequent production batches.

In food, beverage, or pharmaceutical manufacturing, fungal microorganisms of the genus Chaetomium or Arthrinium, and spores or bacteria of the genus Bacillus spp. can be a significant problem in food bottling processes, particularly in cold aseptic bottling processes. The cleaning compositions comprising one or more surfactant compounds of the present disclosure can be used for the purpose of controlling or substantially reducing (by more than a 5 log₁₀ reduction) the number of Chaetomium or Arthrinium or Bacillus microorganisms in beverage or food or pharmaceutical bottling lines using cold aseptic bottling techniques. Those same microorganisms can become serious concerns during the manufacturing of fermented and/or cultured foods such as beers, certain alcoholic beverages, yogurts, etc., and cleaning compositions comprising one or more surfactant compounds of present disclosure may be used to achieve significant reduction of these harmful microorganisms, prevent fouling of subsequent production batches, and thus significantly reduce waste and contamination events.

In such techniques, metallic, aluminum or steel containers may be filled, glass bottles or vessels can be filled, or plastic (PET or PBT or PEN) bottles of containers, and the like, can be filled using cold aseptic filling techniques. In such processes, the cleaning compositions of the disclosure can be used to sanitize the interior of such food containers prior to filling with the food products, for example, carbonated or non-carbonated beverages. Typical carbonated beverages in this application include, but are not limited to, cola beverages, fruit beverages, ginger ale beverages, root beer beverages, iced tea beverages which may be non-carbonated, and other common beverages considered soft drinks. The cleaning compositions comprising one or more surfactant molecules of the present disclosure can be used to sanitize the tanks, lines, pumps, and other equipment used for the manufacture and store such products and can also be used in the bottling or containing the food product. In certain embodiments, the cleaning compositions of the present disclosure may be useful for killing both undesirable bacterial and fungal microorganisms that can be present on the surfaces of the production equipment and food containers.

Suitable antimicrobial agents that can effectively kill microorganisms (e.g., >1 log₁₀ or up to about 5 log₁₀ reduction in 30 seconds) may be included in the cleaning compositions of the instant disclosure from a concentration level of at least about 50 ppm, in addition to one or more surfactant molecules of the present disclosure. In an embodiment, such agents, excluding water, would be present at a concentration of about 0.001 to about 1 wt-%, for example, about 0.01 to about 0.15 wt-%, or about 0.05 to about 0.1 wt-%. In certain instances, the one or more surfactant compounds of the present disclosure may, on their own, exhibit certain microbial-killing capabilities above certain threshold concentrations. In such circumstances, the one or more surfactant compounds may alone, without additional antimicrobial agents, achieve effective killing of harmful microorganisms.

### 3. Surfactants

Suitable surfactants for use in the cleaning formulations of the present disclosure for hard surfaces, for example, in clean-in-place systems (CIP), clean-out-of-place systems (COP), washer-decontaminators, sterilizers, textile laundry machines, ultra and nano-filtration systems and indoor air filters, include one or more surfactant molecule and/or co-surfactant molecule of Formula I or II,

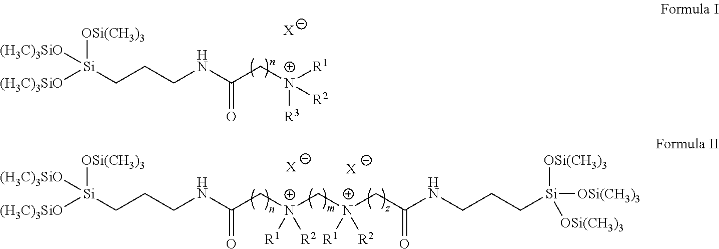

wherein R¹ and R² may be the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ may be selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to an additional surfactant molecule having a structure represented by Formula I, wherein the additional surfactant molecule of Formula I is the same or different from the surfactant molecule of Formula I;
n and z may be selected independently from any integer from 1 to 12;
m may be any integer from 1 to 12; and
X may be selected from the group consisting of chloride, bromide, and iodide.

Specifically, R³ may be selected from the group consisting of C₂-C₁₀ alkenyl, C₂-C₁₀ alkynyl, C₂-C₁₂ ester, C₁-C₁₀ hydroxyl, benzyl, C₂-C₁₂ alkoxy alkyl ether, alkyl phosphate, alkyl phosphonate, C₃-C₈ carboxylic acid, C₁-C₅ alkyl benzoic acid, and a three-carbon linker attached to a second molecule of Formula I, wherein the second molecule of Formula I is the same as the first molecule of Formula I.

More specifically, R³ may be selected from the group consisting of the formulas below:

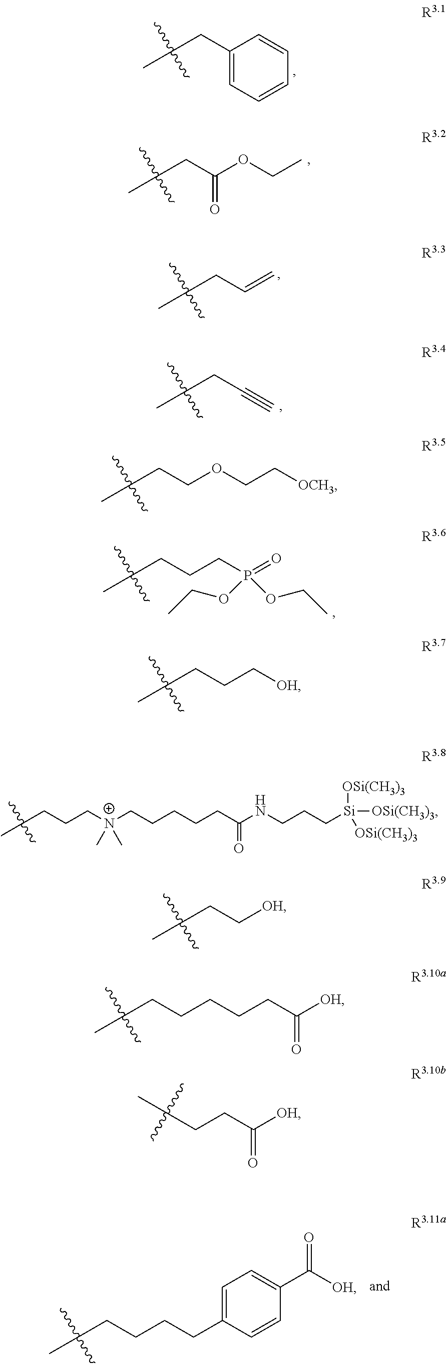

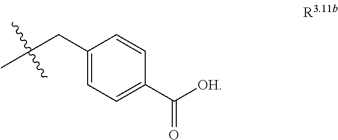 [SMILES: *Cc1ccc(C(=O)O)cc1]

In particular, suitable surfactants or co-surfactants may include one or more of any of Surfactants 1-12 described herein.

### 4. Other Additional Ingredients

In some embodiments, the cleaning compositions of the present disclosure can include other additional ingredients. Additional ingredients suitable for use with the compositions of the present disclosure include, but are not limited to, acidulants, stabilizing agents, e.g., chelating agents or sequestrants, buffers, detergents, wetting agents, defoaming agents, thickeners, foaming agents, solidification agents, aesthetic enhancing agents (i.e., colorants, odorants, or perfumes) and other cleaning agents. These additional ingredients can be preformulated with the compositions of the disclosure or added to the system before, after, or substantially simultaneously with the addition of the compositions of the present disclosure. Additionally, the cleaning compositions can be used in conjunction with one or more conventional cleaning agents, e.g., an alkaline detergent. In some examples, the cleaning composition may include a soap, a bleach, or detergent as described herein. Further, the cleaning composition may also include a cosolvent as described herein.

### Acidulants

In some embodiments, the cleaning compositions comprising one or more surfactant compounds of the present disclosure may further include an acidulant. The acidulant can act as a catalyst for conversion of carboxylic acid to peroxycarboxylic acid. The acidulant can be effective to form a concentrated cleaning composition with pH of about 0.01 to about 7 or less, a pH of about 1 to about 6, or a pH of about 2 to about 5. The acidulant can be effective to form a use composition with pH of about 4 to about 9, about 5 to about 8, about 5.5 to about 7.5. In some embodiments, an acidulant can be used to lower the pH of an alkaline cleaning solution to a pH of about 10, about 10 or less, about 9, about 9 or less, about 8, about 8 or less, about 7, about 7 or less, about 6, or about 6 or less. In certain embodiments, the acidulant includes an inorganic acid. Suitable inorganic acids include, but are not limited to, sulfuric acid, sodium bisulfate, phosphoric acid, nitric acid, hydrochloric acid. In some embodiments, the acidulant includes an organic acid. Suitable organic acids include, but are not limited to, methane sulfonic acid, ethane sulfonic acid, propane sulfonic acid, butane sulfonic acid, xylene sulfonic acid, benzene sulfonic acid, linear alkyl benzene sulphonic acid, cumene sulfonic acid, xylene sulfonic acid, formic acid, acetic acid, glycolic acid, mono, di, or tri-halocarboyxlic acids, picolinic acid, dipicolinic acid, and mixtures thereof. In some embodiments, the compositions of the present disclosure are free or substantially free of a phosphorous based acid.

In some embodiments, the acidulant selected can also function as a stabilizing agent. Thus, the compositions of the present disclosure can be substantially free of an additional stabilizing agent.

In certain embodiments, the cleaning compositions comprising one or more of the surfactant compounds of this disclosure may include further about 0.5 to about 80 wt-% acidulant, about 1 to about 50 wt %, about 5 to about 30 wt-% acidulant, or about 7 to about 14 wt-% acidulant. It is to be understood that all values and ranges between these values and ranges are encompassed by the compositions of the present disclosure.

### Stabilizing Agents

In some embodiments, the cleaning compositions comprising one or more surfactant compounds of the present disclosure include one or more stabilizing agents. The stabilizing agents can be used, for example, to stabilize the peracid and hydrogen peroxide and prevent the premature oxidation of this constituent within the cleaning compositions.

In some embodiments, an acidic stabilizing agent can be used. Thus, in some embodiments, the cleaning compositions comprising one or more surfactant compounds of the present disclosure can be substantially free of an additional acidulant.

Suitable stabilizing agents include, for example, chelating agents or sequestrants. Suitable sequestrants include, but are not limited to, organic chelating compounds that sequester metal ions in solution, particularly transition metal ions. Such sequestrants include organic amino- or hydroxy-polyphosphonic acid complexing agents (either in acid or soluble salt forms), carboxylic acids (e.g., polymeric polycarboxylate), hydroxycarboxylic acids, aminocarboxylic acids, or heterocyclic carboxylic acids, e.g., pyridine-2,6-dicarboxylic acid (dipicolinic acid).

In some embodiments, the cleaning compositions comprising one or more surfactant compounds of the present disclosure may further include dipicolinic acid as a stabilizing agent. Such cleaning compositions comprising dipicolinic acid can be formulated to be free or substantially free of phosphorous. It has also been observed that the inclusion of dipicolinic acid in a cleaning composition, such as one comprising one or more surfactant compounds of the present disclosure, may aid in achieving the phase stability of the compositions, compared to other conventional stabilizing agents, e.g., 1-hydroxy ethylidene-1,1-diphosphonic acid (CH3C(PO3H2)2OH) (HEDP).

In the event a cleaning composition comprising one or more surfactant compounds of the present disclosure contains at least one nonionic surfactant, especially one having an ethylene oxide (EO) hydrophilic block, and/or when such a composition contains at least one certain other anionic and/or certain other amine oxide surfactants, there may potentially be a risk for the cleaning composition to phase separate or suffer from visible cloudiness or haziness in appearance. In such cases, a small amount of a hydrotrope, such as sodium cumene sulfonate (“SCS”) may be added to the composition. Up to about 10 weight percent, up to about 8 weight percent, up to about 5 weight percent, and up to about 3 weight percent hydrotrope may be added to clear and/or eliminate phase separation of the cleaning composition formulation.

In other embodiments, a sequestrant can further be added to the cleaning composition comprising one or more surfactant compounds of the present disclosure. Suitable sequestrant may include phosphonic acid and/or phosphonate salt. Examples of phosphonic acids and phosphonate salts include, without limitation, HEDP; ethylenediamine tetrakis methylenephosphonic acid (EDTMP); diethylenetriamine pentakis methylenephosphonic acid (DTPMP); cyclohexane-1,2-tetramethylene phosphonic acid; amino[tri(methylene phosphonic acid)]; (ethylene diamine [tetra methylene-phosphonic acid)]; 2-phosphene butane-1,2,4-tricarboxylic acid; or salts thereof, such as the alkali metal salts, ammonium salts, or alkyloyl amine salts, such as mono, di, or tetra-ethanolamine salts; picolinic, dipicolinic acid or mixtures thereof. In some embodiments, organic phosphonates, e.g., HEDP, may be included in a cleaning composition comprising one or more surfactant compounds of the present disclosure.

Commercially available food additive chelating agents such as phosphonates sold under the trade name DEQUEST® may also be incorporated into a cleaning composition comprising one or more surfactant compounds of the present disclosure. Such chelating agent include, for example, 1-hydroxyethylidene-1,1-diphosphonic acid, available from Monsanto Industrial Chemicals Co., St. Louis, Mo., as DEQUEST® 2010; amino(tri(methylenephosphonic acid)), (N[CH2PO3H2]3), available from Monsanto as DEQUEST® 2000; ethylenediamine[tetra(methylenephosphonic acid)] available from Monsanto as DEQUEST® 2041; and 2-phosphonobutane-1,2,4-tricarboxylic acid available from Mobay Chemical Corporation, Inorganic Chemicals Division, Pittsburgh, Pa., as Bayhibit A M, and the like.

A suitable sequestrant may be an aminocarboxylic acid type sequestrant. Suitable aminocarboxylic acid type sequestrants include, for example, the acids or alkali metal salts thereof, e.g., amino acetates and salts thereof. Suitable aminocarboxylates may include, without limitation, N-hydroxyethylaminodiacetic acid; hydroxyethylenediaminetetraacetic acid, nitrilotriacetic acid (NTA); ethylenediaminetetraacetic acid (EDTA); N-hydroxyethyl-ethylenediaminetriacetic acid (HEDTA); diethylenetriaminepentaacetic acid (DTPA); and alanine-N,N-diacetic acid; and the like; and mixtures thereof.

Moreover, suitable sequestrant may include a polycarboxylate. For example, suitable polycarboxylates include, without limitation, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, polymaleic acid, polyfumaric acid, copolymers of acrylic and itaconic acid, phosphino polycarboxylate, acid or salt forms thereof, mixtures thereof, and the like.

In certain embodiments, a cleaning composition comprising one or more surfactant compounds of the present disclosure may include about 0.01 to about 10 wt-% of one or more stabilizing agents, about 0.4 to about 4 wt-% of one or more stabilizing agents, about 0.6 to about 3 wt-% of one or more stabilizing agents, about 1 to about 2 wt-% of one or more stabilizing agents. It is to be understood that all values and ranges within these values and ranges are encompassed by the present disclosure.

### Wetting or Defoaming Agents

Also useful in a cleaning composition comprising one or more surfactant compounds of the present disclosure are wetting and defoaming agents. Wetting agents function to further increase the surface contact or penetration activity, beyond such wetting properties brought about by the one or more surfactant compounds of the present disclosure. Wetting agents that may be used in the cleaning composition may include any of those constituents known within the art to raise the surface activity of a material.

Generally, defoamers which can be used in accordance with the instant disclosure include, without limitation, silica and silicones; aliphatic acids or esters; alcohols; sulfates or sulfonates; amines or amides; halogenated compounds such as fluorochlorohydrocarbons; vegetable oils, waxes, mineral oils as well as their sulfonated or sulfated derivatives; fatty acids and/or their soaps such as alkali, alkaline earth metal soaps; and phosphates and phosphate esters such as alkyl and alkaline diphosphates, and tributyl phosphates among others; and mixtures thereof.

In some embodiments, a cleaning composition comprising one or more surfactant compounds of the present disclosure may include antifoaming agents or defoamers which are of food grade quality especially if the cleaning composition is used to clean food products, food processing equipment, food containers and vessels used to produce foods and beverages, as well as pharmaceuticals. To this end, one of the more effective antifoaming agents includes silicones. Silicones such as dimethyl silicone, glycol polysiloxane, methylphenol polysiloxane, trialkyl or tetralkyl silanes, hydrophobic silica defoamers and mixtures thereof can all be used to achieve defoaming. Commercial defoamers commonly available include, without limitations, silicones such as Ardefoam® from Armour Industrial Chemical Company which is a silicone bound in an organic emulsion; Foam Kill® or Kresseo® available from Krusable Chemical Company which are silicone and non-silicone type defoamers as well as silicone esters; and Anti-Foam A® and DC-200 from Dow Corning Corporation which are both food grade type silicones among others. Defoamers can be present in a cleaning composition comprising one or more surfactant compounds of the present disclosure at a concentration range from about 0.01 wt-% to 20 wt-%, from about 0.01 wt-% to 5 wt-%, or from about 0.01 wt-% to about 1 wt-%.

In some embodiments, a cleaning composition comprising one or more surfactant compounds of the present disclosure can include antifoaming agents or defoaming agents, which are based on alcohol alkoxylates that are stable in acid environments and/or are oxidatively stable. For this, one example of the more effective antifoaming agents are the alcohol alkoxylates having an alcohol chain length of about C8-12, and more specifically C9-11, and having poly-propylene oxide alkoxylate in whole or part of the alkylene oxide portion. Commercial defoamers commonly available of this type include alkoxylates such as the BASF Degressal's; especially Degressal SD20.

### Thickening or Gelling Agents

A cleaning composition comprising one or more surfactant compounds of the present disclosure may include any of a variety of known thickeners. Suitable thickeners include, without limitation, natural gums such as xanthan gum, guar gum, or other gums from plant mucilage; polysaccharide based thickeners, such as alginates, starches, and cellulosic polymers (e.g., carboxymethyl cellulose); polyacrylates thickeners; and hydrocolloid thickeners, such as pectin. Other suitable thickeners include synthetic materials, such as for example, polyacrylates, polyacrylamides, polyalkylene glycols and derivatives including polyethylene glycols or polypropylene glycols, polyvinyl derivatives such as polyvinyl alcohols and/or polyvinyl acetates, or co-polymers thereof, and other polyvinyl derivatives, and mixtures thereof. Polycarboxylic acids are also useful as thickening agents. ACUS OL® 445 is a partially neutralized, liquid detergent polymer. Other polyacrylic acids of molecular weight 4500 (CRITERION 2005) and 8000 (CRITERION 2108) can be purchased from Kemira Chemicals, Kennesaw, Ga. Other thickening agents include, but are not limited to, Soakalan CP5 available from BASF, Coatex DE185, and Isol Dispersant HN44. In some embodiments, the thickener included is non oxidizable and storage stable under the pH conditions of the disclosure. In an embodiment, the thickener does not leave contaminating residue on the surface of an object. For example, the thickeners or gelling agents can be compatible with food or other sensitive products in contact areas. Generally, the concentration of thickener employed in a cleaning composition comprising one or more surfactant compounds of the present disclosure will be dictated by the desired viscosity within the final cleaning composition. However, as a general guideline, the viscosity of thickener within the composition shall range from about 0.1 wt-% to about 5 wt-%, from about 0.1 wt-% to about 1.0 wt-%, or from about 0.1 wt-% to about 0.5 wt-%.

### Solidification Agents

A cleaning composition comprising one or more surfactant compounds of the present disclosure may include a solidification agent, which can participate in maintaining the compositions in a solid form. In some embodiments, the solidification agent can form and/or maintain the composition as a solid. In other embodiments, the solidification agent can solidify the composition without unacceptably detracting from the eventual release of the surfactant compound(s) contained therein. The solidification agent can include, for example, an organic or inorganic solid compound having a neutral inert character or making a functional, stabilizing or detersive contribution to the cleaning composition. Suitable solidification agents include, without limitation, solid or paste polyethylene glycols (PEG), solid or paste polypropylene glycols, solid EO/PO block copolymer, amide, urea (also known as carbamide), nonionic surfactant (which can be employed with a coupler), anionic surfactant, starch that has been made water-soluble (e.g., through an acid or alkaline treatment process), cellulose that has been made water-soluble, inorganic agent, poly (maleic anhydride/methyl vinyl ether), polymethacrylic acid, other generally functional or inert materials with high melting points, mixtures thereof, and the like;

Suitable glycol solidification agents include a solid polyethylene glycol or a solid polypropylene glycol, which can, for example, have molecular weight of about 1.400 to about 30,000. In certain embodiments, the solidification agent includes or is solid PEG, for example PEG 1500 up to PEG 20,000. In certain embodiments, the PEG includes PEG 1450, PEG 3350, PEG 4500, PEG 8000, PEG 20,000, and the like. Suitable solid polyethylene glycols are commercially available from Union Carbide under the tradename CARBOWAX.

Suitable amide solidification agents include stearic monoethanolamide, lauric diethanolamide, stearic diethanolamide, stearic monoethanol amide, cocodiethylene amide, an alkylamide, mixtures thereof, and the like. In an embodiment, the present composition can include glycol (e.g., PEG) and amide.

When the one or more surfactant compounds included in a cleaning composition comprising one or more surfactant compounds of the present disclosure is a nonionic surfactant, the solidification agents to be used may include nonylphenol ethoxylate, linear alkyl alcohol ethoxylate, ethylene oxide/propylene oxide block copolymer, mixtures thereof, or the like. Suitable ethylene oxide/propylene oxide block copolymers include those sold under the Pluronic tradename (e.g., Pluronic 108 and Pluronic F68) and commercially available from BASF Corporation. In some embodiments, the nonionic surfactant included in a cleaning composition comprising one or more surfactant compounds of the present disclosure can be one that is solid at room temperature or the temperature at which the cleaning composition is stored or used. In other embodiments, the nonionic surfactant may be selected to be one with reduced aqueous solubility in combination with the coupling agent. Suitable couplers that can be employed with the nonionic surfactant solidification agent include propylene glycol, polyethylene glycol, mixtures thereof, or the like.

When the one or more surfactant compounds included in a cleaning composition comprising one or more surfactant compounds of the present disclosure is an anionic surfactant, the solidification agents to be used may include linear alkyl benzene sulfonate, alcohol sulfate, alcohol ether sulfate, alpha olefin sulfonate, mixtures thereof, and the like. In an embodiment, the solidification agent is or may include a linear alkyl benzene sulfonate. In an embodiment, the anionic surfactant included in a cleaning composition comprising one or more surfactant compounds of the present disclosure may be one that is solid at room temperature or the temperature at which the cleaning composition is stored or used.

Suitable inorganic solidification agents include, without limitation, phosphate salt (e.g., alkali metal phosphate), sulfate salt (e.g., magnesium sulfate, sodium sulfate or sodium bisulfate), acetate salt (e.g., anhydrous sodium acetate), Borates (e.g., sodium borate), Silicates (e.g., the precipitated or fumed forms (e.g., Sipernat 500 available from Degussa), carbonate salt (e.g., calcium carbonate or carbonate hydrate), other known hydratable compounds, mixtures thereof, and the like. In certain embodiments, the inorganic solidification agent can include organic phosphonate compound and carbonate salt, such as an E-Form composition.

In some embodiments, a cleaning composition comprising one or more surfactant compounds of the present disclosure can include any agent or combination of agents that provide a requisite degree of solidification and aqueous solubility in such a composition. In other embodiments, increasing the concentration of the solidification agent in the cleaning composition may increase the hardness of the composition. In yet other embodiments, decreasing the concentration of solidification agent may loosen or soften the cleaning composition. In practice, the use of such agents, and the amounts used, may be applied and adjusted to achieve the desired form of a cleaning composition.

In some embodiments, the solidification agent can include any organic or inorganic compound that imparts a solid character to and/or controls the soluble character of a cleaning composition comprising one or more surfactant compounds of the present disclosure, for example, when placed in an aqueous environment. For example, a solidifying agent can provide controlled dispensing if it has greater aqueous solubility compared to other ingredients in the composition. Urea can be one such solidification agent. By way of further example, for systems that can benefit from less aqueous solubility or a slower rate of dissolution, an organic nonionic or amide hardening agent may be appropriate.

In some embodiments, a cleaning composition comprising one or more surfactant compounds of the present disclosure may include a solidification agent that provides for convenient processing or manufacture thereof. For example, the solidification agent can be selected to form such a composition that may harden to a solid form under ambient temperatures of about 30 to about 50° C. after mixing ceases and the mixture is dispensed from the mixing system, within about 1 minute to about 3 hours, or about 2 minutes to about 2 hours, or about 5 minutes to about 1 hour.

A cleaning composition comprising one or more surfactant compounds of the present disclosure may include solidification agent at any effective amount. The amount of solidification agent included in such a composition can vary according to the type of composition, the ingredients included in the composition, the intended use of the composition, the quantity of dispensing solution applied to the solid composition over time during use, the temperature of the dispensing solution, the hardness of the dispensing solution, the physical size of the intended solid cleaning composition, the concentration of the other ingredients, the concentration of the cleaning components in the composition, and other like factors. Suitable amounts may be about 1 to about 99 wt-%, about 1.5 to about 85 wt-%, about 2 to about 80 wt-%, about 10 to about 45 wt-%, about 15% to about 40 wt-%, about 20% to about 30 wt-%, about 30% to about 70%, about 40% to about 60%, up to about 50 wt-%, about 40% to about 50%

### Carriers

In some embodiments, a cleaning composition comprising one or more surfactant compounds of the present disclosure may include a carrier. The carrier provides a medium which dissolves, suspends, or carries the other components of such a composition. For example, the carrier can provide a medium for solubilization, suspension, or production of a sulfonated peroxycarboxylic acid and for forming an equilibrium mixture. The carrier can also function to deliver and wet the composition of the disclosure on an object. To this end, the carrier can contain any component or components that can facilitate these functions.

In some embodiments, the carrier may include primarily water that promotes solubility and work as a medium for reaction and equilibrium. The carrier can alternatively include or be primarily an organic solvent, such as simple alkyl alcohols, e.g., ethanol, isopropanol, n-propanol, benzyl alcohol, and the like. Polyols are also useful carriers, which include, without limitation, glycerol, sorbitol, and the like.

Suitable carriers may include glycol ethers. Suitable glycol ethers include, without limitation, diethylene glycol n-butyl ether, diethylene glycol n-propyl ether, diethylene glycol ethyl ether, diethylene glycol methyl ether, diethylene glycol t-butyl ether, dipropylene glycol n-butyl ether, dipropylene glycol methyl ether, dipropylene glycol ethyl ether, dipropylene glycol propyl ether, dipropylene glycol tert-butyl ether, ethylene glycol butyl ether, ethylene glycol propyl ether, ethylene glycol ethyl ether, ethylene glycol methyl ether, ethylene glycol methyl ether acetate, propylene glycol n-butyl ether, propylene glycol ethyl ether, propylene glycol methyl ether, propylene glycol n-propyl ether, tripropylene glycol methyl ether and tripropylene glycol n-butyl ether, ethylene glycol phenyl ether (commercially available as DOWANOL EPH™ from Dow Chemical Co.), propylene glycol phenyl ether (commercially available as DOWANOL PPH™ from Dow Chemical Co.), and the like, or mixtures thereof. Additional suitable commercially available glycol ethers (all of which are available from Union Carbide Corp.) include, without limitation, Butoxyethyl PROPASOL™, Butyl CARBITOL™ acetate, Butyl CARBITOL™, Butyl CELLOSOLVE™ acetate, Butyl CELLOSOLVE™, Butyl DIPROPASOL™, Butyl PROPASOL™, CARBITOL™ PM-600, CARBITOL™ LOW Gravity, CELLOSOLVE™ acetate, CELLOSOLVE™, Ester EEP™, FILMER IBT™, Hexyl CARBITOL™, Hexyl CELLOSOLVE™, Methyl CARBITOL™, Methyl CELLOSOLVE™ acetate, Methyl CELLOSOLVE™, Methyl DIPROPASOL™, Methyl PROPASOL™ acetate, Methyl PROPASOL™, Propyl CARBITOL™, Propyl CELLOSOLVE™, Propyl DIPROPASOL™ and Propyl PROPASOL™.

In some embodiments, the carrier may make up a large portion of a cleaning composition comprising one or more surfactant compounds of the present disclosure, and may even be the balance of the entire composition apart from the surfactant, antimicrobial agent, oxidizing agent, additional ingredients, and the like. The carrier concentration and type will depend upon the nature of the composition as a whole, the environmental storage, and method of application including concentration of the other components, among other factors.

In certain embodiments, a cleaning composition comprising one or more surfactant compounds of the present disclosure may include about 5 to about 90 wt-% carrier, about 10 to about 80 wt % carrier, about 20 to about 60 wt % carrier, or about 30 to about 40 wt % carrier. It is to be understood that all values and ranges between these values and ranges are encompassed by the present disclosure.

### Additional Function Ingredients

In some embodiments, a cleaning composition comprising one or more surfactant compounds of the present disclosure may include additional functional ingredients. Additional functional ingredients suitable for inclusion in the compositions may be one or more of the following, but are not limited to, optical brighteners, soil antiredeposition agents, antifoam agents, low foaming surfactants, defoaming surfactants, pigments and dyes, softening agents, anti-static agents, anti-wrinkling agents, dye transfer inhibition/color protection agents, odor removal/odor capturing agents, soil shielding/soil releasing agents, ultraviolet light protection agents, fragrances, sanitizing agents, disinfecting agents, water repellency agents, insect repellency agents, anti-pilling agents, souring agents, mildew removing agents, allergicide agents, and mixtures thereof. In some embodiments, the additional functional ingredient or ingredients is formulated in the compositions. In other embodiments, the additional functional ingredient or ingredients is added separately during a cleaning process.

### Color Stabilizing Agent

In some embodiments, a cleaning composition comprising one or more surfactant compounds of the present disclosure may optionally include a color stabilizing agent. A color stabilizing agent can be any component that is included to inhibit discoloration or browning of the composition. In some embodiments, a color stabilizing agent may be included in the compositions at an amount of from about 0.01 to about 5 wt %, from about 0.05 to about 3 wt %, and from about 0.10 to about 2 wt %.

### Optical Brighteners

In some embodiments, a cleaning composition comprising one or more surfactant compounds of the present disclosure may optionally include an optical brightener. Brighteners are added to laundry detergents to replace whitening agents removed during washing and to make the clothes appear cleaner. Optical brighteners may include dyes that absorb light in the ultraviolet and violet region (usually 340-370 nm) of the electromagnetic spectrum, and re-emit light in the blue region (typically 420-470 nm). These additives are often used to enhance the appearance of the color of a fabric, causing a perceived “whitening” effect, making materials look less yellow by increasing the overall amount of blue light reflected. In some embodiments, optical brighteners suitable for inclusion in the compositions may include, but are not limited to, triazine-stilbenes (di-, tetra- or hexa-sulfonated), coumarins, imidazolines, diazoles, triazoles, benzoxazolines, biphenyl-stilbenes, and mixtures thereof. One or more optical brighteners may be used in the compositions. In some embodiments, optical brighteners are included in the compositions at an amount of from about 0.1 to about 5 wt %, from about 0.15 to about 3 wt %, or from about 0.2 to about 2 wt %. Examples of commercially available optical brighteners suitable for use in the compositions include, but are not limited to, DMS-X and CBS-X, a distyryl biphenyl derivative, both available from Vesta-Intracon BV

### Soil Antiredeposition Agents

In some embodiments, a cleaning composition comprising one or more surfactant compounds of the present disclosure may optionally include antiredeposition agents. Without wishing to be bound by any particular theory, it is thought that antiredeposition agents aid in preventing loosened soil from redepositing onto cleaned fabrics. Antiredeposition agents may be made from complex cellulosic materials such as carboxymethylcellulose (CMC), or synthetic materials such as polyethylene glycol and polyacrylates. In other embodiments, polyphosphate builders may be included as an antiredeposition agent.

There is set out above the disclosure of formulations comprising at least one surfactant of Formula I or II for use in various cleaning products. The following disclosure of the compounds of Formula I and II applies to the compounds of Formula I and II in any of the disclosed uses and formulations set out herein.

Further compounds provided by the present disclosure are those compounds of Formula I wherein R1 and R2 are methyl.

Other compounds provided by the present disclosure are compounds of Formula I, wherein n and/or z are 5.

As used herein, the phrase “n may be an integer from 1 to 12” means that n may be equal to 1, 2, 3, 4, 5, 6, 7, 8, 9, 10, 11, and/or 12.

As used herein, the phrase “C1-C6 alkyl” means a straight chain or branched alkyl group containing 1, 2, 3, 4, 5, and/or 6 carbons.

As used herein, the phrase “C1-C6 linker” means a straight chain or branched alkyl chain containing 1, 2, 3, 4, 5, and/or 6 carbons.

As used herein, the phrase “C2-C10 alkenyl” means a straight chain or branched alkenyl group containing 2, 3, 4, 5, 6, 7, 8, 9, and/or 10 carbons.

As used herein, the phrase “C2-C10 alkynyl” means a straight chain or branched alkynyl group containing 2, 3, 4, 5, 6, 7, 8, 9, and/or 10 carbons.

As used herein, the phrase “C2-C12 ester” means a straight chain or branched ester group having a total of 2, 3, 4, 5, 6, 7, 8, 9, 10, 11 and/or 12 carbons.

As used herein, the phrase “C2-C12 alkoxy alkyl ether” means a straight chain or branched alkoxy alkyl ether group having a total of 2, 3, 4, 5, 6, 7, 8, 9, 10, 11 and/or 12 carbons.

As used herein, the phrase “C1-C10 hydroxyl” means a hydroxyl attached to a straight chain or branched alkyl group containing 1, 2, 3, 4, 5, 6, 7, 8, 9, and/or 10 carbons.

As used herein, the phrase “C3-C8 carboxylic acid” means a carboxylic acid group attached to a straight chain or branched alkyl group with a containing 3, 4, 5, 6, 7, and/or 8, carbons.

As used herein, the phrase “C1-C10 alkyl benzoic acid” means a benzoic acid group attached to a straight chain or branched alkyl group containing 1, 2, 3, 4, 5, 6, 7, 8, 9, and/or 10 carbons.

As used herein, the phrase “n and z may be selected independently from any integer from 1 to 12” means that n and z may be independently 1, 2, 3, 4, 5, 6, 7, 8, 9, 10, 11, and/or 12.

As used herein, the phrase “m may be any integer from 1 to 12” means that m may be 1, 2, 3, 4, 5, 6, 7, 8, 9, 10, 11, and/or 12.

As used herein, the phrase “q may be any integer from 1 to 10” means that q may be 1, 2, 3, 4, 5, 6, 7, 8, 9, and/or 10.

One specific compound provided by the present disclosure and referred to herein as Surfactant 1 is N-benzyl-6-((3-(1,1,1,5,5,5-hexamethyl-3-((trimethylsilyl)oxy)trisiloxan-3-yl)propyl)amino)-N,N-dimethyl-6-oxohexan-1-aminium bromide, having the following formula:

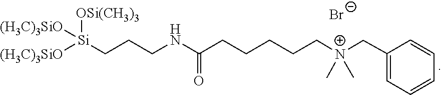

A second specific compound provided by the present disclosure and referred to herein as Surfactant 2 is N-(2-ethoxy-2-oxoethyl)-6-((3-(1,1,1,5,5,5-hexamethyl-3-((trimethylsilyl)oxy)trisiloxan-3-yl)propyl)amino)-N,N-dimethyl-6-oxohexan-1-aminium bromide, having the following formula:

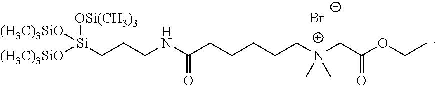

A third specific compound provided by the present disclosure and referred to herein as Surfactant 3 is N-allyl-6-((3-(1,1, 1,5,5,5-hexamethyl-3-((trimethylsilyl)oxy)trisiloxan-3-yl)propyl)amino)-N,N-dimethyl-6-oxohexan-1-aminium iodide, having the following formula:

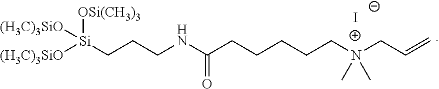

A fourth specific compound provided by the present disclosure and referred to herein as Surfactant 4 is 6-((3-(1,1,1,5,5,5-hexamethyl-3-((trimethylsilyl)oxy)trisiloxan-3-yl)propyl)amino)-N,N-dimethyl-6-oxo-N-(prop-2-yn-1-yl)hexan-1-aminium bromide, having the following formula:

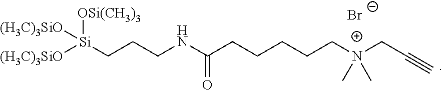

A fifth specific compound provided by the present disclosure and referred to herein as Surfactant 5 is 6-((3-(1,1,1,5,5,5-hexamethyl-3-((trimethylsilyl)oxy)trisiloxan-3-yl)propyl)amino)-N-(2-(2-methoxyethoxy)ethyl)-N,N-dimethyl-6-oxohexan-1-aminium bromide, having the following formula:

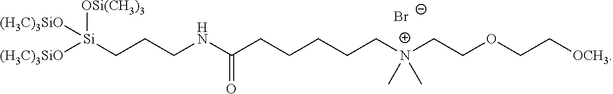

A sixth specific compound provided by the present disclosure and referred to herein as Surfactant 6 is N-(3-(diethoxyphosphoryl) propyl)-6-((3-(1,1,1,5,5,5-hexamethyl-3-((trimethylsilyl)oxy)trisiloxan-3-yl)propyl)amino)-N,N-dimethyl-6-oxohexan-1-aminium bromide, having the following formula:

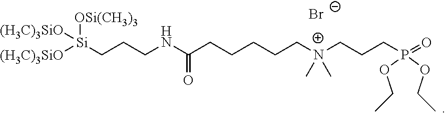

A seventh specific compound provided by the present disclosure and referred to herein as Surfactant 7 is 6-((3-(1,1,1,5,5,5-hexamethyl-3-((trimethylsilyl)oxy)trisiloxan-3-yl)propyl)amino)-N-(3-hydroxypropyl)-N,N-dimethyl-6-oxohexan-1-aminium iodide, having the following formula:

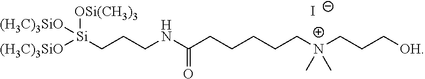

An eighth specific compound provided by the present disclosure and referred to herein as Surfactant 8 is 6-((3-(1,1, 1,5,5,5-hexamethyl-3-((trimethylsilyl)oxy)trisiloxan-3-yl)propyl)amino)-N-(2-hydroxyethyl)-N,N-dimethyl-6-oxohexan-1-aminium iodide, having the following formula:

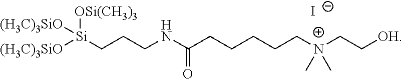

A ninth specific compound provided by the present disclosure and referred to herein as Surfactant 9 is N-(5-carboxypentyl)-6-((3-(1,1,1,5,5,5-hexamethyl-3-((trimethylsilyl)oxy)trisiloxan-3-yl)propyl)amino)-N,N-dimethyl-6-oxohexan-1-aminium bromide, having the following formula:

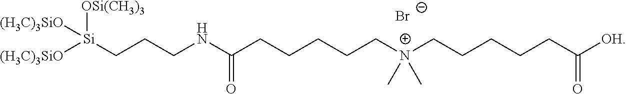

An tenth specific compound provided by the present disclosure and referred to herein as Surfactant 10 is N¹,N³-bis(6-((3-(1,1, 1,5,5,5-hexamethyl-3-((trimethylsilyl)oxy)trisiloxan-3-yl)propyl)amino)-6-oxohexyl)-N¹,N¹,N³,N³-tetramethylpropane-1,3-diaminium dibromide, having the formula:

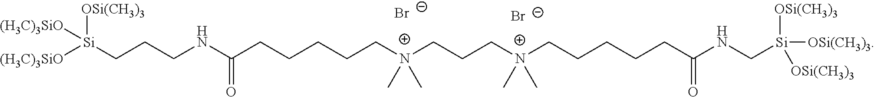

A further group of specific compounds provided by the present disclosure and referred to herein as Surfactant 11-12 have the general formula:

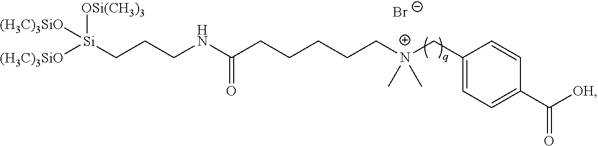

wherein q may be an integer from 1 to 10.

An eleventh specific compound provided by the present disclosure and referred to herein as Surfactant 11 is N-(4-(4-carboxyphenyl)butyl)-6-((3-(1,1,1,5,5,5-hexamethyl-3-((trimethylsilyl)oxy)trisiloxan-3-yl)propyl)amino)-N,N-dimethyl-6-oxohexan-1-aminium bromide, having the formula:

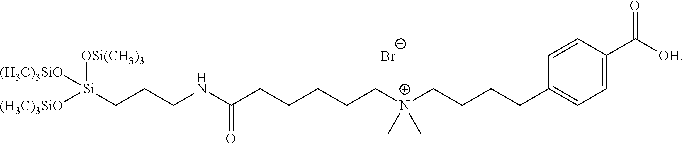

A twelfth specific compound provided by the present disclosure and referred to herein as Surfactant 12 is N-(4-carboxybenzyl)-6-((3-(1,1,1,5,5,5-hexamethyl-3-((trimethylsilyl)oxy)trisiloxan-3-yl)propyl)amino)-N,N-dimethyl-6-oxohexan-1-aminium bromide, having the formula:

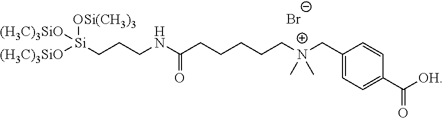

These compounds may be synthesized by various methods. One such method includes reacting an amino acid, such as an N-alkylated or N-acylated amino acid, with a siloxane to convert the amino acid C-terminus to the desired siloxane derivative. The amino acid N-terminus may be further alkylated to yield a quaternary amine, for example.

The amino acid may be naturally occurring or synthetic or may be derived from a ring opening reaction of a lactam, such as caprolactam. The ring-opening reaction may be either an acid or alkali catalyzed reaction, and an example of an acid catalyzed reaction is shown below in Scheme 1.

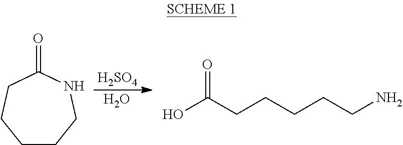

The amino acid may have as few as 1 or as many as 12 carbons between the N- and C-terminii, such as 1, 2, 3, 4, 5, 6, 7, 8, 9, 10, 11, or 12 carbons. The alkyl chain may be branched or straight. The alkyl chain may be interrupted with nitrogen, oxygen, or sulfur. The alkyl chain may be further substituted with one or more substituents selected from the group consisting of hydroxyl, amino, amido, sulfonyl, sulfonate, carboxyl, and carboxylate. The N-terminal nitrogen may be acylated or alkylated with one or more alkyl groups. For example, the amino acid may be 6-(dimethylamino)hexanoic acid.

The siloxane may be substituted with one or more alkoxy groups, such as methoxy, ethoxy, isopropoxy, tertiary butoxy, and others. The siloxane may be further substituted with one or more alkyl groups, such as propyl, wherein the alkyl group may yet be further substituted with an appropriate functional group to permit coupling of the siloxane to the amino acid, such as a nitrogen. For example, the siloxane may be 3-aminopropyltris(trimethylsiloxy)silane.

The siloxane derivative of the amino acid may be synthesized as shown below in Scheme 2. As shown, 6-aminohexanoic acid may be alkylated at the N-terminus by treatment with formaldehyde in formic acid at reflux to give 6-(dimethylamino)hexanoic acid. The free carboxylic acid is then coupled to 3-aminopropyl(trismethylsiloxy)silane in refluxing toluene to give the desired siloxane derivative.

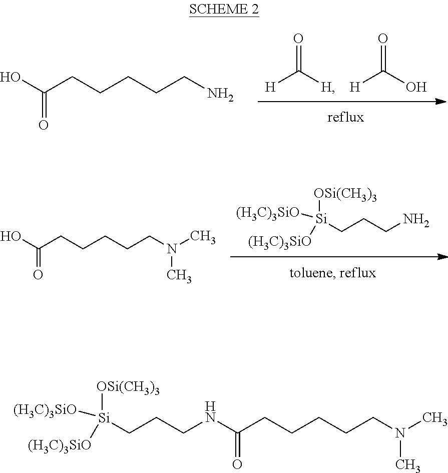

The N-terminal nitrogen may be further derivatized to modify or improve water solubility and surface-active properties. A sample synthetic scheme is shown below in Scheme 3, in which the N-terminal nitrogen is alkylated to provide a quaternary amine.

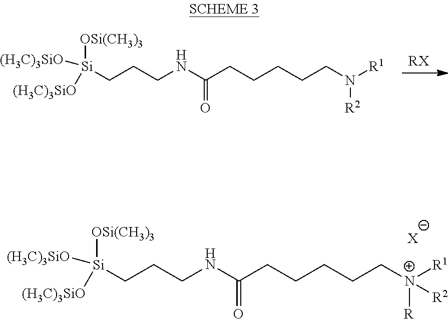

Suitable alkylating agents may include benzyl bromide, ethyl bromoacetate, allyl iodide, propargyl bromide, 1-bromo-2-(2-methoxyethoxy)ethane, bromo phosphonate, 3-iodopropanol, 3-bromopropanol, 2-iodoethanol, 2-bromoethanol, 6-bromohexanoic acid, 4-(4-bromobutyl)benzoic acid, and 4-(bromomethyl)benzoic acid, for example. Two molecules of Formula I may be linked by treating the N-terminal nitrogen with a difunctional alkylating agent, such as 1,3-dibromopropane for example.

The compounds of the present disclosure demonstrate surface-active properties. These properties may be measured and described by various methods. One method by which surfactants may be described is by the molecule's critical micelle concentration (CMC). CMC may be defined as the concentration of a surfactant at which micelles form, and above which all additional surfactant is incorporated into micelles.

As surfactant concentration increases, surface tension decreases. Once the surface is completely overlaid with surfactant molecules, micelles begin to form. This point represents the CMC, as well as the minimum surface tension. Further addition of surfactant will not further affect the surface tension. CMC may therefore be measured by observing the change in surface tension as a function of surfactant concentration. One such method for measuring this value is the Wilhemy plate method. A Wilhelmy plate is usually a thin iridium-platinum plate attached to a balance by a wire and placed perpendicularly to the air-liquid interface. The balance is used to measure the force exerted on the plate by wetting. This value is then used to calculate the surface tension (γ) according to Equation 1:

$$γ = F / l cos θ \qquad Equation 1$$

wherein I is equal to the wetted perimeter (2w+2d, in which w and d are the plate thickness and width, respectively) and cos θ, the contact angle between the liquid and the plate, is assumed to be 0 in the absence of an extant literature value.

Another parameter used to assess the performance of surfactants is dynamic surface tension. The dynamic surface tension is the value of the surface tension for a particular surface or interface age. In the case of liquids with added surfactants, this can differ from the equilibrium value. Immediately after a surface is produced, the surface tension is equal to that of the pure liquid. As described above, surfactants reduce surface tension; therefore, the surface tension drops until an equilibrium value is reached. The time required for equilibrium to be reached depends on the diffusion rate and the adsorption rate of the surfactant.

One method by which dynamic surface tension is measured relies upon a bubble pressure tensiometer. This device measures the maximum internal pressure of a gas bubble that is formed in a liquid by means of a capillary. The measured value corresponds to the surface tension at a certain surface age, the time from the start of the bubble formation to the occurrence of the pressure maximum. The dependence of surface tension on surface age can be measured by varying the speed at which bubbles are produced.

Surface-active compounds may also be assessed by their wetting ability on solid substrates as measured by the contact angle. When a liquid droplet comes in contact with a solid surface in a third medium, such as air, a three-phase line forms among the liquid, the gas and the solid. The angle between the surface tension unit vector, acting at the three-phase line and tangent at the liquid droplet, and the surface is described as the contact angle. The contact angle (also known as wetting angle) is a measure of the wettability of a solid by a liquid. In the case of complete wetting, the liquid is completely spread over the solid and the contact angle is 0°. Wetting properties are typically measured for a given compound at the concentration of 1-100×CMC; however, it is not a property that is concentration-dependent. Therefore, measurements of wetting properties can be measured at concentrations that are higher or lower.

In one method, an optical contact angle goniometer may be used to measure the contact angle. This device uses a digital camera and software to extract the contact angle by analyzing the contour shape of a sessile droplet of liquid on a surface.

Potential applications for the surface-active compounds of the present disclosure include formulations for use as shampoos, hair conditioners, detergents, spot-free rinsing solutions, floor and carpet cleaners, cleaning agents for graffiti removal, wetting agents for crop protection, adjuvants for crop protection, and wetting agents for aerosol spray coatings.

It will be understood by one skilled in the art that small differences between compounds may lead to substantially different surfactant properties, such that different compounds may be used with different substrates, in different applications. It will be further understood by one skilled in the art that surfactant properties may not be predictable on the basis of chemical structure, as further demonstrated below. For example, Surfactant 9 and the Comparative Surfactant, which differ only in the number of methylene groups in R3, demonstrate different surfactant properties. Surprisingly, Surfactant 9 demonstrates excellent activity, as described further below, while the Comparative Surfactant demonstrates inferior surfactant properties.

The following non-limiting embodiments are provided to demonstrate the different properties of the different surfactants. In Table 1 below, short names for the surfactants are correlated with their corresponding chemical structures.

TABLE 1

| Surfactant | Formula & Name |
|---|---|
| Surfactant 1 | 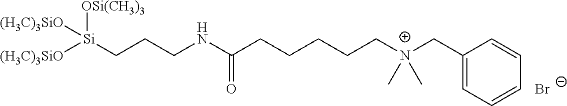 N-benzyl-6-((3-(1,1,1,5,5,5-hexamethyl-3- ((trimethylsilyl)oxy)trisiloxan-3-yl)propyl)amino)-N,N- dimethyl-6-oxohexan-1-aminium bromide |
| Surfactant 2 | 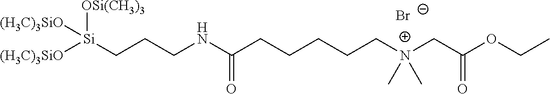 N-(2-ethoxy-2-oxoethyl)-6-((3-(1,1,1,5,5,5-hexamethyl-3- ((trimethylsilyl)oxy)trisiloxan-3-yl)propyl)amino)-N,N- dimethyl-6-oxohexan-1-aminium bromide |
| Surfactant 3 | 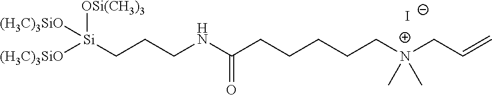 N-allyl-6-((3-(1,1,1,5,5,5-hexamethyl-3- ((trimethylsilyl)oxy)trisiloxan-3-yl)propyl)amino)-N, N- dimethyl-6-oxohexan-1-aminium iodide |
| Surfactant 4 | 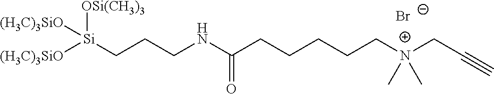 6-((3-(1,1,1,5,5,5-hexamethyl-3- ((trimethylsilyl)oxy)trisiloxan-3-yl)propyl)amino)-N,N- dimethyl-6-oxo-N-(prop-2-yn-1-yl)hexan-1-aminium bromide |
| Surfactant 5 | 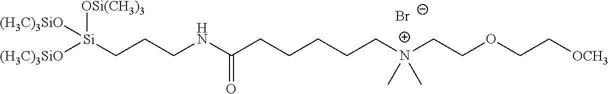 6-((3-(1,1,1,5,5,5-hexamethyl-3- ((trimethylsilyl)oxy)trisiloxan-3-yl)propyl)amino)-N-(2-(2- methoxyethoxy)ethyl)-N,N-dimethyl-6-oxohexan-1- aminium bromide |
| Surfactant 6 | 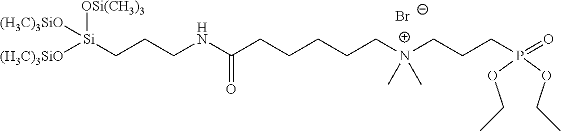 N-(3-(diethoxyphosphoryl)propyl)-6-((3-(1,1,1,5,5,5- hexamethyl-3-((trimethylsilyl)oxy)trisiloxan-3- yl)propyl)amino)-N,N-dimethyl-6-oxohexan-1-aminium bromide |
| Surfactant 7 | 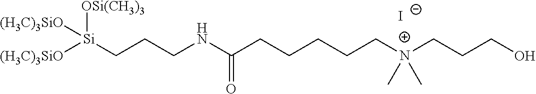 6-((3-(1,1,1,5,5,5-hexamethyl-3- ((trimethylsilyl)oxy)trisiloxan-3-yl)propyl)amino)-N-(3- hydroxypropyl)-N,N-dimethyl-6-oxohexan-1-aminium iodide |
| Surfactant 8 | 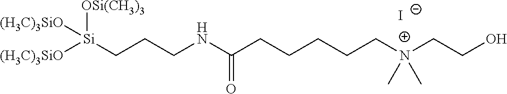 6-((3-(1,1,1,5,5,5-hexamethyl-3- ((trimethylsilyl)oxy)trisiloxan-3-yl)propyl)amino)-N-(2- hydroxyethyl)-N,N-dimethyl-6-oxohexan-1-aminium iodide |
| Surfactant 9 | 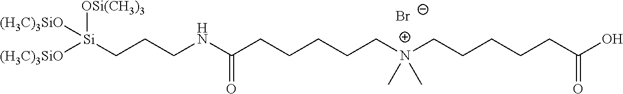 N-(5-carboxypentyl)-6-((3-(1,1,1,5,5,5-hexamethyl-3- ((trimethylsilyl)oxy)trisiloxan-3-yl)propyl)amino)-N,N- dimethyl-6-oxohexan-1-aminium bromide |
| Surfactant 10 | 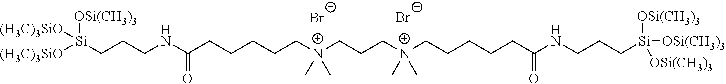 N¹, N³-bis(6-((3-(1,1,1,5,5,5-hexamethyl-3- ((trimethylsilyl)oxy)trisiloxan-3-yl)propyl)amino)-6- oxohexyl)-N¹, N¹, N³, N³-tetramethylpropane-1,3-diaminium dibromide |
| Surfactant 11-12 | 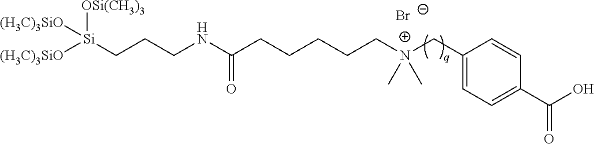 |
| Surfactant 11 | 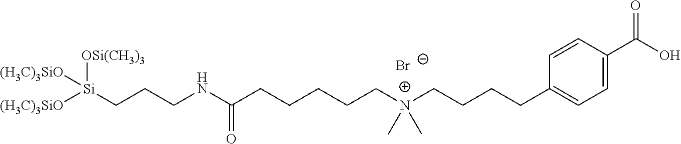 N-(4-(4-carboxyphenyl)butyl)-6-((3-(1,1,1,5,5,5- hexamethyl-3-((trimethylsilyl)oxy)trisiloxan-3- yl)propyl)amino)-N,N-dimethyl-6-oxohexan-1-aminium bromide |
| Surfactant 12 | 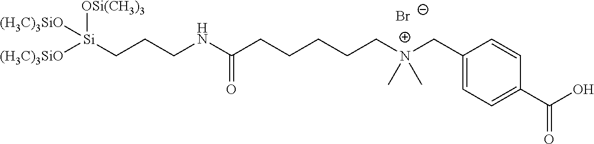 N-(4-carboxybenzyl)-6-((3-(1,1,1,5,5,5-hexamethyl-3- ((trimethylsilyl)oxy)trisiloxan-3-yl)propyl)amino)-N,N- dimethyl-6-oxohexan-1-aminium bromide |

These compounds may be effective as surface-active agents, useful for wetting or foaming agents, dispersants, emulsifiers, and detergents, in any of the formulations contemplated by this disclosure.

The amount of the compounds disclosed herein used in a formulation may be as low as about 0.001 wt. %, about 0.05 wt. %, about 0.1 wt. %, about 0.5 wt. %, about 1 wt. %, about 2 wt. %, or about 5 wt. %, or as high as about 8 wt. %, about 10 wt. %, about 15 wt. %, about 20 wt. %, or about 25 wt. %, about 30 wt. %, about 40 wt. %, about 50 wt. %, about 80 wt. %, or within any range of 0.001 wt. % to 80 wt. %, or 0.05 wt. % to 50 wt. %, or 0.1 wt. % to 20 wt. %, or 0.5 wt. % to 10 wt. %, or 1 wt. % to 8 wt. %, or 2 wt. % to 8 wt. %, or 5 wt. % to 8 wt. %, or within any range using any two of the foregoing values.

Table 2 includes a comparative surfactant, including name and structure.

TABLE 2

| Surfactant | Formula & Name |
|---|---|
| Comparative Surfactant | 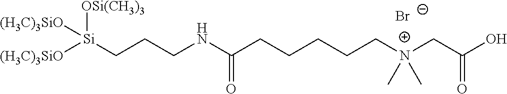 N-(carboxymethyl)-6-((3-(1,1,1,5,5,5-hexamethyl-3- ((trimethylsilyl)oxy)trisiloxan-3-yl)propyl)amino)-N,N- dimethyl-6-oxohexan-1-aminium bromide |

The surfactants useful in the formulations disclosed herein may have a critical micelle concentration (CMC) of less than about 15 mmol, less than about 10 mmol, less than about 5 mmol, less than about 1 mmol, less than about 0.8 mmol, less than about 0.7 mmol, less than about 0.6 mmol, less than about 0.5 mmol, less than about 0.4 mmol, less than about 0.3 mmol, less than about 0.2 mmol, less than about 0.1 mmol, less than about 0.05 mmol, or less than about 0.01 mmol, or may have any CMC that falls within a range encompassed by the foregoing endpoints. For example, the surfactant may have a CMC of from about 0.01 to about 15 mmol, from about 0.05 to about 10 mmol, or from about 0.1 to about 5 mmol.

The surfactants useful in the formulations disclosed herein may have a plateau value of minimum surface tension of less than about 25 mN/m, less than about 24 mN/m, less than about 23 mN/m, less than about 22 mN/m, less than about 21 mN/m, less than about 20 mN/m, less than about 19 mN/m, less than about 18 mN/m, less than about 17 mN/m, less than about 16 mN/m, or less than about 15 mN/m, or may have any plateau value of minimum surface tension that falls within a range encompassed by the foregoing endpoints. For example, the surfactant may have a plateau value of minimum surface tension of from about 15 to about 25 mN/m, from about 18 to about 22 mN/m or from about 20 to about 21 mN/m.

Surfactants with Antimicrobial Activities

Cells are fundamental units of all living organisms, which all have individual set of organelles that are responsible for the respective cell's ability to perform various kinds of functions, store genetic information for the development and functioning of the organisms. The outside boundaries of cells are called cell membranes, which serve as barriers and regulate the transport of materials between the inside and outside of the cells. Cell membranes can be destroyed through a process called lysis, resulting in cell deaths, which fundamentally underlie all antimicrobial processes. The use of surfactants which have an intrinsic biocidal activities to clean surfaces, foods and in various other applications, can be highly important especially in situations where the cleaning treatment cannot tolerate the use of chemical biocidal agents.

Traditionally cationic surfactants have been used as antimicrobial agents in industries such as the food industry and hospitals. Unlike traditional antimicrobial chemicals, which rely on a “lock-key” mechanism, cationic surfactants are known to exert antimicrobial activities by disintegrating bacterial membranes via electrostatic and hydrophobic interactions. Zhou & Wang, Structure-activity relationship of cationic surfactants as antimicrobial agents., Current Opinion in Colloids & Interface Science, 45:28-43 (2020). To serve as a good antimicrobial agent a surfactant would need to sufficiently kill bacteria or other unwanted pathogenic microbes without perturbing mammalian cells. Today, with the rising awareness of potential cytotoxicity and environmental hazards caused by certain chemicals, there has also been concerted efforts to develop surfactants that have reduced cytotoxicity concerns that may arise due to the lack of selectivity of conventional quaternary ammonium type of surfactants which are known to indiscriminately disrupt the bio-membranes, regardless of cell types.

Surfactants of the present disclosure have been shown in a standard protocol to assess antimicrobial activities called minimum inhibitory concentration (MIC) tests. The tables below shows the MIC results of examples of surfactants of the present disclosure.

| | Interval | Result | |
|---|---|---|---|
| Surfactant 6 | | | |
| Inoculum: P. aeruginosa (9027), serial | 24 hours | Not determined | |
| dilution 1:10; 2000 ppm max | | | |
| Inoculum: S. aureus (6538), serial dilution | 24 hours | 138 +/− 57 | ppm |
| 1.7 fold; 400 ppm max | | | |
| Inoculum: E. coli (8739), serial dilution | 24 hours | Not determined | |
| 1:10; 2000 ppm max | | | |
| Inoculum: S. mutans (25715) serial | 24 hours | 81 +/− 34 | ppm |
| dilution 1.7 fold; 400 ppm max | | | |
| Surfactant 7 | | | |
| Inoculum: P. aeruginosa (9027), serial | 24 hours | 81 +/− 34 | ppm |
| dilution 1.7 fold; 400 ppm max | | | |
| Inoculum: S. aureus (6538), serial dilution | 24 hours | Not determined | |
| 1:10; 2000 ppm max | | | |
| Inoculum: E. coli (8739), serial dilution 1.7 | 24 hours | 81 +/− 34 | ppm |
| fold; 400 ppm max | | | |
| Inoculum: S. mutans (25715) serial | 24 hours | Not determined | |
| dilution 1:10; 2000 ppm max | | | |
| Surfactant 9 | | | |
| Inoculum: P. aeruginosa (9027), serial | 24 hours | Not determined | |
| dilution 1:10; 2000 ppm max | | | |
| Inoculum: S. aureus (6538), serial dilution | 24 hours | 138 +/− 57 | ppm |
| 1.7 fold; 400 ppm max | | | |
| Inoculum: E. coli (8739), serial dilution | 24 hours | Not determined | |
| 1:10; 2000 ppm max | | | |
| Inoculum: S. mutans (25715) serial | 24 hours | 81 +/− 34 | ppm |
| dilution 1.7 fold; 400 ppm max | | | |
| ADBAC control | | | |
| Inoculum: P. aeruginosa (9027), serial | 24 hours | 48 +/− 20 | ppm |
| dilution 1.7 fold; 400 ppm max | | | |
| Inoculum: S. aureus (6538), serial dilution | 24 hours | 7 +/− 3 | ppm |
| 1.7 fold; 20 ppm max | | | |
| noculum: E. coli (8739), serial dilution 1.7 | 24 hours | 16 +/− 7 | ppm |
| fold; 20 ppm max | | | |
| Inoculum: S. mutans (25715) serial | 24 hours | 7 +/− 3 | ppm |

dilution 1.7 fold; 20 ppm max

### EXAMPLES

Nuclear magnetic resonance (NMR) spectroscopy was performed on a Bruker 500 MHz spectrometer. The critical micelle concentration (CMC) was determined by the Wilhelmy plate method at 23° C. with a tensiometer (DCAT 11, DataPhysics Instruments GmbH) equipped with a Pt—Ir plate. Dynamic surface tension was determined with a bubble pressure tensiometer (Krüss BP100, Krüss GmbH), at 23° C. Contact angle was determined with the optical contact angle goniometer (OCA 15 Pro, DataPhysics GmbH) equipped with a digital camera.

### Example 1: Synthesis of 6-(dimethylamino)-N-(3-(1,1,1,5,5,5-hexamethyl-3-((trimethylsilyl)oxy)trisiloxan-3-yl)propyl)hexanamide

6-(Dimethylamino)hexanoic acid (2.00 g, 12.56 mmol, 1 equiv.) was dissolved in toluene (50 mL) in a 100 mL round bottom boiling flask equipped with a Dean Stark trap, then 3-aminopropyltris(trimethylsiloxy)silane (5.48 mL, 13.81 mmol, 1.1 equiv.) was added. The reaction vessel was heated, and the reaction refluxed for 24 hours until no more water separated in the Dean Stark tube. The solvent was removed under vacuum to give the desired siloxane derivative as a yellow oil in 94% yield. ¹H NMR (500 MHz, DMSO) δ: 0.09 (s, 27H), 0.28-0.31 (m, 2H), 1.12-1.26 (m, 2H), 1.27-1.30 (m, 4H), 1.38-1.41 (m, 2H), 1.94 (t, J=7.3 Hz, 2H), 2.00 (s, 6H), 2.06-2.03 (m, 2H), 2.89 (dd, J=12.9, 6.8 Hz, 2H).

### Example 2a: Synthesis of N-benzyl-6-((3-(1,1,1,5,5,5-hexamethyl-3-((trimethylsilyl)oxy)trisiloxan-3-yl)propyl)amino)-N,N-dimethyl-6-oxohexan-1-aminium bromide (Surfactant 1)

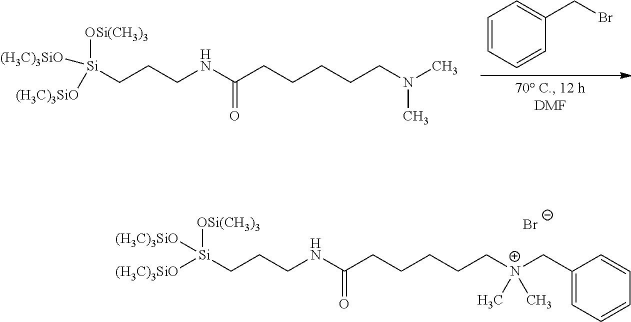

The siloxane derivative described in Example 1 (1 g, 2.02 mmol) was dissolved in dimethylformamide (DMF) (15 mL). Benzyl bromide (518 mg, 3.03 mmol) was added, and the mixture was heated to 70° C. for 12 hours. The solvent was removed under vacuum and the crude product was washed twice with acetone to remove excess benzyl bromide and give Surfactant 1 as a yellow solid (1.1 g).

### Example 2b: Determination of Physical Properties of Surfactant 1

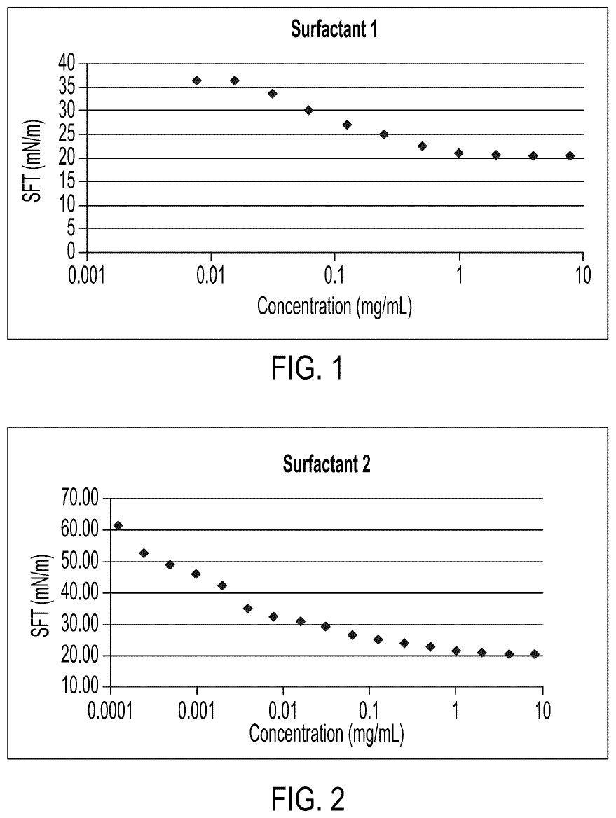

The critical micelle concentration (CMC) for Surfactant 1 was measured. From the surface tension change with concentration in water, the CMC was determined to be about 9.883 mmol at pH 8. The plateau value of minimum surface tension that can be reached by this surfactant was around 20.67 mN/m, indicating that the surfactant has outstanding interfacial activity. These results are plotted as surface tension versus concentration in FIG. 1.

### Example 3a: Synthesis of N-(2-ethoxy-2-oxoethyl)-6-((3-(1,1,1,5,5,5-hexamethyl-3-((trimethylsilyl)oxy)trisiloxan-3-yl)propyl)amino)-N,N-dimethyl-6-oxohexan-1-aminium bromide (Surfactant 2)

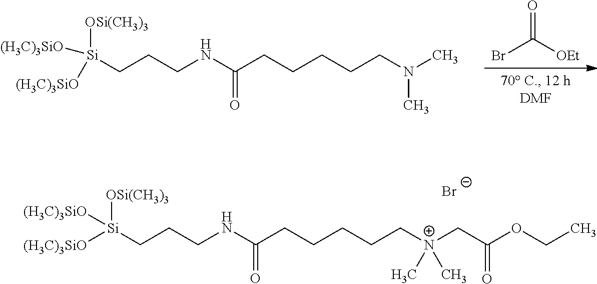

The siloxane derivative described in Example 1 (1 g, 2.02 mmol) was dissolved in DMF (15 mL), and ethyl bromoacetate (0.25 mL, 2.4 mmol) was added. The mixture was stirred for 12 hours at 70° C. The solvent was removed under vacuum, and the crude product was washed twice with hexane two times to give Surfactant 2 as a brown liquid (900 mg).

### Example 3b: Determination of Physical Properties of Surfactant 2

The critical micelle concentration (CMC) for Surfactant 2 was measured. From the surface tension change with concentration in water, the CMC was determined to be about 0.2171 mmol. The plateau value of minimum surface tension that can be reached by this surfactant was around 20.36 mN/m, indicating that the surfactant has outstanding interfacial activity. These results are plotted as surface tension versus concentration in FIG. 2.

### Example 4a: Synthesis of N-allyl-6-((3-(1,1,1,5,5,5-hexamethyl-3-((trimethylsilyl)oxy)trisiloxan-3-yl)propyl)amino)-N,N-dimethyl-6-oxohexan-1-aminium iodide (Surfactant 3)

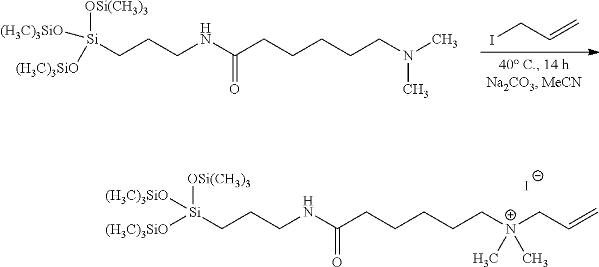

The siloxane derivative described in Example 1 (1.00 g, 2.02 mmol) was added to acetonitrile (10 mL), followed by sodium carbonate (0.26 g), then allyl iodide (674 mg). The reaction was refluxed for 14 hours at 40° C. Residual sodium carbonate was removed via filtration and the filtrate was concentrated. The crude product was washed twice with hexane to remove excess allyl iodide to give Surfactant 3 as a brown liquid (850 mg).

### Example 4b: Determination of Physical Properties of Surfactant 3

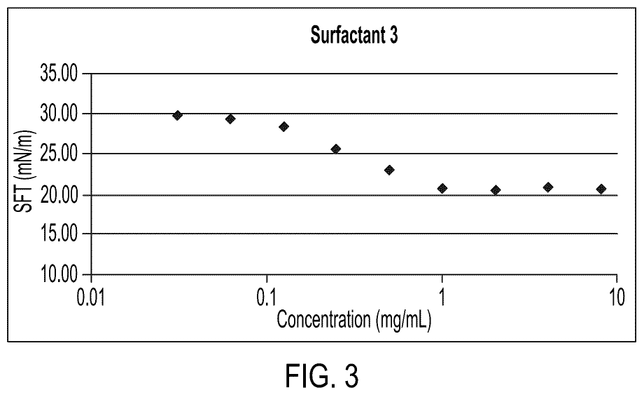

The critical micelle concentration (CMC) for Surfactant 3 was measured. From the surface tension change with concentration in water, the CMC was determined to be about 1.3599 mmol. The plateau value of minimum surface tension that can be reached by this surfactant was about 20.67 mN/m, indicating that the surfactant has outstanding interfacial activity. These results are plotted as surface tension versus concentration in FIG. 3.

### Example 5a: Synthesis of 6-((3-(1,1,1,5,5,5-hexamethyl-3-((trimethylsilyl)oxy)trisiloxan-3-yl)propyl)amino)-N,N-dimethyl-6-oxo-N-(prop-2-yn-1-yl)hexan-1-aminium bromide (Surfactant 4)

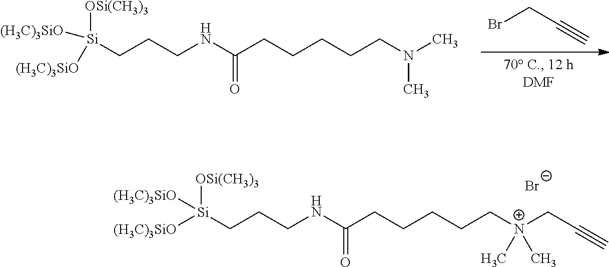

The siloxane derivative described in Example 1 (1.00 g, 2.02 mmol) was dissolved in dimethylformamide (DMF) (15 mL). Propargyl bromide (674 mg, 2.4 mmol) was added, and the mixture was stirred for 12 hours at 70° C. The solvent was removed under vacuum, and the crude product was washed twice with hexanes to give Surfactant 4 as a brown liquid (850 mg).

### Example 5b: Determination of Physical Properties of Surfactant 4

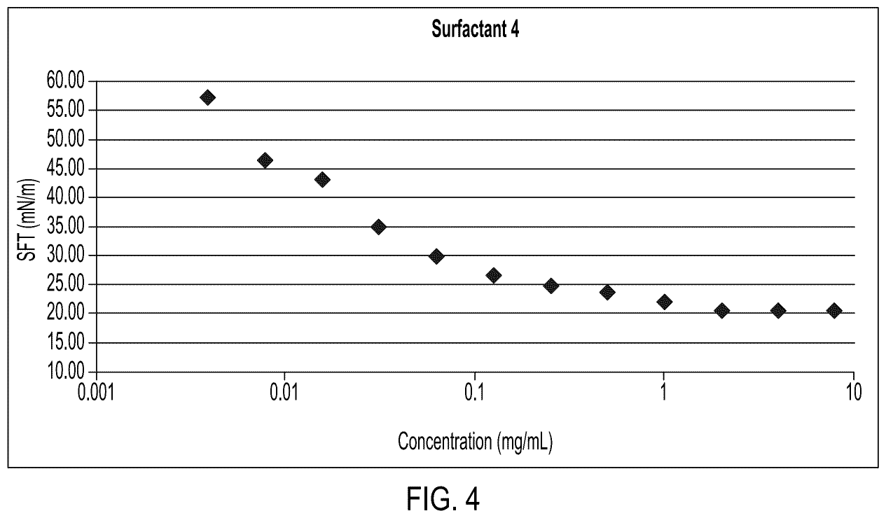

The critical micelle concentration (CMC) for Surfactant 4 was measured. From the surface tension change with concentration in water, the CMC was determined to be about 0.2419 mmol. The plateau value of minimum surface tension that can be reached by this surfactant was about 20.54 mN/m, indicating that the surfactant has outstanding interfacial activity. These results are plotted as surface tension versus concentration in FIG. 4.

### Example 6a: Synthesis of 6-((3-(1,1,1,5,5,5-hexamethyl-3-((trimethylsilyl)oxy)trisiloxan-3-yl)propyl)amino)-N-(2-(2-methoxyethoxy)ethyl)-N,N-dimethyl-6-oxohexan-1-aminium bromide (Surfactant 5)

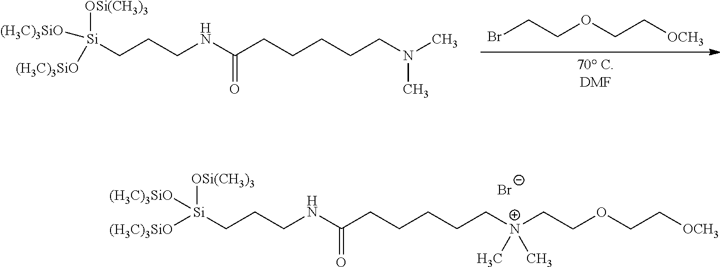

The siloxane derivative described in Example 1 (1.00 g, 2.02 mmol) was dissolved in dimethylformamide (DMF) (15 mL). 1-Bromo-2-(2-methoxyethoxy)ethane (2.4 mmol) was added, and the mixture was stirred for 12 hours at 70° C. The solvent was removed under vacuum, and the crude product was washed twice with hexanes to give Surfactant 5 as a brown liquid (800 mg).

### Example 6b: Determination of Physical Properties of Surfactant 5

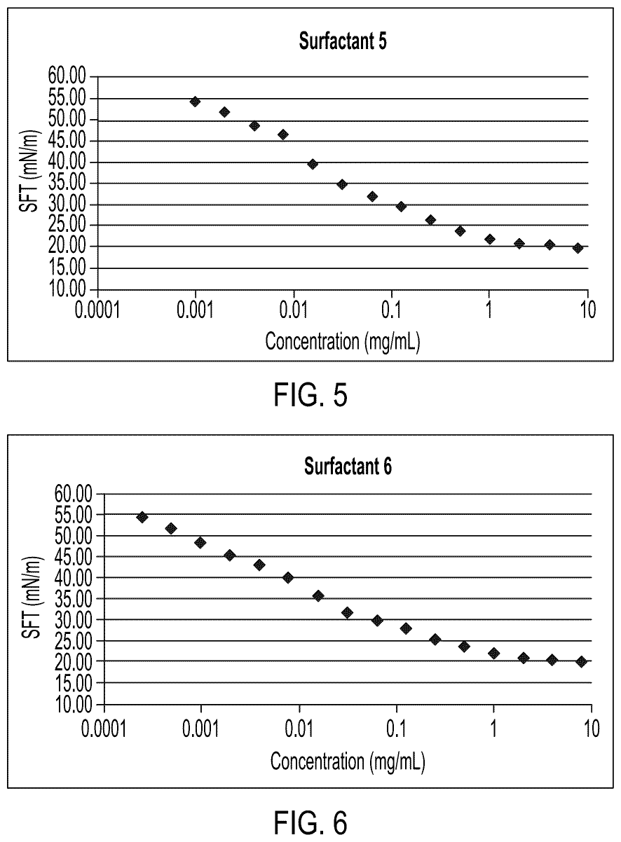

The critical micelle concentration (CMC) for Surfactant 5 was measured. From the surface tension change with concentration in water, the CMC was determined to be about 0.4622 mmol. The plateau value of minimum surface tension that can be reached by this surfactant was about 20.40 mN/m, indicating that the surfactant has outstanding interfacial activity. These results are plotted as surface tension versus concentration in FIG. 5.

### Example 7a: Synthesis of N-(3-(diethoxyphosphoryl) propyl)-6-((3-(1,1,1,5,5,5-hexamethyl-3-((trimethylsilyl)oxy)trisiloxan-3-yl)propyl)amino)-N,N-dimethyl-6-oxohexan-1-aminium bromide (Surfactant 6)

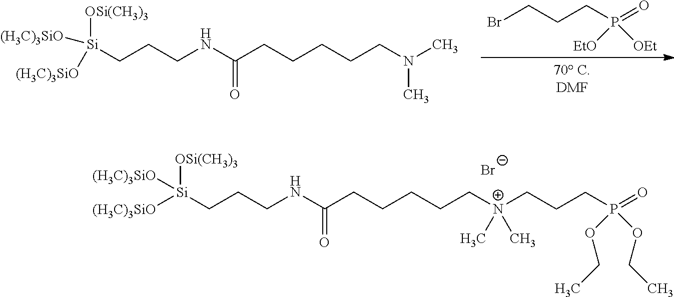

The siloxane derivative described in Example 1 (1.00 g, 2.02 mmol) was dissolved in dimethylformamide (DMF) (20 mL). Bromo phosphonate (4.04 mmol) was added, and the mixture was stirred for 12 hours at 70° C. The solvent was removed under vacuum, and the crude product was washed twice with hexanes to give Surfactant 6 as a brown liquid (900 mg).

### Example 7b: Determination of Physical Properties of Surfactant 6

The critical micelle concentration (CMC) for Surfactant 6 was measured. From the surface tension change with concentration in water, the CMC was determined to be about 0.3989 mmol. The plateau value of minimum surface tension that can be reached by this surfactant was about 20.48 mN/m, indicating that the surfactant has outstanding interfacial activity. These results are plotted as surface tension versus concentration in FIG. 6.

### Example 8a: Synthesis of 6-((3-(1,1,1,5,5,5-hexamethyl-3-((trimethylsilyl)oxy)trisiloxan-3-yl)propyl)amino)-N-(3-hydroxypropyl)-N,N-dimethyl-6-oxohexan-1-aminium iodide (Surfactant 7)

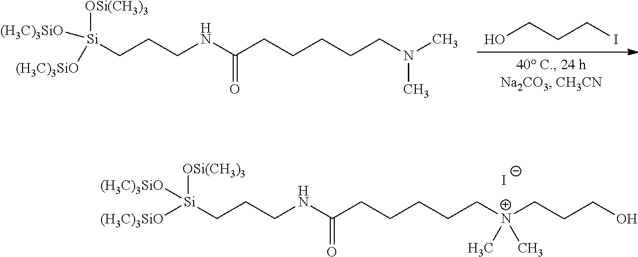

The siloxane derivative described in Example 1 (1.00 g, 2.02 mmol) was dissolved in acetonitrile (10 mL). Sodium carbonate (0.26 g) was added, followed by 3-iodopropanol (674 mg). The mixture was stirred for 24 hours at 40° C. Residual base was removed via filtration and the filtrate was concentrated. The crude product was washed twice with hexanes to remove excess iodopropanol and give Surfactant 7 as a brown liquid (780 mg).

### Example 8b: Determination of Physical Properties of Surfactant 7

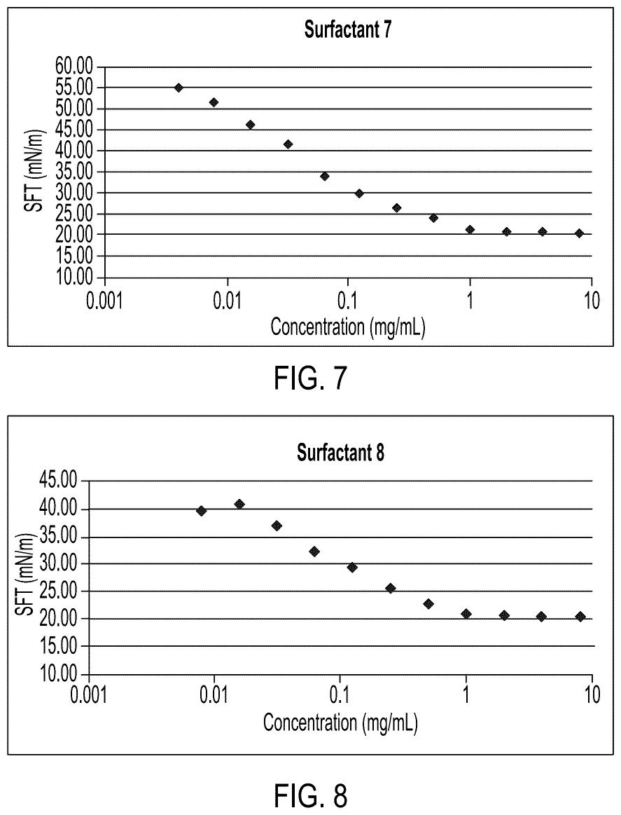

The critical micelle concentration (CMC) for Surfactant 7 was measured. From the surface tension change with concentration in water, the CMC was determined to be about 0.4568 mmol. The plateau value of minimum surface tension that can be reached by this surfactant was about 20.61 mN/m, indicating that the surfactant has outstanding interfacial activity. These results are plotted as surface tension versus concentration in FIG. 7.

### Example 9a: Synthesis of 6-((3-(1,1,1,5,5,5-hexamethyl-3-((trimethylsilyl)oxy)trisiloxan-

3-yl)propyl)amino)-N-(2-hydroxyethyl)-N,N-dimethyl-6-oxohexan-1-aminium iodide (Surfactant 8)

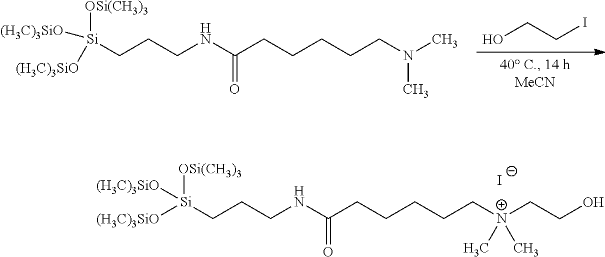

The siloxane derivative described in Example 1 (1.00 g, 2.02 mmol) was dissolved in acetonitrile (10 mL). 2-Iodoethanol (4.04 mmol) was added, and the mixture was stirred for 14 hours at 40° C. The solvent was removed, and the crude product was washed twice with hexanes to give Surfactant 8 (910 mg).

### Example 9b: Determination of Physical Properties of Surfactant 8

The critical micelle concentration (CMC) for Surfactant 8 was measured. From the surface tension change with concentration in water, the CMC was determined to be about 0.9986 mmol. The plateau value of minimum surface tension that can be reached by this surfactant was about 20.41 mN/m, indicating that the surfactant has outstanding interfacial activity. These results are plotted as surface tension versus concentration in FIG. 8.

### Example 10a: Synthesis of N¹,N³-bis(6-((3-(1,1,1,5,5,5-hexamethyl-3-((trimethylsilyl)oxy)trisiloxan-3-yl)propyl)amino)-6-oxohexyl)-N¹,N¹,N³,N³-tetramethylpropane-1,3-diaminium dibromide (Surfactant 10)

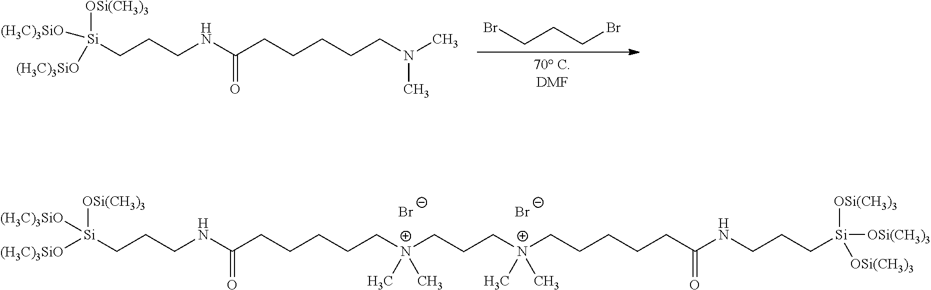

The siloxane derivative described in Example 1 (1.00 g, 2.02 mmol) was dissolved in dimethylformamide (DMF) (20 mL). 1,2-Dibromopropane (1 mmol) was added, and the mixture was stirred for 12 hours at 70° C. The solvent was removed, and the crude product was washed twice with hexanes to give Surfactant 10 as a brown liquid (900 mg).

### Example 10b: Determination of Physical Properties of Surfactant 10

The critical micelle concentration (CMC) for Surfactant 10 was measured. From the surface tension change with concentration in water, the CMC was determined to be about 0.0631 mmol. The plateau value of minimum surface tension that can be reached by this surfactant was about 22.12 mN/m, indicating that the surfactant has interfacial activity. These results are plotted as surface tension versus concentration in FIG. 10.

### Example 11a: Synthesis of N-(5-carboxypentyl)-6-((3-(1,1,1,5,5,5-hexamethyl-3-((trimethylsilyl)oxy)trisiloxan-3-yl)propyl)amino)-N,N-dimethyl-6-oxohexan-1-aminium bromide (Surfactant 9)

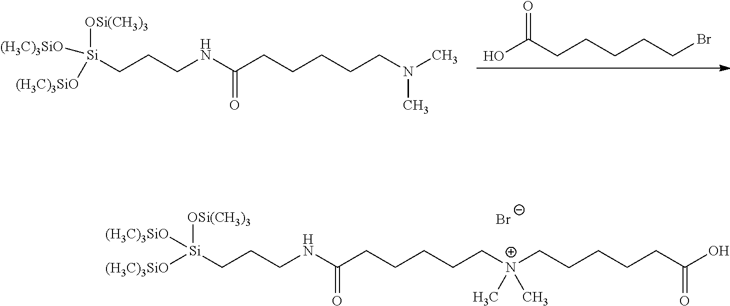

The siloxane derivative described in Example 1 (1 g, 2.02 mmol) was dissolved in dimethylformamide (DMF) (15 mL) and 6-bromohexanoic acid (2.02 mmol) was added. The mixture was stirred for 12 hours at 70° C., after which the solvent was removed under vacuum. The crude product was washed twice with hexane to provide N-(5-carboxypentyl)-6-((3-(1,1,1,5,5,5-hexamethyl-3-((trimethylsilyl)oxy)trisiloxan-3-yl)propyl)amino)-N,N-dimethyl-6-oxohexan-1-aminium bromide as a sticky brown liquid (650 mg).

### Example 11b: Determination of Physical Properties of Surfactant 9

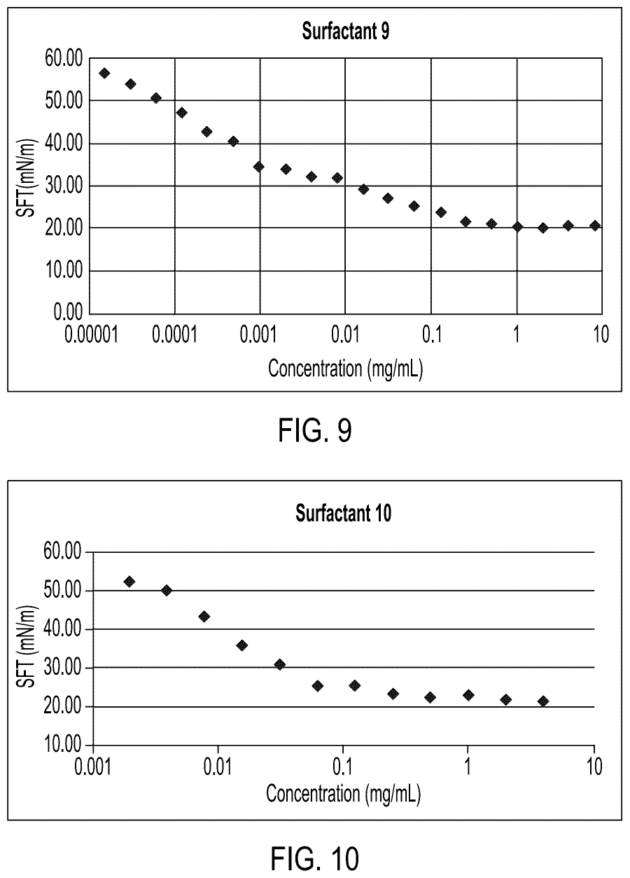

The critical micelle concentration (CMC) for Surfactant 9a was measured. From the surface tension change with concentration in water, the CMC was determined to be about 0.2237 mmol. The plateau value of minimum surface tension that can be reached by this surfactant was about 20.52 mN/m, indicating that the surfactant has excellent interfacial activity. These results are plotted as surface tension versus concentration in FIG. 9.

### Comparative Example A1: Synthesis of N-(carboxymethyl)-6-((3-(1,1,1,5,5,5-hexamethyl-3-((trimethylsilyl)oxy)trisiloxan-3-yl)propyl)amino)-N,N-dimethyl-6-oxohexan-1-aminium bromide (Comparative Surfactant)

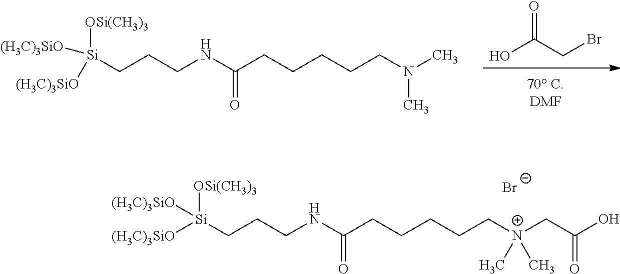

The siloxane derivative described in Example 1 (1.00 g, 2.02 mmol) was dissolved in dimethylformamide (DMF) (15 mL). Bromoacetic acid (2.02 mmol) was added, and the mixture was stirred for 12 hours at 70° C. The solvent was removed, and the crude product was washed twice with hexanes to give Surfactant 9b as a brown liquid (700 mg).

### Comparative Example A2: Determination of Physical Properties of the Comparative Surfactant

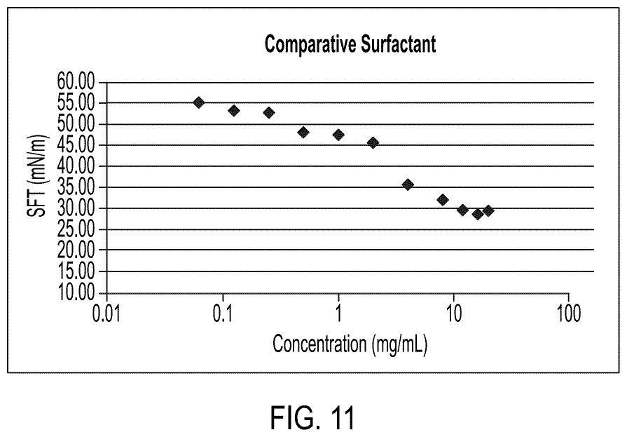

The critical micelle concentration (CMC) for Surfactant 9b was measured. From the surface tension change with concentration in water, the CMC was determined to be about 17.28 mmol. The plateau value of minimum surface tension that can be reached by this surfactant was about 29.16 mN/m. These results are plotted as surface tension versus concentration in FIG. 11. The results show the difficulty in predicting surfactant activity on the basis of chemical structure; Surfactant 9, which differs only in the number of methylene groups in the carboxylic acid, displays excellent activity.

### Example 12: Synthesis of N-(4-(4-carboxyphenyl)butyl)-6-((3-(1,1,1,5,5,5-hexamethyl-3-((trimethylsilyl)oxy)trisiloxan-3-yl)propyl)amino)-N,N-dimethyl-6-oxohexan-1-aminium bromide (Surfactant 11)

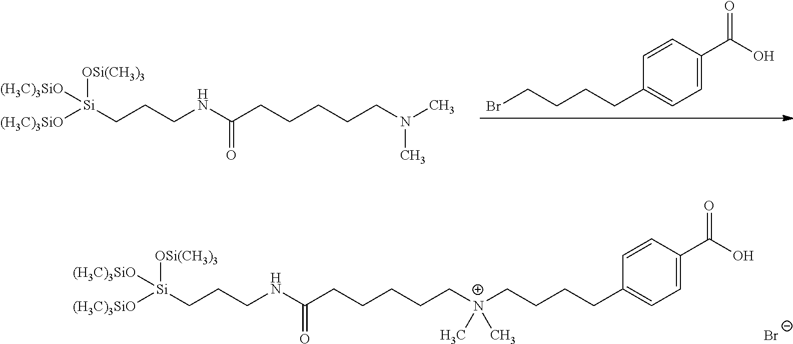

To the siloxane derivative described in Example 1 is added 4-(4-bromobutyl)benzoic acid to provide N-(4-(4-carboxyphenyl)butyl)-6-((3-(1,1,1,5,5,5-hexamethyl-3-((trimethylsilyl)oxy)trisiloxan-3-yl)propyl)amino)-N,N-dimethyl-6-oxohexan-1-aminium bromide.

### Example 13: Synthesis of N-(4-carboxybenzyl)-6-((3-(1,1,1,5,5,5-hexamethyl-3-((trimethylsilyl)oxy)trisiloxan-3-yl)propyl)amino)-N,N-dimethyl-6-oxohexan-1-aminium bromide (Surfactant 12)

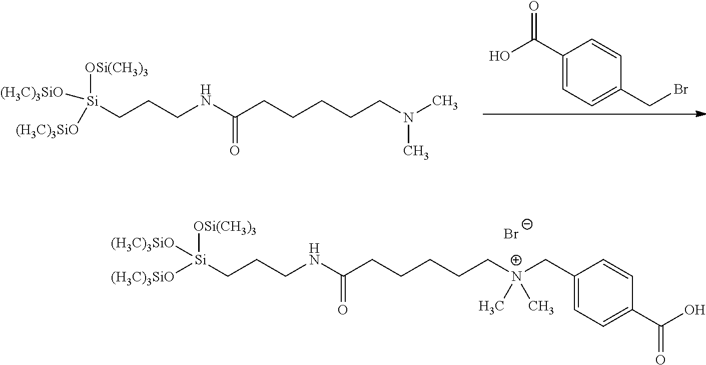

To the siloxane derivative described in Example 1 is added 4-(bromomethyl)benzoic acid to provide N-(4-carboxybenzyl)-6-((3-(1,1,1,5,5,5-hexamethyl-3-((trimethylsilyl)oxy)trisiloxan-3-yl)propyl)amino)-N,N-dimethyl-6-oxohexan-1-aminium bromide.

### Example 14

### Soaps Comprising Two or More Inventive Surfactants

Detergent formulation comprising the soap, fully saturated lauric soap granule based on Prifac 5808 from Uniqema, a first inventive surfactant, and a non-ionic inventive surfactant. All formulation include 1.008 g/l of surfactant; and 0.25 to 0.67 of soap. The water was conditioned with a mixture of CaCl₂_2 H₂O) and MgCl—H₂O), such that the ration of calcium to magnesium

### Example 15

### Dry Cleaning Formulations

Laundry articles are contacted with the following low aqueous dry cleaning compositions A (see table 3) and agitated for 15 minutes at 20° C. using a liquid to cloth ratio of 13. Subsequently, the dry cleaning composition is removed and the laundry articles are rinsed with a rinse composition comprising clean dry cleaning solvent. The experiment is repeated with following low aqueous dry cleaning compositions B-F (see table I) using an liquid to cloth ratio of 5.

TABLE 3

| | Composition | | | | | |
|---|---|---|---|---|---|---|
| | A | B | C | D | E | F |
| Inventive Surfactant A (wt. %) | 0.5 | | | | | |
| Invnetive surfact B | | 0.1 | 0.1 | 0.5 | 0.1 | 0.5 |
| Water Solvent (Balance) | — | 0.25 | 0.5 | 0.5 | 1.0 | 1.0 |
| HFE-7200 ™ | X | X | | | | |
| Dodecamethylpentasiloxane | | | X | | | |
| Decamethyltetrasiloxane | | | | X | | |
| Decamethylcyclopentasiloxane | | | | | X | X |

### Example 16

### Cleaning Composition Suitable for Food Contact

Exemplary formulations illustrating certain embodiments of the cleaning compositions can be formulated generally by adding the components into a suitably sized vessel in no particular order and at room temperature. If any of the components are solid, thick or gel-like at room temperature, they can be warmed to render them pourable liquids prior to addition to the vessel. Mixing of the constituents was achieved by the use of a mechanical stirrer with a small diameter propeller at the end of its rotating shaft. Mixing, which generally lasted from 5 minutes to 120 minutes was maintained until the particular exemplary formulation appeared to be homogeneous. The exemplary compositions were readily pourable, and retained well mixed characteristics (i.e., stable mixtures) upon standing for extend periods.

Exemplary aqueous compositions may include one or more surfactants 1-12 disclosed herein, optionally a low concentration of a lower alcohol, and a fragrance. The composition may further be optimized for phase stability (i.e., maintenance of a single phase). The composition may further include from 0.1 to 0.6% isopropyl alcohol. The balance of the composition was water.

TABLE 15

| Component | Amount |
|---|---|
| Inventive Surfactant 1-12 | 0.001 wt. % to 80 wt. % |
| Fragance | optional |
| solvent | optional |
| Isopropyl alcohol | 0.1 to 0.6% |
| water | |

### Example 17

### Clean-In-Place Sample Formulations

Exemplary formulations suitable for clean-in-place applications can be formulated generally by adding the components indicated in Table 16 (amounts in weight %) below into a suitably sized vessel in no particular order and at room temperature.

TABLE 16
CIP Sample compositions [% of components]

| | Composition 1 | Composition 2 | Composition 3 |
|---|---|---|---|
| Inventive Surfactant | 1-50 | 10-40 | 25-35 |
| 1-12 | | | |
| Oxidizing Agent | 0.1-10 | 2-8 | 5-7 |
| Stabilizing Agent | 0.1-10 | 0.5-5 | 1-2 |
| Acidulant | 1-50 | 10-40 | 20-30 |

### Example 18 Antimicrobial MIC Studies

The antimicrobial properties of surfactants can be examined using known methods and standard protocols, and various types of microorganisms as treatment targets. As a general matter, standard protocols can be developed to assess antimicrobial minimum inhibitory concentration (MIC) using serial dilution method, giving concentration-dependent microorganism growth inhibition measurements against gram positive (e.g., Streptococcus mutans, which is anaerobic, and Staphylococcus aureus, which is usually aerobic but can grow also anaerobically), gram negative (e.g., Escherichia coli, which is anaerobic, or Pseudomonas aeruginosa, which is aerobic).

Bacteria are propagated overnight in a suitable growth medium, e.g., a Tryptic Soy Broth. Prior to testing, the concentrations of the test organisms are established using a spectrophotometer that can measure optical density. Those bacterial samples are then diluted to about 1E3 to 1E4 CFU/mL. Thereafter, 10 μL of the bacterial cultures thus prepared are inoculated into test wells of a 96-well plate, each containing suitable growth media, for example, a Tryptic Soy Agar, and once the bacterial cultures are inoculated, these wells are then treated with the test specimen, serially diluted, are incubated at a temperature of 37+/−1° C. and relative humidity of not less than 90% for about 24+/−1 hour.

Test surfactants are prepared into dilution series. All dilutions are conducted serially using a multichannel pipetter into 96-well microtiter plates. The dilution series are typically established by range-finding exercises so as to determine a high concentration ceiling and a series of diluted, lower concentrations so as to ensure that the test substance would at no time completely inhibit bacterial growth but still show effects.

The MIC is used to determine the approximate concentration of the test surfactant at which there is inhibition of bacterial growth.

A reference substance is typically used as a positive control in this antimicrobial testing protocol. For example, ADBAC Quarternary Amine having a CAS number of 139-08-2 would be a suitable test reference.

Test measurements are conducted on replicate 96-well plates, and reported as the rounded whole number average of the determined MIC. Replicate data are averaged by determination of the mean value (arithmetic average) for a selected measure using the equation: Arithmetic mean=the sum of the numbers in the set of interest/the number of terms. Measurement variability is then reported based on the determined average in the form of MIC+/−.

### ASPECTS

Aspect 1 is a formulation for cleaning, comprising: at least one surfactant of Formula I:

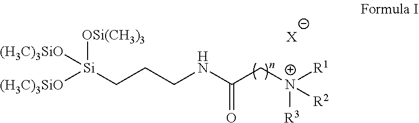

wherein R¹ and R² are the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ is selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to a second molecule of Formula I, wherein the second molecule of Formula I is the same or different form the first molecule of Formula I;
n is an integer from 1 to 12; and
X is selected from the group consisting of chloride, bromide, and iodide;
and at least one detergent and/or at least one soap.
Aspect 2 is the formulation of Aspect 1, wherein the at least one detergent or soap is selected from the group consisting of anionic detergents, cationic detergents, non-ionic detergents, and zwitter ionic detergents.
Aspect 3 is the formulation of any of either Aspect 1 or Aspect 2, wherein the soap is of the general formula:
(RCO₂⁻)n Mⁿ⁺ wherein R includes an alkly group, M is a metal, and n+ is either +1 or +2.
Aspect 4 is the formulation of any of Aspects 1-3, further comprising: at least one builder.
Aspect 5 is the formulation of Aspect 4, wherein the at least one builder is at least one compound selected from the group consisting of: tripolyphosphates, nitrilloacetic acid salts, zeolites, calcite/carbonate, citrate or polymers, sodium, pyrophosphate, orthophosphate, sodium aluminosilicate, inorganic salts of alkaline agents, inorganic salts of alkali metals, sulphates, silicates, and metasilicates.
Aspect 6 is the formulation of any of Aspects 1-5, further comprising: at least one bleach.
Aspect 7 is the formulation of Aspect 6, wherein the at least one bleach at is at least one compound selected from the group consisting of: metal borates, persalts, peroxyacids, percarbonates, perphophates, persilicates, persulfates, sodium hypochlorite, chlorine dioxide, hydrogen peroxide, sodium percarbonate, sodium perborate, peroxoacetic acid, benzol peroxide, potassium persulfate, potassium permanganate, and sodium dithionite.
Aspect 8 is the formulation of any of Aspects 1-7, further comprising: at least one enzyme.
Aspect 9 is the formulation of Aspect 8, wherein the at least one enzyme is selected from the group consisting of: proteases, amylases, cellulases, oxidases, mannanases, peroxidases and lipases.
Aspect 10 is the formulation of any of Aspects 1-9, further comprising at least one polymer.
Aspect 11 is the formulation of Aspect 10, wherein the at least one polymer is at least one compound selected from the group consisting of: polymers of methacrylamidem; ethylenically unsaturated monomer; N,N-dialkylaminoalkyl methacrylate; N,N-di alkylaminoalkyl acrylate; N,N-dialkylaminoalkyl acrylamide; N,N-dialkylaminoalkylmethacrylamide; methacylamidoalkyl trialkylammonium salts; acrylamidoalkylltrialkylamminium salts; vinylamine; vinyl imidazole; quaternized vinyl imidazole and diallyl dialkyl ammonium salts; diallyl dimethyl ammonium salt; N,N-dimethyl aminoethyl acrylate; N,N-dimethylaminoethyl methacrylate, [2-(methacryloylamino)ethyl]tri-methylammonium salts; N,N-dimethylaminopropyl acrylamide; N,N-dimethylaminopropyl methacrylamide, acrylamidopropyl trimethyl ammonium salts, methacrylamidopropyl trimethylammonium salts, and quaternized vinylimidazole.
Aspect 12 is a formulation for dry cleaning, comprising: at least one surfactant of Formula I:

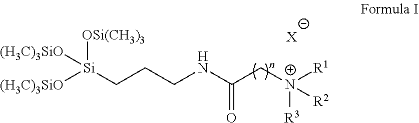

wherein R¹ and R² are the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ is selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to a second molecule of Formula I, wherein the second molecule of Formula I is the same or different form the first molecule of Formula I;
n is an integer from 1 to 12; and
X is selected from the group consisting of chloride, bromide, and iodide;
   and at least one solvent.
Aspect 13 is the formulation of Aspect 12, wherein the at least one solvent is at least one compound selected from the group consisting of: perchloroethylene, hydrocarbons, trichloroethylene, decamethylcyclopentasiloxane, dibutoxymthane, and n-propyl bromide.
Aspect 14 is the formulation of any of either Aspect 12 or Aspect 13, further comprising at least one co-solvent.
Aspect 15 is the formulation of Aspect 14 wherein the at least one co-solvent is at least one compound selected from the group consisting of: alcohols, ethers, glycol ethers, alkanes, alkenes, linear and cyclic amides, perfluorinated tertiary amines, perfluoroethers, cycloalkanes, esters, ketones, aromatics, methanol, ethanol, isopropanol, t-butyl alcohol, trifluoroethanol, pentafluoropropanol, hexafluoro-2-propanol, methyl t-butyl ether, methyltamyl ether, propylene glycol n-propyl ether, propylene glycol n-butyl ether, dipropylene glycol n-butyl ether, propylene glycol methyl ether, ethylene glycol monobutyl ether, trans-1,2-dichloroethylene, decalin, methyl decanoate, t-butyl acetate, ethyl acetate, glycol methyl ether acetate, ethyl lactate, diethyl phthalate, 2-butanone, N-alkyl pyrrolidone (such as N-methyl pyrrolidone, N-ethyl pyrroli done), methyl isobutyl ketone, naphthalene, toluene, trifluorotoluene, perfluorohexane, perfluoroheptane, perfluorooctane, perfluorotributylamine, and perfluoro-2-butyloxacyclopentane.
Aspect 16 is the use as a surfactant of a compound of Formula I:

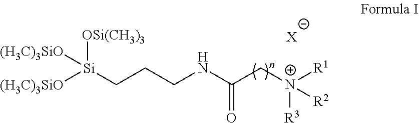

wherein R¹ and R² are the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ is selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to a second molecule of Formula I, wherein the second molecule of Formula I is the same or different form the first molecule of Formula I;
   n is an integer from 1 to 12; and
   X is selected from the group consisting of chloride, bromide, and iodide;
      in a cleaning formulation, wherein the cleaning formulation comprises at least one surfactant of formula I, at least one detergent, and/or at least one soap.
Aspect 17 is the use of Aspect 16, wherein the at least one detergent or soap is selected from the group consisting of anionic detergents, cationic detergents, non-ionic detergents, and zwitter ionic detergents.
Aspect 18 is the use of any of either Aspect 16 or Aspect 17, wherein the soap is of the general formula:
(RCO₂⁻)n Mⁿ⁺ wherein R includes an alkly group, M is a metal, and n+ is either +1 or +2.
Aspect 19 is the use of any of Aspects 16-18, further comprising: at least one builder.
Aspect 20 is the use of Aspect 19, wherein the at least one builder is at least one compound selected from the group consisting of: tripolyphosphates, nitrilloacetic acid salts, zeolites, calcite/carbonate, citrate or polymers, sodium, pyrophosphate, orthophosphate, sodium aluminosilicate, inorganic salts of alkaline agents, inorganic salts of alkali metals, sulphates, silicates, and metasilicates.
Aspect 21 is the use of any of Aspects 16-20, further comprising: at least one bleach.
Aspect 22 is the use of Aspect 21, wherein the at least one bleach at is at least one compound selected from the group consisting of: metal borates, persalts, peroxyacids, percarbonates, perphophates, persilicates, persulfates, sodium hypochlorite, chlorine dioxide, hydrogen peroxide, sodium percarbonate, sodium perborate, peroxoacetic acid, benzol peroxide, potassium persulfate, potassium permanganate, and sodium dithionite.
Aspect 23 is the use of any of Aspects 16-22, further comprising: at least one enzyme.
Aspect 24 is the use of Aspect 23, wherein the at least one enzyme is selected from the group consisting of: proteases, amylases, cellulases, oxidases, mannanases, peroxidases and lipases.
Aspect 25 is the use of any of Aspects 16-24, further comprising at least one polymer.
Aspect 26 is the use of Aspect 25, wherein the at least one polymer is at least one compound selected from the group consisting of: polymers of methacrylamidem; ethylenically unsaturated monomer; N,N-dialkylaminoalkyl methacrylate; N,N-di alkylaminoalkyl acrylate; N,N-dialkylaminoalkyl acrylamide; N,N-dialkylaminoalkylmethacrylamide; methacylamidoalkyl trialkylammonium salts; acrylamidoalkylltrialkylamminium salts; vinylamine; vinyl imidazole; quaternized vinyl imidazole and diallyl dialkyl ammonium salts; diallyl dimethyl ammonium salt; N,N-dimethyl aminoethyl acrylate; N,N-dimethylaminoethyl methacrylate, [2-(methacryloylamino)ethyl]tri-methylammonium salts; N,N-dimethylaminopropyl acrylamide; N,N-dimethylaminopropyl methacrylamide, acrylamidopropyl trimethyl ammonium salts, methacrylamidopropyl trimethylammonium salts, and quaternized vinylimidazole.
Aspect 27 is the use as a surfactant of a compound of Formula I:

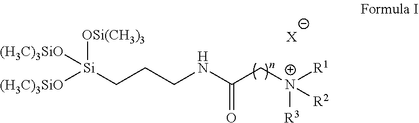

wherein R¹ and R² are the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ is selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to a second molecule of Formula I, wherein the second molecule of Formula I is the same or different form the first molecule of Formula I;
n is an integer from 1 to 12; and
X is selected from the group consisting of chloride, bromide, and iodide;
   in a dry cleaning formulation, wherein the formulation at least one surfactant of formula I, and at least one solvent.
Aspect 28 is the use of Aspect 27, wherein the at least one solvent is at least one compound selected from the group consisting of: perchloroethylene, hydrocarbons, trichloroethylene, decamethylcyclopentasiloxane, dibutoxymthane, and n-propyl bromide.
Aspect 29 is the use of any of either Aspect 27 or Aspect 28, further comprising at least one co-solvent.
Aspect 30 is the formulation of Aspect 29 wherein the at least one co-solvent is at least one compound selected from the group consisting of: alcohols, ethers, glycol ethers, alkanes, alkenes, linear and cyclic amides, perfluorinated tertiary amines, perfluoroethers, cycloalkanes, esters, ketones, aromatics, methanol, ethanol, isopropanol, t-butyl alcohol, trifluoroethanol, pentafluoropropanol, hexafluoro-2-propanol, methyl t-butyl ether, methyltamyl ether, propylene glycol n-propyl ether, propylene glycol n-butyl ether, dipropylene glycol n-butyl ether, propylene glycol methyl ether, ethylene glycol monobutyl ether, trans-1,2-dichloroethylene, decalin, methyl decanoate, t-butyl acetate, ethyl acetate, glycol methyl ether acetate, ethyl lactate, diethyl phthalate, 2-butanone, N-alkyl pyrrolidone (such as N-methyl pyrrolidone, N-ethyl pyrroli done), methyl isobutyl ketone, naphthalene, toluene, trifluorotoluene, perfluorohexane, perfluoroheptane, perfluorooctane, perfluorotributylamine, and perfluoro-2-butyloxacyclopentane.
Aspect 31 is cleaning formulation as disclosed in any one of aspects 1 to 16.
Aspect 36 is the use as a cleaning or dry cleaning of a formulation a comprising at least one surfactant of a compound of Formula (I)

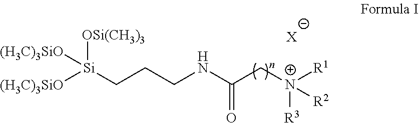

wherein R¹ and R² are the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ is selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to a second molecule of Formula I, wherein the second molecule of Formula I is the same or different form the first molecule of Formula I;
n is an integer from 1 to 12; and
X is selected from the group consisting of chloride, bromide, and iodide.
Aspect 37 is the use of a formulation a comprising at least one surfactant of a compound of Formula (I)

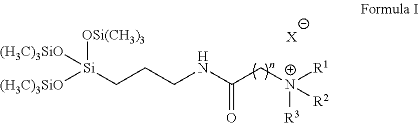

wherein R¹ and R² are the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ is selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to a second molecule of Formula I, wherein the second molecule of Formula I is the same or different form the first molecule of Formula I;
   n is an integer from 1 to 12; and
X is selected from the group consisting of chloride, bromide, and iodide, and water in a CIP or COP cleaning method or process.
Aspect 38 is the use of Aspect 37 wherein the formulation further includes an oxidizing agent, a stabilizing agent, a fragrance or an acidulant.
Aspect 39 is a method of preparing the formulation of any one of Aspects 1 to 11 comprising:
synthesizing a compound of Formula I

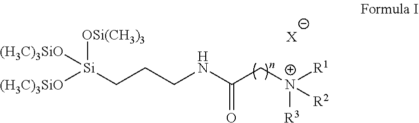

wherein R¹ and R² are the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate; R³ is selected from the group consisting of alkenyl, alkynyl, ester, alcohol, aryl alkyl, alkoxy alkyl ether, alkyl phosphate, C₃-C₈ carboxylic acid, C₁-C₁₀ alkyl benzoic acid, and a C₁-C₆ linker attached to a second molecule of Formula I, wherein the second molecule is the same or different; n is an integer from 1 to 12; and X is selected from the group consisting of chloride, bromide, and iodide, the method comprising: a ring opening step to open lactam ring to provide an amino acid having an N-terminus and a C-terminus; a first alkylation step, to alkylate the N-terminus to provide a tertiary amine; a coupling step, to react the C-terminus with 3-aminopropyltris(trimethylsiloxy)silane to provide siloxane derivative; and a second alkylation step, to alkylate the N-terminus to provide a quaternary amine of Formula I, adding at least one detergent, and/or at least one soap; and optionally, water.
Aspect 40 is a method of preparing the formulation of any one of Aspects 12 to 15 comprising:
synthesizing a compound of Formula I

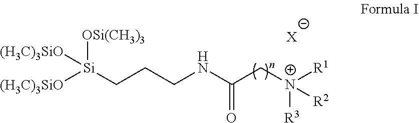

wherein R¹ and R² are the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate; R³ is selected from the group consisting of alkenyl, alkynyl, ester, alcohol, aryl alkyl, alkoxy alkyl ether, alkyl phosphate, C₃-C₈ carboxylic acid, C₁-C₁₀ alkyl benzoic acid, and a C₁-C₆ linker attached to a second molecule of Formula I, wherein the second molecule is the same or different; n is an integer from 1 to 12; and X is selected from the group consisting of chloride, bromide, and iodide, the method comprising: a ring opening step to open lactam ring to provide an amino acid having an N-terminus and a C-terminus; a first alkylation step, to alkylate the N-terminus to provide a tertiary amine; a coupling step, to react the C-terminus with 3-aminopropyltris(trimethylsiloxy)silane to provide siloxane derivative; and a second alkylation step, to alkylate the N-terminus to provide a quaternary amine of Formula I, and adding a solvent.
Aspect 41 is a method of preparing a formulation for a CIP, a COP or a hard-surface cleaning process, comprising:
synthesizing a compound of Formula I

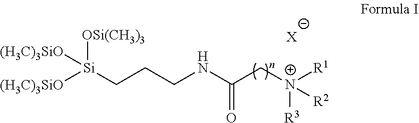

wherein R¹ and R² are the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate; R³ is selected from the group consisting of alkenyl, alkynyl, ester, alcohol, aryl alkyl, alkoxy alkyl ether, alkyl phosphate, C₃-C₈ carboxylic acid, C₁-C₁₀ alkyl benzoic acid, and a C₁-C₆ linker attached to a second molecule of Formula I, wherein the second molecule is the same or different; n is an integer from 1 to 12; and X is selected from the group consisting of chloride, bromide, and iodide, the method comprising: a ring opening step to open lactam ring to provide an amino acid having an N-terminus and a C-terminus; a first alkylation step, to alkylate the N-terminus to provide a tertiary amine; a coupling step, to react the C-terminus with 3-aminopropyltris(trimethylsiloxy)silane to provide siloxane derivative; and a second alkylation step, to alkylate the N-terminus to provide a quaternary amine of Formula I, and
adding at least one of an acidulent, an oxidizing agent or stabilizing agent; and optionionally, water.
Aspect 42 is the method of any of Aspects 39 to 41, wherein the lactam is caprolactam.
Aspect 43 is the method of any of Aspects 39 to 42, wherein in the first alkylation step, the tertiary amine is 6-(dimethylamino)hexanoic acid.
Aspect 44 is the method of any one of Aspects 39 to 43, wherein in the second alkylation step, the N-terminus is alkylated with an alkylating agent selected from the group consisting of benzyl bromide, ethyl bromoacetate, allyl iodide, propargyl bromide, 1-bromo-2-(2-methoxyethoxy)ethane, bromo phosphonate, 3-iodopropanol, 3-bromopropanol, 2-iodoethanol, 2-bromoethanol, 6-bromohexanoic acid, and 1,3-dibromopropane.

1. A formulation for cleaning, comprising:
at least one surfactant of Formula I: 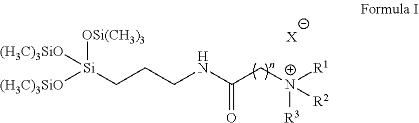
wherein R¹ and R² are the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ is selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to a second molecule of Formula I, wherein the second molecule of Formula I is the same or different form the first molecule of Formula I;
n is an integer from 1 to 12; and
X is selected from the group consisting of chloride, bromide, and iodide; and
at least one detergent or at least one soap.

2. The formulation of claim 1, wherein the at least one detergent or soap is selected from the group consisting of: anionic detergents, cationic detergents, non-ionic detergents, and zwitter ionic detergents.

3. The formulation of claim 1, wherein the soap is of the general formula:
(RCO₂⁻)ₙ Mⁿ⁺
wherein R includes an alkly group, M is a metal, and ⁿ⁺ is either +1 or +2.

4. The formulation of claim 1, further comprising: at least one builder, wherein the at least one builder is at least one compound selected from the group consisting of: tripolyphosphates, nitrilloacetic acid salts, zeolites, calcite/carbonate, citrate or polymers, sodium, pyrophosphate, orthophosphate, sodium aluminosilicate, inorganic salts of alkaline agents, inorganic salts of alkali metals, sulphates, silicates, and metasilicates.

5. The formulation according to claim 1, further comprising: at least one bleach, wherein the at least one bleach at is at least one compound selected from the group consisting of: metal borates, persalts, peroxyacids, percarbonates, perphophates, persilicates, persulfates, sodium hypochlorite, chlorine dioxide, hydrogen peroxide, sodium percarbonate, sodium perborate, peroxoacetic acid, benzol peroxide, potassium persulfate, potassium permanganate, and sodium dithionite.

6. The formulation of claim 1, further comprising at least one enzyme, wherein the at least one enzyme is selected from the group consisting of: proteases, amylases, cellulases, oxidases, mannanases, peroxidases and lipases.

7. The formulations of claim 1, further comprising at least one polymer, wherein the at least one polymer is at least one compound selected from the group consisting of: polymers of methacrylamidem; ethylenically unsaturated monomer; N,N-dialkylaminoalkyl methacrylate; N,N-di alkylaminoalkyl acrylate; N,N-dialkylaminoalkyl acrylamide; N,N-dialkylaminoalkylmethacrylamide; methacylamidoalkyl trialkylammonium salts; acrylamidoalkylltrialkylamminium salts; vinylamine; vinyl imidazole; quaternized vinyl imidazole and diallyl dialkyl ammonium salts; diallyl dimethyl ammonium salt; N,N-dimethyl aminoethyl acrylate; N,N-dimethylaminoethyl methacrylate, [2-(methacryloylamino)ethyl]tri-methylammonium salts; N,N-dimethylaminopropyl acrylamide; N,N-dimethylaminopropyl methacrylamide, acrylamidopropyl trimethyl ammonium salts, methacrylamidopropyl trimethylammonium salts, and quaternized vinylimidazole.

8. A formulation for dry cleaning, comprising:
at least one surfactant of Formula I: 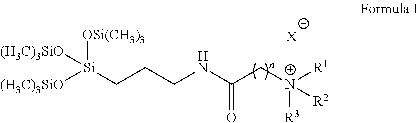
wherein R¹ and R² are the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ is selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to a second molecule of Formula I, wherein the second molecule of Formula I is the same or different form the first molecule of Formula I;
n is an integer from 1 to 12; and
X is selected from the group consisting of chloride, bromide, and iodide;
and
at least one solvent.

9. The formulation according to claim 8, wherein the at least one solvent is at least one compound selected from the group consisting of: perchloroethylene, hydrocarbons, trichloroethylene, decamethylcyclopentasiloxane, dibutoxymthane, and n-propyl bromide.

10. The formulation of claim 9, further comprising at least one co-solvent, wherein the at least one co-solvent is at least one compound selected from the group consisting of: alcohols, ethers, glycol ethers, alkanes, alkenes, linear and cyclic amides, perfluorinated tertiary amines, perfluoroethers, cycloalkanes, esters, ketones, aromatics, methanol, ethanol, isopropanol, t-butyl alcohol, trifluoroethanol, pentafluoropropanol, hexafluoro-2-propanol, methyl t-butyl ether, methyltamyl ether, propylene glycol n-propyl ether, propylene glycol n-butyl ether, dipropylene glycol n-butyl ether, propylene glycol methyl ether, ethylene glycol monobutyl ether, trans-1,2-dichloroethylene, decalin, methyl decanoate, t-butyl acetate, ethyl acetate, glycol methyl ether acetate, ethyl lactate, diethyl phthalate, 2-butanone, N-alkyl pyrrolidone (such as N-methyl pyrrolidone, N-ethyl pyrroli done), methyl isobutyl ketone, naphthalene, toluene, trifluorotoluene, perfluorohexane, perfluoroheptane, perfluorooctane, perfluorotributylamine, and perfluoro-2-butyloxacyclopentane.

11. A formulation for hard surface cleaning, comprising:
at least one surfactant of Formula I: 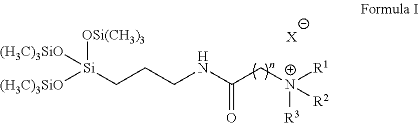
wherein R¹ and R² are the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate;
R³ is selected from the group consisting of alkenyl, alkynyl, ester, alcohol, aryl alkyl, alkoxy alkyl ether, alkyl phosphate, alkyl phosphonate, C₃-C₈ carboxylic acid, C₁-C₁₀ alkyl benzoic acid, and a C₁-C₁₂ linker attached to a second molecule of Formula I, wherein the second molecule of Formula I is the same or different form the first molecule of Formula I;
n is an integer from 1 to 12; and
X is selected from the group consisting of chloride, bromide, and iodide;
optionally an antimicrobial agent; and
water.

12. The formulation according to claim 11, wherein the antimicrobial agent is present, and has a greater than 1 log₁₀ reduction in 30 seconds.

13. The formulation according to claim 11, wherein the antimicrobial agents is present at a concentration level of at least about 50 ppm.

14. The formulation of claim 11, further comprising a further additive selected from acidulants, stabilizing agents, chelating agents, sequestrants, buffers, detergents, wetting agents, defoaming agents, thickeners, foaming agents, solidification agents, colorants, odorants, or perfumes.

15. The formulation of claim 11, further comprising a soap, bleach, or detergent.

16. A method of preparing the formulation claim 1, comprising:
synthesizing a compound of Formula I 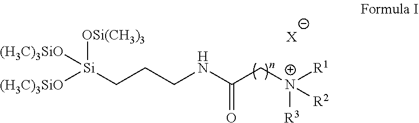
wherein R¹ and R² are the same or different, and comprise at least one group selected from the group consisting of C₁-C₆ alkyl, optionally the C₁-C₆ alkyl may include one or more of oxygen, nitrogen, or sulfur atoms or groups that include at least one of these atoms, and the alkyl chain may be optionally substituted with one or more substituents selected from the group consisting of hydroxyl, amino, amido, sulfonyl, sulfonate, carbonyl, carboxyl, and carboxylate; R³ is selected from the group consisting of alkenyl, alkynyl, ester, alcohol, aryl alkyl, alkoxy alkyl ether, alkyl phosphate, C₃-C₈ carboxylic acid, C₁-C₁₀ alkyl benzoic acid, and a C₁-C₆ linker attached to a second molecule of Formula I, wherein the second molecule is the same or different; n is an integer from 1 to 12; and X is selected from the group consisting of chloride, bromide, and iodide, the method comprising: a ring opening step to open lactam ring to provide an amino acid having an N-terminus and a C-terminus; a first alkylation step, to alkylate the N-terminus to provide a tertiary amine; a coupling step, to react the C-terminus with 3-aminopropyltris(trimethylsiloxy)silane to provide siloxane derivative; and a second alkylation step, to alkylate the N-terminus to provide a quaternary amine of Formula I, adding at least at least one detergent or at least one soap;
and water.

17. The method of claim 16, wherein the lactam is caprolactam.

18. The method of claim 16, wherein in the first alkylation step, the tertiary amine is 6-(dimethylamino)hexanoic acid.

19. The method of claim 16, wherein in the second alkylation step, the N-terminus is alkylated with an alkylating agent selected from the group consisting of benzyl bromide, ethyl bromoacetate, allyl iodide, propargyl bromide, 1-bromo-2-(2-methoxyethoxy)ethane, bromo phosphonate, 3-iodopropanol, 3-bromopropanol, 2-iodoethanol, 2-bromoethanol, 6-bromohexanoic acid, and 1,3-dibromopropane.
